(19) United States
(12) Patent Application Publication
(10) Pub. No.: US 2014/0255884 A1
(43) Pub. Date: Sep. 11, 2014

(54) INCREMENTALLY-SIZED STANDARD-SIZED EATING-WARE SYSTEM FOR WEIGHT MANAGEMENT

(71) Applicant: FOQUS, INC., Voorhees, NJ (US)

(72) Inventor: Danuta Highet, Voorhees, NJ (US)

(73) Assignee: FOQUS, INC., Voorhees, NJ (US)

(21) Appl. No.: 14/214,482

(22) Filed: Mar. 14, 2014

Related U.S. Application Data
(63) Continuation-in-part of application No. 13/373,175, filed on Nov. 7, 2011.
Application No. 13/373,175 is a continuation-in-part of application No. 11/888,975, filed on Aug. 3, 2007, now abandoned.
(60) Provisional application No. 61/800,590, filed on Mar. 15, 2013.

(51) Int. Cl. G09B 19/00; A23L 1/29

(52) U.S. Cl. CPC G09B 19/0092; A23L 1/293
USPC 434/127

(57) ABSTRACT

A diet management system, including a plurality of different-sized templates, each template having the same shape and defining a size of a food portion in accordance with a standardized eating system. Each template is collapsible for storage and/or transportation, and each template includes an indicia demarking the correspondence of the template with the standardized eating system.

### CROSS-REFERENCE TO RELATED APPLICATIONS

This application claims priority under 35 USC §119(e) from U.S. Provisional Patent Application Ser. No. 61/800,590, filed on Mar. 15, 2013, the disclosure of which is incorporated herein by reference in its entirety. This application is also a continuation-in-part of U.S. patent application Ser. No. 13/373,175, filed on Nov. 7, 2011, which is a continuation-in-part of U.S. patent application Ser. No. 11/888,975, filed on Aug. 3, 2007, the disclosures of both of which are incorporated herein by reference in their entirety.

### BACKGROUND OF THE INVENTION

1. Field of the Invention

The present invention relates to an incrementally-sized standard-sized eating-ware system and processes for weight management; and more particularly to an Incrementally-Sized Standard-Sized Eating-ware System, using a plurality of Incrementally-Sized Standard-Sized objects that represent and/or define Standard Sizes of food portion amounts as defined within, dimensionally based on formulas that establish and assign standard sizes to eating-ware, where the standard sizes are based on a series of incrementally-sized flat surfaces, and the flat surfaces establish the basis for total volumetric capacity equivalents, and the total volumetric capacity equivalents comprise volume inside the eating-ware and directly above the eating-ware, and the standard sizes are used as a guide to control amount and rate of food in a form of liquid or solid consumed for weight management as user shifts from one increment in size to the next to either decrease or increase weight or continues to select eatingware components with the same size to maintain weight; and wherein a plurality of incrementally-sized standard-sized eating-ware components have successively decreasing standard sizes to gradually and unnoticeably modify food portions consumed and/or the rate of food consumption, while minimizing the emotional impact on the user; and processes for use of the standard sizes and/or the incrementally-sized standard-sized eating-ware components for weight management and instilling healthy eating habits; and wherein a Caloric Density Mark consisting of a letter representation of food caloric density is used by the user to select foods that have lower caloric density (in order to lose weight) and higher caloric density in order to gain weight, or tries to maintain same Caloric Density Mark foods to maintain weight and/or combined with the numeric representation of eating-ware standard size to guide a user while serving and consuming food with the estimated caloric content.

2. Description of the Related Art

The amount of food served usually determines the amount consumed. Consumers depend on the eating-ware that they are using to determine the amount of food they serve themselves. They are unaware that the size of their eating-ware impacts the amount and the rate that they consume their food. Nor can they determine the total volumetric food delivery capacity of their eating-ware by any currently available means.

Eating-ware components in a form of a flat surface are currently used for serving food and transfer of food directly to the user. Eating-ware components heretofore known and utilized for weight management generally require users to either measure and/or transfer food prior to being able to consume it directly from a flat surface or from any typical eating-ware.

Solid foods can be served extending beyond the rim of a container and eaten during the daily consumption process. Although the volume of food that can be served above the rim of eating-ware is not contained within, it does add to the total volume consumed. No currently devised eating-ware or method takes this and its impact on the daily consumption into account.

The current dietary recommendations require consumers to monitor and calculate their daily consumption vs. recommended amounts, which will vary with their age, gender, built, etc. This is a very complex and time consuming strategy that is difficult to implement for most adults, and especially for children. Currently there are no recommendations for gradually and unnoticeably modifying the amount and rate of consumption nor are there tools that would guide the user in this process to address their individual needs.

Bad eating habits result in overeating. When individuals eat big mouthfuls quickly they are not giving themselves enough time for the body to recognize that food was consumed. As a result, they continue to eat more food than they would have if they were mindful of their consumption.

Many people begin a diet abruptly by immediately reducing their caloric and food intake. Oftentimes these dieters become discouraged when their appetite does not readily adjust to the caloric modifications, and they suffer from feelings of hunger and deprivation. Discomfort and discouragement replace the drive to diet. As a consequence, many would be “dieters” quit their diet altogether or go through yo-yo dieting. Heretofore known and utilized devices fail to take into account the importance of change being gradual and unnoticeable, or fail to allow the user to use typical eating-ware. Instead, heretofore known and utilized devices, systems or elements—drastically alter how a person eats and makes the food restrictions glaringly obvious, which leads to feelings of deprivation and demotivation.

The main focus of the majority of diet devices heretofore proposed is either a focus on the food itself (i.e. calories, fat content, sugar content) or on the individual serving container. These devices do not take into the account that eating is a system of processes. For example, cooking, selection of eating-ware, decision of adequate portion (impacted by size of eating-ware components), selection of utensil-like eating-ware (impacts the rate of consumption unbeknownst to the user). During the process of transferring food from serving-ware into a container from which the food is eaten, the user estimates how much food to serve by visual determination. The planar view of the eating-ware component is a critical factor on the user's estimation of portion size. None of the heretofore disclosed devices or diet methods account for the fact that food portions appear visually smaller on an eating-ware component with a larger planar view. Eating-ware of the same planar view may have different depths. Most users are not aware of the fact that plate-like eating-ware can actually have a significant internal volume. A person, unaware, will serve more food on an eating-ware component of same surface dimension in a component that has greater depth. In fact some of the devices are in a shape of a box, which results in a user serving more than they would on a flat surface. In addition using a “device” as opposed to typical eating-ware would make a user more focused on being on a diet and increases the feelings of deprivation.

None of the heretofore known and utilized eating-ware devices give the user an ability to follow a numeric representation of portions on flat surfaces and portions served directly above the eating-ware components.

Moreover, none of the heretofore disclosed devices or diet methods take into account the relative size of eating-ware to other components in a setting during consumption. None of them address the importance of surrounding eating-ware accessories. That's because the focus of these devices is on food itself or they are used to measure and transfer food prior to consumption. Heretofore known and utilized eating-ware devices are not concerned with consumption processes as a system. Typically they consist of devices for measuring food contained within the device, the internal volume only.

Currently heretofore known and utilized eating-ware devices or diet methods generally fail to consider the importance of utensil-like eating-ware components that actually deliver food directly to the user and affect the rate of consumption, which is an important factor in overeating. This is because the devices do not address the most important factor of dieting, the entire eating process.

Surprisingly and unexpectedly, the incrementally-sized standard-sized eating-ware system and processes of the subject invention has determined that the entire consumption process impacts the user's ability to successfully manage their weight.

Most diet plans require a great deal of effort and “will-power” to count calories, attend meetings, choose different foods, or measure and control portion sizes. It is difficult for dieters to maintain this ritual for extended periods of time. Most people cannot accurately estimate the calorie content of the substances they consume. A person would need to know the exact quantity of each ingredient in a meal to determine the total calorie intake. Most people therefore make a visual estimation of how much to serve themselves by visually evaluating the amount of food contained on their eating-ware in relation to the size of eating-ware. This is a very inaccurate process due to the variability of typical eating-ware. There is no simple way, such as standard sized eating-ware to guide the user in selecting eating-ware components that actually affect the amount of food served and consumed, and the rate of consumption, to optimize the feeling of satiation and prevent over-eating.

As eating-ware has increased in size, normal food portions served on that eating-ware appear smaller and smaller. In response, users have increased the amount served to compensate for this illusion. No prior art addresses this critical phenomenon.

When selecting the eating-ware there are limited choices of relative sizes within a typical eating-ware set, for example: dinner plate, salad plate, desert plate, bowl, cup. Depending on a manufacturer and/or style, all these items come in a variety of different sizes and configurations. In addition to china-like eating-ware, a consumer typically adds mugs, glassware, utensils and cutlery, and eating-ware accessories to complete a serving setting. Even though visually eating-ware components of the same type may appear similar, they will deliver very different food quantities. Depending on the style or manufacturer of the eating-ware, the internal volume of the eating-ware component and the amount of food that can be served above the upper boundary of component will vary. The user does not have a way of verifying how much total volumetric capacity an eating-ware component has and/or how the different components' total volumetric capacities relate to each other. For example: a flat plate vs. a deep plate vs. a bowl vs. a cup vs. a spoon vs. a fork, etc. No heretofore known and utilized device looks at the total (internal and directly above) volumetric capacity of the eating-ware components and assigns it a numerical equivalency that can be applied across different types and/or styles of components.

Some of the heretofore known and utilized devices remain the same size throughout the diet process, while other heretofore known and utilized devices require measurement and transfer of a food portion. None of the heretofore known and utilized devices take into account the impact on the user of seeing the smaller portion served on typically sized eating-ware. As the portions get smaller the user will feel more and more deprived and therefore more and more discouraged from continuing on his/her weight management program.

The focus of heretofore known and utilized devices is on measuring food or aspects related to its properties. No heretofore known and utilized eating system or process looks at consumption as a system. The importance of visual appearance of the food served relative to the total serve-able surface area, and the impact it will have on satiation and/or consumption is largely ignored by prior art. Further, heretofore known and utilized devices, systems and processes typically do not take into account the rate of consumption that is affected by the total volumetric capacity of utensil-like eating-ware components.

Moreover, heretofore known and utilized devices, systems and methods that have indicia (spoon-like or cup-like) are typically used for measurement of food during preparation. It is not designed for consumption and the marks are used to indicate the internal volume within the mark only.

Experts believe that losing weight slowly is healthier, and that it is important to change eating habits in order to maintain permanent weight loss. Changing eating habits includes not only modifying what an individual is eating, but also altering portion amounts through portion control. Studies show that visual perception influences food consumption. People eat more when given larger portions.

Portion control adjustment over a period of time greatly facilitates healthy weight loss, as the individual's behavior towards foods and portions becomes modified. The ability of an individual to maintain healthy weight is affected by the amount of food they serve themselves and the rate they consume the food. In addition to the size of portion consumed, the rate of consumption impacts the consumer's feeling of satiation. The slower the food is consumed, the more satisfied the user will feel with lesser amount of food. One way to control that is to eat more slowly, and another is to eat less with each mouthful. The heretofore known and utilized devices do not provide a solution for the user to control the amount of food per mouthful.

Moreover, dieting can be very embarrassing in our society and most users prefer to be discreet. However, none of heretofore known and utilized devices or systems can be used at the dinner table with guests without making it glaringly obvious to everyone that the user is dieting. There is a need in the art for a discrete gradual and unnoticeable portion control device and processes which can be utilized when dining with guests, without making the user's diet glaringly obvious.

None of heretofore known and utilized devices and/or systems provide a system that utilizes formulas to determine a standard size for all eating-ware components. Heretofore known and utilized devices and/or systems do not provide a system that can be used by manufacturers to indicate the standard sizes of eating-ware components for the users, so that the users will be able to continue to stay on their weight management regimen no matter what they eat (type of food and/or type of meal), what eating-ware component they eat from (plate, bowl, cup, glass, flat surface, bag, pre-packaged-ware, etc.), what they eat with (fork, knife, spoon, straw, chop sticks, etc.), or where they eat (restaurant, cafeteria, friend's home), as long as the users verify the standard size of the eating-ware components that they are using. There is a need in the art to provide a device, system and process that yields these capabilities.

The vast majority of portion control and other dieting devices heretofore disclosed and utilized do not address gradual behavior modifications, and therefore are difficult to utilize over time. That is to say, those dieting devices and processes presently in vogue do not provide gradual portion control devices and discrete behavioral modifications. Instead, the majority of dieting devices and processes provide abrupt, immediate portion adjustments, which result in feelings of deprivation as the dieter's appetite does not so abruptly diminish. These portion control dieting devices generally involve plates or containers having partitioned or compartmentalized assemblies demarcated by a specific food group appointed to be utilized by a user on a daily basis. None of these devices concern themselves with the fact that solid foods can be served beyond the rim of the container, nor the fact that foods can be served on flat surfaces.

For various examples of these compartmentalized assemblies, see the following: U.S. Pat. No. 4,877,119 to Hosking discloses a drinking-beaker assembly including a collar and volumetric structure that is appointed to serve as both a drinking vessel, especially the drinking of water in the course of a diet, and a device for determining the precise amount of liquid consumed; U.S. Pat. No. 6,296,488 to Brenkus et al. discloses a diet method and apparatus which controls the portion size by providing a plate with a plurality of compartments associated with a meal card; U.S. Design Pat. No. D194054 to Grossman discloses an ornamental design for a plate having three compartments, wherein each of the compartments includes a picture symbol representing the food group which is to be portioned in the respective compartment; U.S. Design Pat. No. D200867 to Haifley discloses an ornamental design for a plate or dish wherein approximately one-half of the structure includes caloric indicia thereon, which does not appear to be utilized for holding food, while the other half seems to be appointed for holding food; U.S. Design Pat. No. D281849 to Cantor discloses an ornamental design for a diet plate that utilizes curved rib portions to apparently form food dividers or compartments to separate food items or portions; U.S. Patent Application Publication No. 2006/0029698 to Watson et al. discloses a food template adapted to be removably applied to a food bearing surface of a food holder, such as a plate to define a plurality of areas for food portions to be placed; Foreign Publication No. GB 2119633 to Mackay discloses a compartmented plate divided into different regions which are marked in a different manner, such as by color coding, to indicate the different types of foods intended to be placed in each region; and “The Diet Plate®—Portion Control Made Easy” found at www.thedietplate.com discloses a weight management system consisting of plates and cereal bowls for a family wherein the plate or cereal bowl includes markings therein to indicate the given food groups and respective portion sizes.

These portion control dieting devices do not resemble eating-ware components that are typically used by most users today, and cannot be applied to typical devices that may be utilized in the future. They are cumbersome and either glaringly announce to the user and his/her companions that the user is on a diet, or force them to measure and transfer food prior to serving for consumption. Further, these portion control devices do not address all aspects of eating-ware one eats from, or eats with, or pre-served prepared sources of food or prepackaged food. These portion devices do not adjust in size in a discrete and gradual manner, at increments so small that the small changes are virtually unnoticeable by the user. Moreover, none of these devices address the rate at which food is transferred directly to the user's mouth. They ignore the fact that a flat plate, a fork or a flat surface has a volumetric capacity to deliver food portions, and that eating-ware with an internal volume also has capacity to deliver solid foods directly above the rim of the eating-ware. None of these devices address the importance of the relative size of all components that make up a setting, nor the need for incrementally-sized standard sized series of eating-ware settings.

Additionally, the indicia used on heretofore disclosed devices and methods are either decorative or used for specifying areas of a plate to be used for particular type of food. None of the indicia is used to help the user select sequential standard sizes of typical eating-ware components which relate to the total volumetric capacity to hold food within and directly above the eating-ware component. None of the heretofore disclosed devices and methods can help a user to size their current or future eating-ware components. The indicia described in heretofore disclosed devices and methods used for measurement generally refer to the volume contained within the indicated mark or within the component. None of the heretofore disclosed devices and methods take into account the volume of food that can be served directly above the eating-ware or the fact that some eating-ware has no internal volume. Depending on the shape of the utensil-like eating-ware component, very different amounts of food can be delivered per each mouthful. None of the heretofore disclosed devices and methods that have these indicia concerns itself with these aspects because the purpose of heretofore disclosed devices and methods is for measurement of ingredients during food preparation and not during consumption.

For repositionable compartmentalized devices see: U.S. Pat. No. 4,966,295 to Parrish, which discloses a compartmentalized dieting plate having a partitioned assembly that divides the plate to form predetermined fluid capacity compartments, and in which the partition assembly may be repositioned to adjust the compartmentalized capacities as a dieters requirements change; and U.S. Pat. No. 5,007,743 to Brennan, which discloses a food metering dish including a dish member with a continuous surrounding wall defining an interior cavity having first and second concave recesses for receiving metered containers there within, the recesses being appointed with ribs with removable partition walls to form compartments for food portions for controlling amounts served.

These types of devices do not change the overall dimensions and/or the visual planar reference the food is served on and are not meant to be eaten from in a daily lifestyle. They may help the user if the food type is such that each ingredient can be separated. Many foods today come as a mixture of ingredients and this type of device would be very cumbersome to use with mixtures. Further, these devices could not easily be used in a work environment or in a restaurant and they do not resemble typically used eating-ware, which would make it glaringly obvious to the user and his/her companions that the user is observing portion restriction.

Aforementioned compartmentalized plates and containers all share numerous disadvantageous stemming from abrupt changes in a person's diet. A portion conditioning incrementally-sized standard-sized eating-ware set is not provided. Rather, these compartmentalized dieting plates utilize dividers to form compartments for holding food to be consumed. As the portion amounts are not gradually, unnoticeably adjusted, but are rather immediate, the user will quickly feel deprived and suffer from hunger as his or her appetite is not gradually adjusted with these devices. Behavior modification is not achieved over a gradual period of time. Moreover, these devices all create a negative emotional impact on the user, as they do not discretely provide portion control mechanism. During a dinner with friends or family it will be highly obvious that the user is on a diet or subject to portion control. Moreover, none of these devices provide the ability to gradually and unnoticeably adjust one's food portions through implementation of an incrementally-sized standard-sized eating-ware set that resembles typical eating-ware components.

Even wherein systems and processes of modifying eating habits of a user are provided, rather than just portion control, these devices fail to provide an eating-ware component set that provides incrementally-sized standard-sized eating-ware components which so resemble regular eating-ware components, that a dieter (as well as others eating with the dieter) can soon forget he or she is practicing portion modification.

These devices fail to provide eating-ware components that look like typical eating-ware. These devices fail to provide a system where the user has the flexibility to eat any type of food and continue to stick to the weight management program. The incrementally-sized standard-sized eating-ware system formulas can be applied to determine standard sizes of existing eating-ware components. These devices fail to provide the user with the ability to continue their weight management program regardless of type of eating-ware components used. There is a need in the art for an incrementally-sized standard-sized eating-ware component system wherein any eating-ware item for eating food from and/or eating food with can be used as long as the formulas are applied to determine the standard size and/or sizes of the eating-ware component. Further, there is a need in the art for an incrementally-sized standard-sized eating-ware component system that can be applied to pre-packaged food eaten directly out of the packaging. None of the heretofore known devices or systems enable a user to continue his/her weight management regimen when eating directly out of pre-packaged containers.

Fluid consumption can greatly add to the total consumption of the caloric intake, especially alcohol, sodas, and fruit drinks. There is no heretofore known device or system that helps to control the gradual decrease in these high calorie consumables through a numerically guided incrementally adjustable system.

For example, U.S. Pat. No. 7,044,739 to Matson discloses a system and processes for modifying eating habits of a user by providing a set of fixed volume graduated containers that are subdivided into sections and provide a user with means to control the volume of food consumed over time. In a weight loss program, a user is provided with a set of the graduated sectioned containers and migrates from measuring the amount of food per meal with a larger fixed volume container to measuring the amount of food per meal with a smaller fixed volume container. Unfortunately, the sectioned containers cannot feasibly be utilized in a discrete manner on a dinner table during regular meals. This has particular impact when one has dinner guests, and/or when a parent is attempting to gradually, and discretely, modify eating habits of a child. Moreover, meals require constant measuring and compartmentalizing food to be consumed. The dieter is constantly burdened with the task of loading each compartment, and is constantly reminded of his or her diet during eating. This device appears to be a deep container, which would make the portions appear even smaller from top view perspective and lead to further feeling of deprivation.

These types of diets make it very difficult for a dieter to eat outside of their home environment. In addition, they cannot be used to control liquids or the rate at which a person consumes food.

Obesity is becoming an epidemic that affects not only adults but also an increasing number of children. Family diet techniques become a necessary prerequisite for addressing weight problems that affect parents and their children when unhealthy eating habits become infused in the home. None of the weight loss or diet devices heretofore disclosed and utilized give parents a simple tool to quickly adjust a child's portion as the child grows, in order to help the child maintain healthy weight. Children of the same age may have drastically different caloric requirements depending on their build and growth spurts, and many other factors. None of the weight loss or diet devices heretofore disclosed and utilized address this important issue of giving parents and children a simple tool like a number system to follow when selecting their eating-ware.

Some of the heretofore disclosed and utilized weight loss or diet device's components remain the same size throughout the diet process, while others require measurement and transfer of a food portion. None take into account the impact on the user of seeing a smaller portion served on typically sized eating-ware. As the portions get smaller the user will feel more and more deprived and therefore, more and more discouraged from continuing on his/her weight management program.

Children consume a significant portion of their food outside of the home. None of the heretofore disclosed devices or diet methods provide a system that a young child can implement independent of the parent, for example at school. None of the heretofore disclosed devices or diet methods consider the system that a child can use to prevent being overweight as soon as the child knows letters and numbers.

Notwithstanding the efforts of prior art workers to construct an efficient dieting device and methods for modifying eating habits, there remains a need in the art for an incrementally-sized standard-sized eating-ware system and processes that provides gradual and unnoticeable food portion reduction, so that a user can modify his/her eating habits for effective weight management without feelings of deprivation. There remains a need in the art for an incrementally-sized standard-sized eating-ware system that provides a plurality of incrementally-sized standard-sized eating-ware components having successively decreasing standard size appointed to be utilized in a graduated manner over a period of time. Further, there remains a need for using a set of formulas that allow for standard sizing of the total volumetric capacity of eating-ware components, which includes the internal volume and the volume directly above the eating-ware component. There remains a need for numerical representation of the sizing that can be applied to eating-ware components and represent the total volumetric capacities of eating-ware components so that the user can follow with ease as he/she uses these incrementally-sized standard-sized eating-ware components to follow in an incremental fashion a regimen of weight management. Moreover, there remains a need in the art for a eating-ware system that provides a plurality of eating-ware components that incrementally adjust the structural dimensions to present a series of incrementally-sized standard-sized replicas of each component and therefore incrementally, gradually adjust the user habits and help the user become accustomed to consuming smaller portions over time and at a slower rate per mouthful.

There remains a need for a system of eating-ware component series that can be used by a consumer to adjust food portion size and the rate of food portion delivery with each mouthful in small increments without the feeling of deprivation. There remains a need for a system of formulas that will enable the user to eat from any type of eating-ware regardless of shape or type of eating-ware, and continue to maintain his/her weight management program. There remains a need in the art for an eating-ware system that not only controls the amount of food served as a portion but also controls the rate food is consumed with each mouthful. There remains a need for eating-ware that will enable the user to use typical eating-ware components as incrementally-sized standard-sized settings and/or as individual components and maintain weight through control of portion size and the rate of food consumption by selecting eating-ware of a standard size.

Additionally, there is a need in the art for an incrementally-sized standard-sized eating-ware set that utilizes a plurality of eating-ware components having successively decreasing standard size which become decreased by way of small increments to provide subtle changes in portion amounts served, so that a user does not feel deprived and can gradually and unnoticeably modify food portions consumed and establish healthy eating habits for effective weight management. There remains a need for a Caloric Density Mark System that will give a user a quick estimation of caloric food content.

### SUMMARY OF EMBODIMENTS OF THE INVENTION

Aspects of the present invention are achieved by providing a diet management system, including a plurality of different-sized templates, each template having the same shape and defining a size of a food portion in accordance with a standardized eating system. Each template is collapsible for storage and/or transportation, and each template includes indicia demarking the correspondence of the template with the standardized eating system.

Aspects of the present invention are also achieved by providing a diet management system, including a plurality of different-sized templates, each template having the same shape and defining a size of a food portion in accordance with a standardized eating system. Each template encloses a volume, and each template includes indicia demarking the correspondence of the template with the standardized eating system.

Aspects of the present invention are also achieved by providing a method of employing a plurality of different-sized templates. The method includes selecting one of a plurality of different-sized templates. Each template of the plurality of templates has the same shape and defines a size of a food portion in accordance with a standardized eating system. Each template includes indicia demarking the correspondence of the template with the standardized eating system. The method also includes collapsing the selected template; transporting the collapsed template; bringing template to its expanded, full size; and employing the expanded template to define a size of a food portion on dishware that does not include indicia demarking a correspondence to a standardized eating system.

Aspects of the present invention are also achieved by providing a method of employing a plurality of different-sized templates. The method includes projecting a selected one of the plurality of template as an image on a surface area of dishware to define a size of a food portion, each template of the plurality of templates defining a size of a food portion in accordance with a standardized eating system. Each template includes indicia demarking the correspondence of the template with the standardized eating system.

Additional and/or other aspects and advantages of the present invention will be set forth in the description that follows, or will be apparent from the description, or may be learned by practice of the invention.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1a illustrates a schematic view of a stack of eating-ware components of the incrementally-sized standard-sized eating-ware system, which when flat represent Standard Size surfaces of SPS and SSS;

FIG. 1b illustrates a schematic view of some of the incrementally-sized standard-sized eating-ware components separated from the set/stack of FIG. 1a;

FIG. 2 illustrates a schematic view of an embodiment of the incrementally-sized standard-sized eating-ware system wherein the set further includes optional incrementally-sized standard sized glasses and bowls;

FIG. 3a illustrates a schematic view of optional incrementally-sized standard sized forks;

FIG. 3b illustrates a schematic view of optional incrementally-sized standard sized spoons;

FIG. 4 illustrates a schematic view of incrementally-sized Standard Portion Size (SPS) and incrementally-sized Standard Snack Size (SSS), where a single integer increment in size of SPS represents the diameter incremental increase of 2*X=¼ inch and the single integer increment in size of SSS represents the diameter incremental increase of 2*X=⅛ inch, and where the smallest diameter for SPS is 4 inches and for SSS=0 inches;

FIG. 5 illustrates a schematic view of incrementally-sized Standard Bite Size and/or Standard Nibble Size based on a flat elliptical surface;

FIG. 6 illustrates the standard-sized eating-ware total volumetric food delivery capacity and relationship between variously shaped standard-sized eating-ware components;

FIG. 7 illustrates a schematic view of incrementally-sized Standard Size settings;

FIG. 8 illustrates a schematic planar view of the illusion created by a food portion placed on round flat surfaces that increase in diameter (this illusion leads to portion size distortion, whereby the portions appear smaller and smaller as the round flat surface increases even though the portion size remains constant);

FIG. 9 is a perspective view of a template in accordance with an embodiment of the present invention;

FIG. 10 is a perspective view of another template in accordance with an embodiment of the present invention;

FIG. 11 is a perspective view of templates in accordance with an embodiment of the present invention, all of which have the same standardized size;

FIG. 12 is a perspective view of templates in accordance with an embodiment of the present invention, all of which have the same standardized size;

FIG. 13 is a perspective view of templates in accordance with an embodiment of the present invention, all of which have the same standardized size;

FIG. 14 is a perspective view of another template in accordance with an embodiment of the present invention;

FIG. 15 is a perspective view of another template in accordance with an embodiment of the present invention;

FIG. 16 is a perspective view of a plurality of templates in accordance with an embodiment of the present invention;

FIG. 17 is a partial perspective view of a plurality of templates in accordance with an embodiment of the present invention, with tops thereof removed for clarity;

FIG. 18 is a perspective view of another plurality of templates in accordance with an embodiment of the present invention;

FIG. 19 is a perspective view of another plurality of templates in accordance with an embodiment of the present invention;

FIG. 20 is a perspective view of a template in accordance with an embodiment of the present invention;

FIG. 21 is a cross sectional view of the template of FIG. 20 taken along line 21-21;

FIG. 22 is a perspective view of a template in accordance with an embodiment of the present invention;

FIG. 23 is a cross sectional view of the template of FIG. 20 taken along line 23-23;

FIGS. 24-26 illustrate a method of using the template of FIG. 20;

FIG. 27 illustrates food partitioned by a template in accordance with an embodiment of the present invention;

FIGS. 28 and 29 illustrate projection of a template in accordance with an embodiment of the present invention;

FIGS. 30 and 31 are flowcharts of software in accordance with an embodiment of the present invention;

FIG. 32 is a block diagram of a software program in accordance with an embodiment of the present invention;

FIG. 33 is a representation of statistical data output by the software program of FIG. 32;

FIG. 34 is a perspective view of a handle and interchangeable utensil portions in accordance with an embodiment of the present invention;

FIG. 35 illustrates and embodiment of a display of the handle of FIG. 34;

FIG. 36 is a perspective view of a plurality of different-sized utensils for use with the handle of FIG. 34; and

FIGS. 37 and 38 are block diagrams representing methods of using the handle of FIG. 34.

### DEFINITIONS

The term “Caloric Density Mark” refers to a letter representation of the caloric density of food in terms of calories per cubic inch, wherein the Table A below lists the letters and the amount of calories per cubic inch they represent.

TABLE A
Caloric Density Mark

| Letter | Calories per | Letter | Calories per |
|---|---|---|---|
| designation | cubic inch | designation | cubic inch |
| A | 0-10 | N | >130-140 |
| B | >10-20 | O | >140-150 |
| C | >20-30 | P | >150-160 |
| D | >30-40 | Q | >160-170 |
| E | >40-50 | R | >170-180 |
| F | >50-60 | S | >180-190 |
| G | >60-70 | T | >190-200 |
| H | >70-80 | U | >200-210 |
| I | >80-90 | V | >210-220 |
| J | >90-100 | W | >220-230 |
| K | >100-110 | X | >230-240 |
| L | >110-120 | Y | >240-250 |
| M | >120-130 | Z + number | for amounts over |
| | | | 250 |

The term “delta”, as used herein, means an incremental difference.

The term “eating-ware”, as used herein, means any object/surface from which food is directly consumed or with which food is transferred directly into the user's mouth, including but not limited to: disposable and non-disposable eating-ware; eating-ware having a round, oval, square, cylindrical, cubic, irregular, polygonal, or a variety of shape configurations; objects one eats from such as tableware, dish-ware, drink-ware, beverage containers, snack-ware, designated eating surface, standard portion template (thin, food-safe material), food packaging, plates, bowls, cups, mugs, glasses, food trays, sushi boards, paper plates, juice boxes and juice bags, frozen food trays, plastic bags, bottles, fast food containers, bags, etc.; eating-ware used to transfer food directly to the user's mouth such as flatware, silverware, utensils, cutlery, straws, chopsticks, wooden sticks, etc.; packaged-ware or pre-measured-ware that contains prepackaged foods that consumer eats directly from the package.

The term “eating-ware accessories”, as used herein, means items/objects that are used alongside eating-ware as part of a table-ware setting, for example: place mats, napkins, etc.

The term “food delivery capacity”, as used herein, means the total volumetric capacity of an eating-ware component to deliver volume of food within the boundaries of its rim and directly above its rim. The volume of food contained inside—liquid equivalent plus the ability of the item to hold food directly above the rim when solid food is being served. The volumetric food standard portion sizes: SPS,SSS,SBS,SNS; take into account the total volumetric food delivery capacity of an eating-ware component.

The term “food”, as used herein, means any consumable substance, nutritious and non-nutritious, such as meals, snacks, beverages, alcohol, etc., that may be consumed by an individual.

The term “Food Consumption Rate (Rate of Food Consumption)”, as used herein, means the amount of food transferred directly to the user per Standard Bite and/or Standard Nibble.

The term “Incrementally-Sized Standard-Sized Eating-ware System”, as used herein, generally means a system for management of daily consumption of food for preventing excess weight gain and for weight adjustment and/or maintenance including:
using formulas in a device, process or system for calculating standard sizes, and
using formulas/calculations in a device, process system that define the relationship between various standard-sized eating-ware components and the standard sizes for the purpose of cross-referencing and to use exchangeably (interchangeably), and
incrementally-sized standard-sized eating-ware components, and
indicia or other means of indicating a numerical standard size, and
processes for using the incrementally-sized standard-sized eating-ware for weight management, and
a series of multi-type incrementally-sized standard-sized eating-ware settings

The term “Incrementally-sized standard-sized eating-ware settings”, as used herein, means a series of multi-type incrementally-sized standard-sized eating-ware settings where components within each setting maintain relative proportion to other components within the setting, to minimize the perception of the incremental changes. Each setting in the series makes up a series of congruent sets.

The term “prepackaged food”, as used herein, means foods (such as candy, cookies, crackers, frozen dinners, etc,) that are served in commercial packaging and may be consumed directly out of packaging (such as bags, boxes, flat sushi boards, trays, fun shaped containers, etc.)

The terms “pre-served food” or “pre-measured food”, as used herein, mean prepared food that is already portioned out and may be served at a buffet, cafeteria or other eateries.

The term “process”, as used herein, means a systematic series of adjustments in incrementally-sized standard-sized eating-ware components standard sizes in a variety of combinations to adjust and/or maintain food consumption and consequently weight.

The term “setting”, as used herein, means multiple types of eating-ware components used together at the same time. Similar to a “place setting” or “table setting”. For example a setting may include any or all: dinner plate, salad plate, soup bowl, dessert plate, bread plate, spoons, forks, knives, other utensils, glass, cup, mug, wine glass, etc.

The term “Standard Bite Size (SBS)”, as used herein, means a numerical representation of a volume of food that can be contained in an ellipsoid that is formed around a flat elliptical (spoon-like) shape defined by the formula for SBS (See FORMULAS section).

The term “Standard Eating-ware”, as used herein, means an eating-ware component that has an established and/or known SPS, SSS, SBS, and/or SNS.

The term “Standard Nibble Size” (SNS), as used herein, means a numerical representation of a volume of food that can be contained in an ellipsoid that is formed around a flat elliptical (spoon-like) shape defined by the formula for SNS (See FORMULAS section).

The term “Standard Eating-ware”, as used herein, means an eating-ware component that has an established and/or known SPS, SSS, SBS, and/or SNS

The term “Standard Food Portion Sizes”, as used herein, means all four Standard Sizes: SPS, SSS, SBS, and SNS.

The term “Standard Portion Size” (SPS), as used herein, means a numerical representation of a volume of a 1 inch high cylinder formed above a flat round surface defined by the formula for SPS (See FORMULAS section).

The term “Standard Size”, as used herein, means Standard Portion Size, and/or Standard Snack Size, and/or Standard Bite Size, and/or Standard Nibble Size.

The term “Standard Snack Size” (SSS), as used herein, means a numerical representation of a volume of a 1 inch high cylinder formed above a flat round surface defined by the formula for SSS (See FORMULAS section).

The term “style” of Standard-sized Eating-ware Component as used herein, refers to different appearances or configurations of a given type of eating-ware, for example: rimless plate vs. rimmed plate, round plate vs. square plate, tall thin glass vs short fat glass, deep bowl vs. shallow bowl, round spoon vs. oval spoon etc.

The term “Total Volumetric Capacity”, as used herein, means a Total Volumetric Food Delivery Capacity of an eating-ware component which is the sum of the volume inside the eating-ware component and the volume of a designated space directly above eating-ware component.

The term “type” of Standard-sized Eating-ware Component, as used herein, means for example: plate, cup, spoon, knife, bag, designated surface, pre-packaged food container, etc.

### DETAILED DESCRIPTION OF EMBODIMENTS OF THE PRESENT INVENTION

The incrementally-sized standard-sized eating-ware of the subject invention allows a user to serve and eat directly from a typical eating-ware component that has an established standard size, with no need for measurement or transfer. None of heretofore disclosed and utilized eating-ware devices and systems allow the user to use a flat surface and/or existing eating-ware unless they pre-measure food and/or transfer it from the device. Heretofore disclosed and utilized eating-ware devices and systems require the use of the device in order to maintain a weight program. This concept is non-transferrable to other devices whereas the incrementally-sized standard-sized eating-ware of the subject invention is applicable to all eating-ware.

None of the weight loss or diet devices heretofore disclosed and utilized address the standard portion size or standard snack size (SPS; SSS) for enabling the incremental adjustment of food amounts based on a numerical standard that represents total volumetric food capacity of an eating-ware component. Additionally, none of the above diet devices address the importance of standard size of the utensils and utensil-like eating-ware components using standard bite size (SBS) and/or standard nibble size (SNS) which affect the rate at which food is consumed. Consumers today can eat food directly out of the packaging, where none of these devices would assist the user in anyway unless they transfer and measure the food into another device and transfer back for consumption. The SPS, SSS, SBS, and/or SNS can be assigned to any prepackaged foods based on a total volumetric capacity equivalence to help guide the user to stick to his/her standard size and control his/her weight without having to transfer the food from the pre-packaged vessel. This is not possible with prior art devices. The prepackaged food does not carry indicia indicating standard sizes and/or Caloric Density Mark to help user make better food choices.

When the user knows the SPS, SSS, SBS, and/or SNS total volumetric capacity equivalent and the Caloric Density Mark, the user is able to quickly estimate the caloric content of his/her meal. No heretofore disclosed and utilized device presents this capability.

In addition food can be served on flat surfaces. Heretofore disclosed and utilized devices would require the user to transfer the food to the “measuring device” first and then place it on the flat serving surface. A flat surface or an area emphasized on a flat surface can have an assigned SPS, SSS, SBS, and/or SNS to help guide the user and maintain his/her weight management process. None of prior art has this capability.

The incrementally-sized standard-sized eating-ware system and processes provide a set of formulas that allow for standard sizing of the total volumetric food delivery capacity of eating-ware components, where the total volumetric food delivery capacity includes both the internal volume and the volume directly above the eating-ware component. The incrementally-sized standard-sized eating-ware system and processes further provide numerical representation of the sizing that can be applied to eating-ware components and represent the total volumetric capacities of eating-ware components so that the user can follow with ease as he/she uses these incrementally-sized standard-sized eating-ware components to follow in an incremental fashion a regimen of weight management. The incrementally-sized standard-sized eating-ware system and processes can be used by a consumer to adjust food portion size and the rate of food portion delivery with each mouthful in small increments without the feeling of deprivation. Moreover, the incrementally-sized standard-sized eating-ware system and processes enables the user to eat from any type of eating-ware regardless of shape or type of eating-ware, and continue to maintain his/her weight management program.

The amount of food served as a portion is controlled by use of the incrementally-sized standard-sized eating-ware system and processes, while also providing control for the rate of food consumed with each mouthful. The incrementally-sized standard-sized eating-ware system and processes provide eating-ware that will enable the user to use typical eating-ware components as part of an incrementally-sized standard-sized setting and/or as a single component, and maintain weight through control of portion size and the rate of food consumption by selecting a eating-ware of a standard size. Use of typical eating-ware components that are sized using the formulas for standard sizes for portion, snack, bite and nibble size of the incrementally-sized standard-sized eating-ware system and processes, can be identified with numerically based indicia for ease of identification of the standard size, and these components are available in a series of incrementally-sized replicas, so the user can transition from one to the next in the series without feeling the effect of change. A user is able to maintain his/her program for weight management regardless of type of food consumed and/or the type of eating-ware component used to help the user adjust and/or maintain the amounts of food consumed and/or the rate of consumption and maintain a healthy weight.

The incrementally-sized standard-sized eating-ware system utilizes a set of formulas to establish and/or identify standard sizes for the total volumetric food delivery capacity of eating-ware components, where the total volumetric food delivery capacity includes both the volume inside and a volume directly above the eating-ware component. This food delivery capacity determines the total food served for eating-ware components from which the food is eaten and the rate of food transfer/consumption for eating-ware components with which the food is eaten.

The amount of food/substance a user consumes is a function of his/her visual assessment of food/substance amount relative to the serving container. The serving surface area, especially the planar view, is an important aspect of this assessment. FIG. 8 shows how visually the portion appears smaller on a larger diameter surface. The formulas are based on incrementally decreasing surface areas, which optimizes the users visual planar perception of adequate portion size and the rate of consumption, and as a result minimizes the emotional impact on the user as the user adjusts the standard size of his/her eating-ware components.

The formulas establish four types of standard sizes: Standard Portion Size (SPS) and Standard Snack Size (SSS), which are used for determination of total volumetric food delivery capacity; and Standard Bite Size (SBS) and Standard Nibble Size (SNS), which are used for rate of total volumetric food delivery capacity per mouthful. The formulas for standard size can be applied to any eating-ware, regardless of internal and/or external configuration, and establish relationships between different styles and types of eating-ware, enabling the user to continue the weight management efforts regardless of the eating-ware used.

When utilizing the incrementally-sized standard-sized eating-ware system and processes a user selects a starting standard size based on a combination of weight management factors, and over time successively shifts to eating-ware components having smaller/larger standard size. The incrementally-sized standard-sized eating-ware system and processes utilize a plurality of eating-ware components having successively decreasing standard size that decrease by way of small increments to provide subtle changes in portion amounts served and/or in the rate of food consumption, so that a user does not feel deprived and can gradually and unnoticeably modify food portions consumed and establish healthy eating habits for effective weight management.

The incrementally-sized standard-sized eating-ware system comprises a plurality of incrementally-sized standard-sized eating-ware components forming a set. Each of the incrementally-sized standard-sized eating-ware components in the set has a standard size that is different from the successive or neighboring eating-ware component. Successively decreasing standard size provides different food volumes/portion sizes. As a result the total amount of food and the rate the food is transferred to the user subtly changes with each incremental adjustment.

The standard size successively decreases by an increment so that as a user shifts from each consecutive eating-ware component, the user gradually and unnoticeably decreases (or increases, depending on weight management needs) his/her portion and/or rate of food consumption over time.

Additionally, weight management processes/methods utilizing the incrementally-sized standard-sized eating-ware system are provided. The first step of the process involves a user selecting a starting eating-ware component, based on the user's weight goals. The starting eating-ware components are selected from a plurality of incrementally-sized standard-sized eating-ware components having successively decreasing standard size. Standard size of each of the incrementally-sized standard-sized eating-ware components are successively differentiated by an increment in order to modify the rate of food consumption and/or food portion intake delivered to a user. The user's selection of the starting eating-ware component can be determined, based on at least one weight management factor. Next, the user utilizes the starting eating-ware components for a designated time interval in order to deliver a starting food portion amount to the user and/or control the food delivery rate, during a meal. When a designated time interval is reached, the user adjusts his/her food portion amount by shifting to a successive eating-ware component selected from the incrementally-sized standard-sized eating-ware components that will deliver a differentiated food portion amount and/or the food delivery rate. Gradually, food portion amounts are adjusted as the user continuously shifts to each successive eating-ware component selected from the incrementally-sized standard-sized eating-ware components each time the designated time interval is reached. Portion amounts and/or rate of food consumption are gradually and unnoticeably modified until the user becomes accustomed to each rate and portion amount and reaches the weight goal. The rate the food amount is adjusted depends on the size increment of successive components selected from the incrementally-sized standard-sized eating-ware. Through continuous use and adjustment as needed of the standard sized eating-ware components, the user can maintain his/her ideal weight and continue to consume healthy food portions.

The incrementally-sized standard-sized eating-ware can also be used to help a user decrease the consumption of undesirable substances, for example alcohol, coffee, sodas, and/or specific foods that they need to limit due to their health specific considerations. The system can also be used to increase the consumption of more desirable substances like drinking water and/or eating more vegetables.

The system components can be used individually or in combination to help a user optimize her/his consumption and quickly adjust his/her total consumption and rate of consumption in response to life style changes to achieve and maintain healthy weight and or lifestyle. The incrementally-sized standard-sized eating-ware system enables the user to adjust the amounts they consume and/or the consumption rate with every meal, without having to measure, count and or record their consumption. As long as the user uses the incrementally-sized standard-sized eating-ware system, the user can continue her/his weight regimen process throughout his/her lifetime. For example, the user may decrease the standard size of his/her eating-ware components on days when he/she can't exercise, around holidays, days of lower activity level due to illness or other life stresses.

The incrementally-sized standard-sized eating-ware helps users gradually, virtually subliminally if needed, reduce the amount of food they consume with each meal and change how fast they consume their portion amount served. The numerical system makes it easy for users to maintain their consumption process regardless of the location the system is implemented. The flexibility of the system enables a user to create unlimited combinations to manage their own consumption process their own way.

The caloric density of food can be calculated and a Caloric Density Mark can be established for any food. Prepackaged food can have indicia indicating standard sizes as well as Caloric Density Mark to help user make better food choices. Any food served can also be identified with the Caloric Density Mark indicated on books, guides, software, charts, menus, signs, and/or labels.

Combining the total volumetric capacity with the concept of caloric food densities will help the user manage their consumption. Users that have modified diets to limit certain types of foods, for example, diabetics may use the incrementally sized standard-sized eating-ware components for individual type of food or number of standard bites or nibbles per meal per day.

The program can incorporate charts and/or software for selection and/or determination of factors that determine the transition rate of each consecutive standard size. Software can be provided to give a person a single number that will represent their total consumption for the day.

Because the standard sizes are based on total volumetric capacity, the sizes can be assigned to any eating-ware components regardless of what measurement system they were produced under. This is an additional advantage to the incrementally-sized standard-sized eating-ware system which creates a single global standard for all eating-ware components.

For illustrative purposes, the invention has been described in the specification and drawings with reference to round and elliptical eating-ware components. It will be understood by those skilled in the art that the incrementally-sized standard-sized eating-ware can have a wide variety of shapes which are other than round or elliptical. Substantially any eating-ware shape that permits incremental changes to be made in the surface area and/or total volumetric food delivery capacity of the incrementally-sized standard-sized eating-ware is intended to fall within the scope of the invention.

The Incrementally-Sized Standard-Sized eating system and processes of the present invention comprise using a series of Incrementally-Sized Standard-Sized templates/objects to represent, identify and/or deliver Standard Food Portion Sizes as defined within, where their volumetric portions of food are based on formulas that establish and assign Standard Food (Substance) Portion Sizes to the templates/objects, visual representations (printed or digital, projected or emitted images) of food amounts and/or Standard Food Portion Sizes and/or eating-ware, where the standard sizes are based on a series of incrementally-sized flat surfaces, and the flat surfaces establish the basis for total volumetric capacity equivalents, and the total volumetric capacity equivalents comprise volume inside the eating-ware and directly above the eating-ware, and the standard sizes are used as a guide to control amount and rate of food consumed for weight management.

Users make visually based decisions when it comes to serving food and other substances. Currently there is no standardized way of presenting users a standardized food portion size for them. The current guides try to demonstrate to user one-size-fit-all portion size by comparisons to typical objects like a deck of cards or a ball, for example. None of these objects are standardized in volumetric dimensions. Users are told to follow the size of their palm to judge their portion size. The caloric value (portion size) varies due to many factors. By nature, as we are young and growing our portion size increases as we grow to an adult, as we get older the portion size needs to decrease due to a loss of muscle as we age. The size of your palm does not significantly change as we age and in fact it will increase for an overweight person guiding them to consume more food. Every individual will be impacted by many factors like amount of exercise and levels of activity, by the time of the day they choose to consume food, by lifestyle changes due to career changes, moving to different location, getting married, getting pregnant, having children, etc. Change is a the only constant factor that we can count on. Therefore each user will have a unique incrementally-sized standard-sized food portion that is individually sized for the adjustments needed to maintain, increase or decrease weight to maintain healthy lifestyle.

Childhood obesity with its implications of lower self-esteem, depression, increase in diabetes and heart disease are a symptom of one-size-fit-all and one-size-fit-big portion sizes. School cafeterias, kids meals are currently training children to consume more than they need. Incrementally-sized standard-sized eating-ware, templates/objects, images, can be used to train the child to consume portion sizes that are just right for their unique situation so that obesity an related complications may be prevented.

The present invention establishes a numeric value to a volumetric food portion in a way that the incremental standard food (substance) portion size increase and/or reduction is achieved at an increasing/decreasing and/or constant rate. Templates/objects, or visual representation thereof, that physically and/or visually represent each Incrementally-Sized Standard-Sized can be used for comparison when serving and/or for training the users to learn an/or establish what is his/her Standard Food Portion Size that's right for their weight goal achievement. These templates/objects, or visual representation thereof, that physically and/or visually represent each Incrementally-Sized Standard-Sized may be made out of solid products like (hockey puck like, egg-like, ball like, for example) plastic, wood, metal, paper, etc. They may be hollow inside and/or may collapse for ease of carrying. They may be made of single or multiple pieces (like plastic Easter eggs, for example). They may be stackable so that the outer larger container contains “nested” (like a Russian nested doll) smaller incremental containers. They may be inflatable, like a beach ball or expandable like a dry sponge, or fillable like a paper or plastic bag, or re-shapeable like play dough etc. that represent the incrementally-sized standard-sized food portions volumetric equivalents. They can be ring-like of different shapes where, the top end and/or bottom end is not enclosed so they stack each shape within the other for ease of packaging and/or storage; made of solid, flexible and/or collapsable materials and used for a comparison, demonstration, delineation, and/or designation of surface and/or space, and use of these templates/objects and/or visual representation to guide and/or control their subsequent meal and/or meal components by controlling incrementally-sized standard-sized portion served and consumed or define the surface area served for consumption.

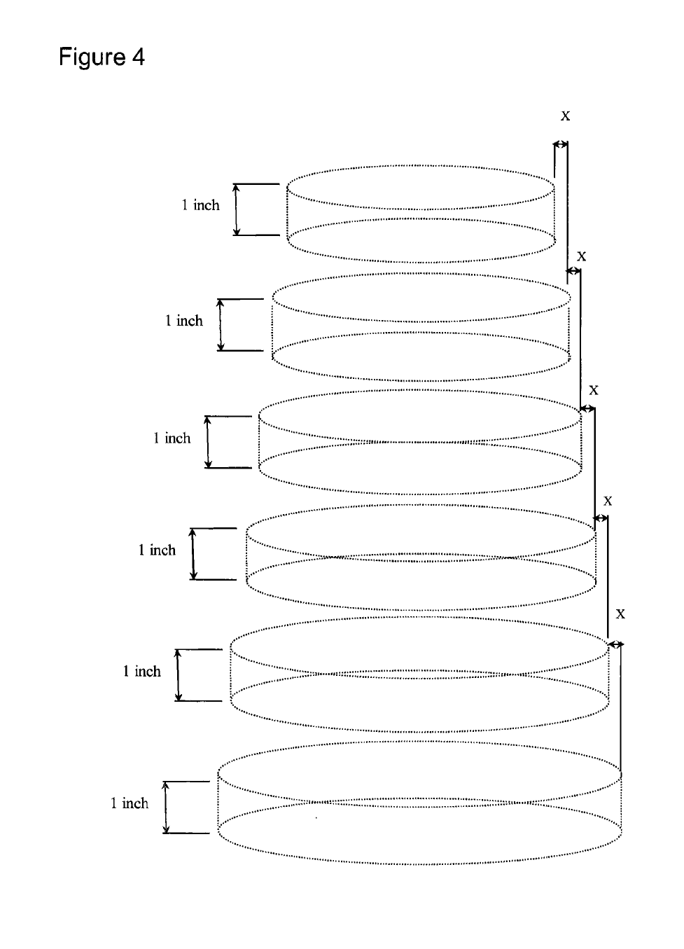

Some of the Incrementally-Sized Standard-Sized templates/objects could be used to cut (like a series of round cookie cutter-like devices or burger making devices see FIG. 4) a specific Standardized Food Portion Size or to measure it out (ring-like structure). Concentric rings (hollow roll like shapes, fixed or flexible, see FIG. 4) can be used to demonstrate or measure out the SPS and SSS Standard Sizes and be stacked within each other for ease of storage and shipping. The user can use the Standard Sized template/objects or their visual volumetrically representative images to visually compare the portion that is being served to his/her Standard Food Portion Size portion size. Having the visual representation of the portion will make it easy to estimate the portion s/he needs to serve and/or consume when incrementally-sized standard-sized eating-ware components are not available or to serve the portion on non-standardized eating-ware. After a while of using the template/representative (equivalent volumetrically) objects or their visual representation in printed and/or digital and or similar format, the user will be able to have a better visual estimation of his/her portion and be able to control the amount of food consumption. When a user finds a need to lose weight the user will select an incrementally-smaller standard-sized portion template/representative (equivalent volumetrically) objects or their visual representation in printed and/or digital and or similar format, and use it for a period of time. If the user does not succeed in desired weight reduction the user will shift to the following smaller Standard Food Portion Size item. These template/representative (equivalent volumetrically) objects or their visual representation in printed and/or digital and or similar format, can be used while serving, to select an eating component that will just fit that incrementally-sized standard-sized food portion, be available to user at home and outside of home, and to servers in restaurants and other public eateries to deliver for servers and users the incrementally-sized standard-sized food portion, and/or be used for training/learning purposes to help an user learn the portion that s/he needs to maintain to lose/gain or maintain weight.

These templates/objects can be graphically and/or visually represented in a printed or digital form (holographic image for example) in full scale or proportionally reduced scale for the purpose of demonstration.

The user will establish the Standard Food Portion Size(s) s/he needs to lose/gain or maintain weight will be able to stick to his portion when s/he uses Incrementally-Sized standard-Sized eating-ware components that have been either measured, identified or designed to deliver the Standard Food Portion Size(s); and/or use the tools like the template/representative (equivalent volumetrically) objects or their visual representation in printed and/or digital and or similar format to control portions served and consumed; and/or consume food portions of a known and/or identified through marking or indication food portions of an Incrementally-Sized standard-Sized size(s).

The user may want to increase consumption of desired substances like water, vegetable, high nutritional value types of substances or a specific substance. The user can increase the incrementally-sized-standard-sized portion size(s) of this substance or substance type. On the other hand the user may want to decrease consumption of undesired substances like caffeine, alcohol, high-salt content (high blood pressure), high-fat content (heart disease), high-sugar (diabetic) content types of substances or a specific substance. The user can decrease the incrementally-sized-standard-sized portion size(s) of this substance or substance type.

Due to bad eating habits, diet filled with high sugar high fat content, a dieter may find the portion size reduced to the levels that s/he finds stressful to make these adjustments. The user can be guided to make better food choices by using the CDM (Caloric Density Mark) to select the foods. For example, the user may be using SPS 12 for all meals, but the user's diet may mostly consist of foods with CDM of G (>60 to 70 calories per cubic inch). The user may shift to foods with CDM of F (>50 to 60 calories per cubic inch) and reduce his/her daily caloric intake while keeping the Standard Food Portion Size(s) the same resulting in a weight loss. The user may be encouraged to dilute the CDM with substances that will lower CDM in incremental levels, for example dilute soda with SBS size 3 of water, than size 4 of water, and so on.

The above processes can be used alone or in a combination, depending on user preferences. One user may be able to use a single SPS and SBS Standard Food Portion Size and make periodic adjustments based on life changes and be successful in maintaining a healthy weight. Other users may have a more difficult time adjusting to even smaller incremental changes, a medically supervised approach with monitoring of health vitals may be required. As dieters are individual in their needs and abilities to transition to gradually smaller Standard Food Portion Sizes the Incrementally-Sized Standard-Sized system and processes provide the user with the tools needed to develop and maintain healthy portion eating habits. The flexibility of the Incrementally-Sized Standard-Sized system and processes creates an opportunity for creating a customized and individualized eating process across individual's lifespan. Once the user establishes the current level of consumption, the user will easily be able to follow the numeric and alphabetical system in their daily routine. Although the daily consumption will vary for every user, on the average there will be a trend that will indicate if there has been a lifestyle change. A software application can be used for tracking weight that can detect a statistically significant change and guide the user to maintain or adjust his/her current Incrementally-Sized Standard-Sized portion(s). The user can indicate level of activity (amount of exercise), or indicate health related issues and the software will recommend a Incrementally-Sized Standard-Sized portion(s) size(s) to follow to maintain weight at desired levels. The software will be able to detect cyclical trends like work week vs weekend, summer vs. winter and recommend a size adjustment due to the cyclical changes in preventative mode. When a user has days of high levels of activity and low levels of activity, the software can recommend adjusting the portion to smaller Standard Food Portion Sizes on the days when exercise does not occur.

Software can be provided to help user track: Standard Food Portion Sizes and the CDM's. This information could be used to help estimate the caloric content of a meal and daily consumption. Software application can be used to help user slow down their eating process and gradually extend the interval between each bite by a visual display of how long to chew for. This would be especially useful when teaching children how to eat slower. For example a character-like friend-buddy can eat with the child to teach them when to take the next bite and entertain the child until the next bite. The child will learn to eat slower and as a result feel satiated faster.

The process will be very simple when all eating components have an indicated Standard Food Portion Size. All the users will need to do is select the components with the right Standard Food Portion Size for them, serve and eat.

The present invention provides incrementally-sized standard-sized eating-ware components, deployed during intervals to provide gradual and unnoticeably food portion reduction, enabling a user to modify his/her eating habits for effective weight management without feelings of deprivation. Eating-ware is comprised of any item that is used to eat from and/or eat with. The incrementally-sized standard-sized eating-ware system and processes provide a plurality of incrementally-sized standard-sized eating-ware components having successively increasing or decreasing standard sizes appointed to be utilized in a graduated manner over a period of time. The incrementally-sized standard-sized eating-ware system and processes of the present invention are designed to decrease or increase serving sizes and vis-a-vie consumption of food over a period of time, depending on a user's weight management needs.

The incrementally-sized standard-sized eating-ware system allows the user to use the components in a process that delivers desired Standard Food Portions that helps a user succeed in losing/gaining and/or maintaining weight. For example, if the user does not have the eating-ware components that have established Standard Food Portion Sizes, s/he can use the formulas to determine the size of his/her current eating-ware components. Here are some examples of how user would use Standard Food Portion Sizes to lose weight:

### Example 1

User adjusts all incrementally-sized standard-sized eating-ware components' (see note below) sizes to lose weight (the period is a duration of time of using between size adjustments, typically it will be 1 week but will vary with individuals)

| | Current SPS | 1st Period SPS | 2nd Period SPS |
|---|---|---|---|
| Dinner Plate | 20 | 19 | 18 |
| Soup Bowl | 15 | 14 | 13 |
| Dessert Plate | 10 | 9 | 8 |
| Glass | 8 | 7 | 6 |
| Cup | 6 | 5 | 4 |

| | Current SSS | 1st Period SSS | 2nd Period SSS |
|---|---|---|---|
| Snack-ware | 10 | 9 | 8 |

| | Current SBS | 1st Period SBS | 2nd Period SBS |
|---|---|---|---|
| Soup Spoon | 18 | 17 | 16 |
| Fork | 16 | 15 | 14 |

Note: sizes indicate the incrementally-sized standard size portions, sizes of eating-ware, templates/objects and other medium used to guide the user in selection of the portion size.

### Example 2

User adjusts some incrementally-sized standard-sized eating-ware components's (see note below) sizes to lose weight (the period is a duration of time of using between size adjustments, typically it will be 1 week but will vary with individuals)

| | Current SPS | 1st Period SPS | 2nd Period SPS |
|---|---|---|---|
| Dinner Plate | 20 | 19 | 18 |
| Soup Bowl | 15 | 15 | 15 |
| Dessert Plate | 10 | 10 | 10 |
| Glass | 8 | 8 | 8 |
| Cup | 6 | 6 | 6 |

| | Current SSS | 1st Period SSS | 2nd Period SSS |
|---|---|---|---|
| Snack-ware | 10 | 9 | 8 |

| | Current SBS | 1st Period SBS | 2nd Period SBS |
|---|---|---|---|
| Soup Spoon | 18 | 17 | 16 |
| Fork | 16 | 15 | 14 |

Note: sizes indicate the incrementally-sized standard size portions, sizes of eating-ware, templates/objects and other medium used to guide the user in selection of the portion size.

There are infinite combinations that can be used but the individual will be able to determine the right combination for them and easily follow the numeric incrementally-sized standard-sized sequential system to lose, gain and/or maintain weight.

To begin the process, first, the user establishes their current eating-ware component's Standard Food Portion Sizes. The users could weigh themselves daily to establish their current weight and identify “typical” daily fluctuation. Then the users would decrease the Standard Food Portion Size(s) of their eating-ware and/or their portions' size by using the incrementally-sized standard-sized eating-ware components or use tools like template/objects and or visual representations of the incrementally-sized standard-sized portions to compare the portion being served and/or consumed. The user can do this even more gradually by adjusting one component and/or size at a time or make multiple adjustments for quicker results. At the end of each period (typically weekly but may vary based on user's medical advice/recommendation) the user will determine the amount of weight lost. If lost 0 pounds, the user may go to the next set of eating-ware components/templates/sizes. If lost 1-2 lbs, the user's MD may recommend to continuing at this level for another period (for example week) or may recommend reduction of all sizes by one size interval again. This level of adjustment will continue until the user is able to sustain desired weight. This process will determine the optimal Standard Food Portion Sizes for the user that will help the user maintain his or her optimal weight. When the user is eating out the user can either bring a template for comparison or go to a location that serves food in Standardized Food Portion Sized eating-ware components, or uses devices that cuts, measures and/or indicates the Standard Food Portion Size. Once the food packaging companies adapt the Standardized Food Portion Sizes and are able to indicate for the user directly on the packaging the Standardized Food Portion Size the user will be able to consume the right “sized” portion for him or her.

Another process that the user can use Standardized Food Portion Size is to use the utensils that the user knows the Standardized Food Portion Size of. So for example the user may use 35 mouthfuls for dinner, 18 for breakfast and 25 for lunch. Initially the user uses a utensil with SBS of 17. Again the user would establish weight and day to day fluctuation first. Then the user would select utensils with SBS of 16. Even though the user would consume same number of mouthfuls, s/he would now consume less food. The user would weigh themselves and follow the size reduction preferably with MD supervision until the user achieves desired weight. Counting while you eat may be cumbersome to some and a Standardized Food Portion Sized utensil that is able track the mouthfuls and indicate them to the user would make this easier. This device electronic on mechanical in nature will be also capable to monitor duration between mouthfuls to help the user adjust the speed of consumption. The device and/or software application may have a distracting or entertaining capabilities to help user fill the time to slow down between mouthfuls, especially useful for children that are learning a correct way of eating.

Some eating-ware components of the incrementally-sized standard-sized eating system may be used for liquids and for solids. As such they may deliver different volumetric portion equivalents depending on the type of substance used. These devices may indicate both sizes depending which type of substance is used. A subsequent letter S or L may be used to indicate that the incrementally-sized standard-sized portion size if used for solid and liquid correspondingly. For example a glass can be used for solid or a liquid. When it's used for solid it could indicate SPS-S-16 and when it's used for liquid it could indicate SPS-L-15 or SPS 16(S) 15(L) or some other way that would make it clear to the user the incrementally-sized standard-sized portion size depending how s/he uses the eating-ware component.

When selecting eating-ware there are limited choices of relative sizes within a typical eating-ware set, for example: dinner plate, salad plate, desert plate, bowl, and cup. Depending on a manufacturer and/or style, all these items come in a variety of different sizes and configurations. In addition to china-like eating-ware, a consumer typically adds mugs, glassware, utensils and cutlery and eating-ware accessories that complete user's typical serving setting. Even though visually these eating-ware components of same type may appear similar, they will deliver very different food quantities. Depending on the style or manufacturer of the eating-ware, the internal volume of the eating-ware component and the amount of food that can be served directly above the upper boundary of component will vary. The user does not have a way of verifying how much total volumetric capacity an eating-ware component has and/or how the different components' total volumetric capacities relate to each other. For example: a flat plate, to a deep plate, to a bowl, to a cup, to a spoon, to a fork, etc. Advantageously, the subject incrementally-sized standard-sized eating-ware system and processes readily discerns the total (internal and directly above) volumetric capacity of the eating-ware components and assigns it a numerical equivalency across components.

Use of the subject incrementally-sized standard-sized eating-ware system and processes facilitate attainment of a healthy weight for a user. Various factors affect consumer's weight. These factors include not only what food is consumed, but how much food is consumed, which in turn is directly relevant to the portion served. As eating-ware has increased in size, normal food portions served on that eating-ware appear smaller and smaller. In response, users have increased the amount served to compensate for this illusion. The incrementally-sized standard-sized eating-ware system and processes takes advantage of this phenomenon. As the user moves to smaller and smaller standard size eating-ware components, the food portions appear larger, thus encouraging the user to consume less.

The incrementally-sized standard-sized eating-ware system and processes uniquely address the amount a consumer eats by very slightly changing one's portion size, via relative sizes of all the components of a setting that the user is using. Users have difficulty reducing the size of their portion when the eating-ware remains the same size. Even if he/she adjusts the size of some of the eating-ware, the food portion will appear smaller due to the relative size appearance of other eating-ware components. Thus, the incrementally-sized standard-sized eating-ware system and processes result in virtually unnoticeable decrease of portion size to facilitate weight control.

The ability of an individual to maintain healthy weight is affected by the amount of food they serve themselves and the rate they consume the food. In addition to the size of portion consumed, the rate of consumption impacts the consumer's feeling of satiation. The slower the food is consumed by the user the more satisfied he/she will feel with lesser amount of food. One way to control that is to eat more slowly, and another is to eat less with each mouthful. Smaller standard bite/nibble size will deliver food directly to the user at a slower rate. The user will be able to have more bites/nibbles per specific standard portion size or standard snack size. This will automatically slow down the rate of consumption. The slower the person eats, the more satiated they will feel and consequently consume less food.

Gradual portion control presented in a discrete manner further facilitates successful dieting and healthy eating habits. With gradual portion control, those dieting (or intending to gain weight, when specific health needs so require) are not constantly reminded of their portion reduction or increase as they are eating; this tends to relieve mental and emotional pressures that often sabotage dieting efforts. Moreover, a discrete gradual portion control device and processes can be utilized when dining with guests, without making the user's diet glaringly obvious.

Another important factor uniquely considered by the incrementally-sized standard-sized eating-ware system and processes of the subject invention concerns the actual transfer of food into the person's mouth. Currently, there are no standards or recommendations with regard to the eating-ware that is used to transfer the food into a person's mouth. This disregards an important factor that affects the individual's consumption process. The larger the utensil-like eating-ware, the larger the amount of food that will be delivered per mouthful. The larger the amount of food that is delivered per mouthful, the faster the user consumes his/her portion. The lack of feeling of satiation is an important aspect of why people overeat. When they consume food fast, they do not experience the feeling of satiation and as a result eat more than they need. Reducing the rate of food transfer to the user by using incrementally smaller utensils results in a decrease in portion amount eaten as more bites are needed, causing a psychological effect of feeling full sooner and thus resulting in consuming of a smaller portion of food overall during a meal. The Incrementally-Sized Standard-Sized Eating-ware System surprisingly and unexpectedly addresses the need for controlling the entire consumption system, not only the amount of food served and/or consumed but also the rate that the user consumes the food by defining the Standard Sizes for all eating-ware.

The user can use the Incrementally-Sized Standard-Sized Eating-ware System to optimize their standard bite size to determine optimal size of the standard “bite/nibble” to maximize feeling of satiated and optimize the number of standard bites/nibbles per day to their weight management goals. User can also use the Incrementally-Sized Standard-Sized Eating-ware System to optimize his/her standard food portion size to determine the optimal food delivery level for healthy weight maintenance.

The Incrementally-Sized Standard-Sized Eating-ware System includes a Standard Portion Size, Standard Snack Size, Standard Bite Size, and Standard Nibble Size each established by using a formula. The detailed explanation of these formulas used in the process and system are included in the FORMULAS section below. The formula for Standard Portion Size is based on a series of total volumetric capacity equivalents (expressed in cubic inches) defined by volumes of 1 inch high cylinders above flat round surfaces that start at a 4 inch diameter and vary in size in small diameter increments of the cylinder bases. The formula for Standard Snack Size, is based on a series of the total volumetric capacity equivalents (expressed in cubic inches) defined by volumes of 1 inch high cylinders above flat round surfaces that start at a 0 inch diameter and vary in size in small diameter increments of the cylinder bases. The formula for Standard Bite Size is based on a series of total volumetric capacity equivalents (expressed in cubic inches) defined by volumes of ellipsoids surrounding flat elliptical surfaces that vary in size in small increments in the major and minor radii, where the major radius starts at 0.5 inch and minor radius starts at 0.25 inch, where both minor radii are equal, and the major radius equals the minor radius times 1.5 plus 0.125. The formula for Standard Nibble Size is based on a series of total volumetric capacity equivalents (expressed in cubic inches) defined by volumes of ellipsoids surrounding flat elliptical surfaces that vary in size in small increments in the major and minor radii, where each of the major and minor radii start at 0 inch, both minor radii are equal, and the major radius is equal to the minor radius times 1.5. These formulas are used to establish the numerical value of a standard size and are calculated by the following formulas:

Standard Portion Size(SPS)=(the diameter of a cylinder in inches−4)*4,

Standard Snack Size(SSS)=the diameter of a cylinder in inches*8,

Standard Bite Size(SBS)=40*minor radius of ellipse in inches−10, and

Standard Nibble Size(SNS)=80*minor radius of ellipse in inches.

Note that Standard Portion Size numerical values will be negative numbers for surface diameters less than 4 inches and can be used as such, but a Standard Snack Size may be preferable for these sizes. Similarly, Standard Bite Size will be negative for minor radii smaller than 0.25 inches and can be used as such, but a Standard Nibble Size may be preferable for these sizes.

These Incrementally-Sized Standard-Sized Eating-ware System Standard Sizes help the user control the amount of food served and/or consumed and also the rate at which the user consumes the food.

The Incrementally-Sized Standard-Sized Eating-ware System eating-ware components are sized and/or identified with Standard Sizes, where standard Portion Size and Standard Snack Size are used to control the total volumetric capacity of eating-ware which in turn controls the amount of food per serving, and wherein standard Bite Size and Standard Nibble Size are used to control the total volumetric capacity of eating-ware which in turn controls the rate of food consumption per bite-full/mouthful.

These formulas are used to determine a standard size for all eating-ware components. They uniquely provide a system that can be used by manufacturers to indicate the standard sizes of eating-ware components for the users, so that the users will be able to continue to stay on their weight management regimen no matter what they eat (type of food and/or type of meal), what eating-ware component they eat from (plate, bowl, cup, glass, flat surface, bag, pre-packaged-ware, etc.), eat with (fork, knife, spoon, straw, chop sticks, etc.), or where they eat (restaurant, cafeteria, friend's home), as long as the users verify the standard size of the eating-ware components that they are using. The standard sizes can also be assigned directly to a food amount that is served independent of its container, for example, a sign at a buffet can indicate the slice of pizza or a slice of lasagna is standard size of 3.0 and a Caloric Density Mark of D.

The incrementally-sized standard-sized eating-ware system and process result in a decrease of portion size which facilitates weight control. This is achieved through use of the incrementally-sized standard-sized eating-ware system's unique eating-ware components that look like and/or are typical eating-ware so that the user has the flexibility to eat any type of food and continue to stick to the weight management program. The Incrementally-Sized Standard-Sized Eating-ware System formulas can be used to design any eating-ware component to a specific Standard Size. The design process comprises of the following steps:
a) determining the features of eating-ware component;
b) determining the internal and/or external features and/or configuration that will result in total volumetric capacity equivalent to the desired Standard Size total volumetric capacity;
c) assigning corresponding Standard Size and/or Standard Size Range to the eating-ware.

The Incrementally-Sized Standard-Sized Eating-ware System eating-ware components can form series of multi-type components so that the user can shift from one component to another within the series to adjust the amount and rate of consumption.

The Incrementally-Sized Standard-Sized Eating-ware System formulas can also be used to design any eating-ware series that adjusts in Standard Size increments small enough to be indistinguishable by the user, by following these steps:
a) determining the internal and/or external features of eating-ware;
b) determining the smallest or largest size in the series;
c) determining the largest Standard Size increment visually undetectable by the user in the series;
d) determining the number of eating-ware components in the series;
e) adjusting the internal and/or external features for each increment in size to achieve a total volumetric capacity equivalent for each component within the series, while maintaining undetectability;
f) assigning the Standard Size and/or Standard Size Range to the eating-ware that corresponds to the Standard Size equivalent total volumetric capacity of each component in the series.

These Incrementally-Sized Standard-Sized Eating-ware System series can be made as a series of single type and/or style of eating-ware, or form a series of multi-type incrementally-sized Standard-Sized eating-ware settings where components within each setting maintain relative proportion (congruent dimensions) to other components within the setting, to minimize the perception of the incremental changes, and where:
a) components within each setting have the same corresponding Standard Size, or
b) components within the setting have a different Standard Size, and all eating-ware components in a consecutive setting are increased or decreased in Standard Size by one or more increments with each adjustment to modify food amounts.

The Incrementally-Sized Standard-Sized Eating-ware System eating-ware series components internal and/or external dimensions and/or configurations (including depth, height, slope of the walls, wall thickness, internal texture, shape of the inside, shape of the bottom, and/or a combination of some or all of the above) can be varied so that the amount of food delivered and/or the rate of delivery varies in small increments, while maintaining the visual appearance of sameness.

The Incrementally-Sized Standard-Sized Eating-ware System formulas can be used to determine and assign any Standard Size and/or Standard Size Range to any existing eating-ware by:
a) selecting which of Standard Size (Standard Portion Size, Standard Snack Size, Standard Bite Size or Standard Nibble Size) and/or Standard Size Ranges of eating-ware is to be assigned,
b) determining the internal volume of the eating-ware,
c) determining the cross-sectional area of the top of the eating-ware,
d) determining the equivalent total volumetric capacity of the Standard Size that has the same cross-sectional surface area as the cross-sectional area of the top of the eating-ware,
e) calculating total volumetric capacity of the eating-ware by adding volume (b) and (d) for Standard Portion Size or Standard Snack Size, or adding volume (b) and one-half of (d) for Standard Bite Size or Standard Nibble Size,
f) determining the numerical Standard Size that corresponds to the total volumetric capacity, and
g) assigning the corresponding selected numerical Standard Size and/or Standard Size Range to the eating-ware.

The incrementally-sized standard-sized eating-ware system formulas can be applied to determine standard sizes of existing eating-ware components. With the incrementally-sized standard-sized eating-ware component system any eating-ware item for eating food from and/or eating food with can be used as long as the formulas are applied to determine the standard size and/or sizes of the eating-ware component. These formulas can be applied to a volumetric quantity of food directly. The Incrementally-Sized Standard-Sized Eating-ware System formulas can be used for assigning a Standard Size and/or Standard Size Range to a volume of food that equates to the total volumetric capacity equivalent to the specific Standard Size and/or a Standard Size Range.

Pre-packaged food can be eaten directly out of the packaging. The incrementally-sized standard-sized eating-ware system will enable the user to continue his/her weight management regimen when eating directly out of pre-packaged containers. The Incrementally-Sized Standard-Sized Eating-ware System formulas can be used to determine and assign and/or indicate a Standard Size and/or Standard Size Range on the pre-packaged and/or pre-measured amount of food to reflect the volumetric amount of food contained therewithin that equates to the specific Standard Size and/or a Standard Size Range.

There are some instances where eating-ware does not permit food to be served above a rim of the eating-ware component. In this situation the Incrementally-Sized Standard-Sized Eating-ware System formulas will be used to assign a Standard Size and/or Standard Size Range based on the internal volume only. The internal volume of the eating-ware is equated to the total volumetric capacity equivalent to the specific Standard Size and/or a Standard Size Range and that Size or Range is assigned to the eating-ware.

Through use of the incrementally-sized standard-sized eating-ware system and processes fluid consumption can also be added to the total consumption of the caloric intake especially alcohol, sodas, and fruit drinks. The Incrementally-Sized Standard-Sized Eating-ware System can be used for purposes other than weight management. The Incrementally-Sized Standard-Sized Eating-ware System can comprise of a series of Standard Sized eating-ware that is used for subtle and incremental management of consumption of other edible substances including alcohol, coffee, water, sodas, fruit drinks, etc. and specific food types, for example decreasing high sugar content or high fat content, or increasing high vitamin or other nutrient content. So for example if you'd want a child to increase the amount of vegetables they consume you would place those on a large Standard Size eating-ware component and the amount would appear small. So gradually and unnoticeably increasing the size of “vegetable” eating-ware would motivate the child to eat more vegetables.

The incrementally-sized standard-sized eating-ware system and processes helps to control the gradual decrease in these high calorie consumables through numerically guided incrementally adjustable system.

Uniquely, a SPS, SSS, SBS, and/or SNS can be assigned to any pre-served food or prepackaged foods based on a total volumetric equivalence to help guide the user to stick to his/her standard size and control his/her weight without having to transfer the food from the pre-packaged vessel, while previously proposed weight loss services require a user to transfer the food to the “measuring device” first and then transfer it again on to the eating surface.

In addition to the SPS, SSS, SBS and/or SNS the pre-packaged ware can have the Caloric Density Mark, which refers to a letter representation of the caloric density of food in terms of calories per cubic inch, which will help the user in selecting foods. (See Table A) This will give the user a quick way to make a determination of the total calories contained. For example, user sees 2 candy bars next to each other, both are SBS=10 one is marked A and the second with E. It would indicate to the user that the “A” candy bar has significantly fewer calories than the “E” candy bar. This would be very useful to children since they can learn to look for foods that have lower caloric densities by looking at the letter of the alphabet when making choices. The Incrementally-Sized Standard-Sized Eating-ware System includes a system for assigning a Caloric Density Mark to caloric food density ranges where each letter of the alphabet represents a caloric density range starting with A representing 0 up to and including 10 calories per cubic inch, B representing more than 10 up to and including 20 calories per cubic inch, and so on up to Y representing more than 240 up to and including 250 calories per cubic inch, with higher caloric densities represented by Z plus the number of calories per cubic inch.

The Incrementally-Sized Standard-Sized Eating-ware System Caloric Density Mark can be listed in or indicated on books, guides, software, charts, menus, signs, labels, or external packaging indicia.

The incrementally-sized standard-sized eating-ware system and process is already a pre-measured surface area and provides a pre-measured eating-ware. A flat surface or an area emphasized on a flat surface of the incrementally-sized standard-sized eating-ware system can have an assigned SPS, SSS, SBS, and/or SNS to help guide the user and maintain his/her weight management process.

The incrementally-sized standard-sized eating-ware system adjusts the amount of food consumption and the rate the food is delivered to the user throughout the daily consumer's consumption process. The system consists of the eating-ware components that are periodically incrementally adjusted in size by the user, and have been standard-sized using the formulas for Standard Portion Size (SPS), Standard Snack Size (SSS), Standard Bite Size (SBS), and Standard Nibble Size (SNS). The formulas for SPS and SSS are used to assign standard sizes to eating-ware components from which food is eaten and define a total amount of food. The formulas for SBS and SNS assign sizes to eating-ware components that are used to transfer the food directly to the user and establish the rate of food transferred per mouthful.

The incrementally-sized standard-sized eating-ware system provides a simple representation of these standard-size total volumetric capacity representations of food amounts numerically.

The decimal number for a Standard Size is used to represent a single total volumetric capacity Standard Size, and a Standard Size Range is an integer that is used to represent a range of total volumetric capacities that include all decimal Standard Sizes having the same integer portion.

In other words, the integer value of a standard size represents a range of volumes that have the same number in the integer place. The decimal value of a standard size represents a single volume equivalent for each size SPS, SSS, SBS, and/or SNS. For example: Standard size 1 represents a range of volumes for sizes 1 and greater but less than 2. Standard size 1.13 refers to a unique total volumetric capacity equivalent for that particular standard size. This system makes it easy for the user to remember just a few numbers to maintain his/her weight management process.

The incrementally-sized standard-sized numerical eating-ware system also provides formulas for determination of the standard size for any eating-ware. This enables the user to continue with his/her weight regimen no matter where he/she eats and irrespective of type or style of eating-ware component the user utilizes. For example the user can use a plate, a bowl, a cup, a glass, a spoon or a fork, etc and continue to stick with his/her consumption process as long as the eating-ware has an established and/or identified standard size that the user is using in his/her weight management regimen.

The system affects the amount a user serves and the rate he/she consumes the substances served therefore it impacts the whole consumption process. With each incremental size adjustment the amounts change in small gradual steps so the user minimizes the feeling of deprivation and distress associated with typical portion reduction. The incrementally-sized standard-sized eating-ware system can be applied to most typical and non-typical eating-ware components. As a result the user has a process for modification of his/her consumption by the use of typical eating-ware components that have been sized and/or identified with the incrementally-sized standard-sized eating-ware system numbers for guidance in selection of eating-ware to help manage weight.

The user can select items from the Incrementally-Sized Standard-Sized Eating-ware System eating-ware components, where:

the Standard Sized eating-ware components form a series,

each successive component within the series varies by a Standard Size increment,

a change in increment is gradual and subtle so that the user is unmindful of that change when shifting between consecutive standard sizes within the series, and

a change in Standard Size increment results in adjustment of food amount served/consumed or the rate of consumption of food.

When the consumer has adjusted to the given serving size or food portion amount, the serving size is further decreased or increased, as the case may be, by utilizing the next incrementally-sized standard sized eating-ware component. The user selects the eating-ware component via the use of the standard size numbers SPS, SSS, SBS, and/or SNS. The unique standard number system cross-references all types of eating-ware components. The user can select different types of eating-ware as long as its standard size is maintained to stay within the weight management process.

Particularly, the incrementally-sized standard-sized eating-ware system provides incrementally-sized standard-sized eating-ware components appointed to be used in intervals to provide gradual and unnoticeable food portion reduction, so that a user can modify his/her eating habits for effective weight management without feelings of deprivation. A plurality of incrementally-sized standard-sized eating-ware components is provided. Each of these eating-ware components has a successively decreasing standard size so that each eating-ware component yields a different volume capacity for food, and hence presents a different portion amount.

A user typically consumes the food served on the eating-ware and transfers the food to his/her mouth using the available eating-ware. The user evaluates the amount of food to serve by visually observing the amount in the planar view from above the eating-ware. The accuracy of this evaluation is not adequate and as eating-ware has been increasing in size, so have the portions served, resulting in overeating. The incrementally-sized standard-sized eating-ware system has incorporated this important factor in the development of the formulas for the standard sizes. The basis of the formula is surface areas (round for the SPS and SSS like a flat plate, and elliptical for SBS and SNS like a flat spoon). The incremental adjustments are designed to help create a perception of sameness as the planar view of the eating-ware changes at such small increments that are virtually undetectable by the user. Most users will be able to adjust to the next size with a whole number adjustment, but some may need fractional adjustments.

The Incrementally-Sized Standard-Sized Eating-ware System comprises of a plurality of processes for using incrementally-sized Standard-Sized eating-ware with known Standard Sizes for weight management, where these processes change the amount of food consumed and/or the rate of consumption with each incremental adjustment in Standard Size and/or Sizes. In addition, they can be used to maintain weight by having the user continually using the same Standard Size.

The Incrementally-Sized Standard-Sized Eating-ware System includes a process to manage weight where a user determines the Standard Sizes of his/her current eating-ware components, and/or selects Standard Size components from within a series, and then:
a) continues to use those same Standard Sized eating-ware components to maintain weight,
b) periodically selects smaller Standard Sized components to reduce weight, or
c) periodically selects larger Standard Sized components to increase weight.

The Incrementally-Sized Standard-Sized Eating-ware System includes a process to manage weight where the user can use and/or adjust one or more of the Standard Sizes of eating-ware so that he/she:

uses same sizes for all food consumption,

uses different sizes for different types of meals,

uses different sizes for different types of food, or

implements any combination of the above scenarios, and controls the amount of food consumed and/or the rate that the food is consumed.

The Incrementally-Sized Standard-Sized Eating-ware System includes a process to manage weight where the user can incrementally adjust the total number of servings of one or more of a particular Standard Size consumed per time interval.

Another process to use the Incrementally-Sized Standard-Sized Eating-ware System to manage weight, allows the user to select a starting Standard Size of eating-ware, the size of incremental adjustment of Standard Size, and the time interval between periodic shifts to the next size in a self-directed process or with guidance from a professional and/or software.

The Incrementally-Sized Standard-Sized Eating-ware System includes a process to manage weight where the user selects Standard Sizes and/or makes adjustments based on various factors including age, health, medical conditions, height, weight, gender, activity level, life style or comfort level.

The Incrementally-Sized Standard-Sized Eating-ware System can be used with any existing eating-ware with assessed and/or assigned Standard Size and/or Standard Size Range for weight management, whether marked or unmarked.

Another unique aspect of the incrementally-sized standard-sized eating-ware system is the ability to give a volumetric representation for a flat surface. The flat round plate-like surfaces form the basis for the Standard Portion Size (SPS) and Standard Snack Size (SSS) system. Any flat surfaces have zero volumetric capacity for holding liquids, yet they can be used to serve solid substances and therefore impact the amount of portion served on them by the user.

A same size portion served on a small surface that just contains it vs. being served on a large surface that reveals a lot of surface area around it will appear to the user as a larger portion (See FIG. 8). The empty space creates an illusion where the portion appears smaller when presented on the larger surface with lots of empty space around it. Adjusting the eating-ware components size will result in the user serving smaller quantities of food without the feeling of deprivation and therefore help the user lose and maintain weight.

Just like flat round plate-like surfaces are the basis for SPS and SSS, flat elliptical spoon-like surfaces are the basis for Standard Bite Size (SBS) and Standard Nibble Size (SNS) which affect the incrementally-sized standard-sized eating-ware components that are used by the user to transfer the substances directly to the user. As the numeric standard-size of utensil-like eating-ware components adjusts, it changes the amount of food the user consumes per each mouthful. Even though the total amount of food consumed may have incrementally decreased with an adjustment of SPS/SSS, by simultaneously adjusting the SBS/SNS the user will experience more mouthfuls and slow down his/her rate of consumption and therefore further minimize the feeling of deprivation.

The eating-ware components are appointed to be utilized in a graduated manner over a period of time. Small, incremental changes in standard sizes are successively provided, so that the food portion changes from eating-ware component to eating-ware component are subtle. Advantageously, with this arrangement, the user does not feel deprived and gradually establishes healthy eating habits for effective weight management.

Long-term use of smaller incrementally-sized standard-sized eating-ware components prevents weight gain after the user's diet is complete, allowing the user to readily maintain his or her weight. This is especially useful, as dieters who are successful at losing the weight frequently gain it back after a period of time.

Long-term use of incrementally-sized standard-sized eating-ware will assist the users in adjusting their weight through their daily consumption and maintain it by continually using the standard size of their eating-ware after they achieve their healthy weight. Incrementally-sized standard-sized eating-ware can be used for all meals throughout a person's life span and adjusted by the user due to life style changes or aging. The user can quickly adjust their consumption in response to their lifestyle changes like aging or illness, and/or changes in activity level, simply by changing the standard size used.

The incrementally-standard-sized eating-ware can be used for children to help them develop a healthy lifestyle. A child will not be able to comprehend the complex calorie based systems for weight management. Adults have difficulty in making the decision of how much food to serve themselves and when they feel full. That is a task beyond most children's ability. Yet a first grader will be able to know his/her eating-ware size and fill it up. A parent will be able to increase the eating-ware size as the child grows to maintain a healthy weight much easier with the incrementally-standard-sized eating-ware.

Long-term use of the eating-ware components reduces the need to track data, count calories, and calculate portion sizes, etc., throughout and after the diet. The act of counting calories and measuring food adds to the feeling of deprivation and constant awareness of being on a restrictive diet.

Advantageously, once a user knows their eating-ware component standard size weight maintenance is readily achieved.

The user only needs to remember a few numbers to help guide him/her in daily choices of eating-ware. The user will no longer have to measure or weigh substances prior to consumption. As restaurants, cafeterias, eating-ware manufacturers, food manufacturers, etc. incorporate the incrementally-sized standard-sized eating-ware system the users will be able to maintain their weight management system anywhere they choose as long as the standard sizes SPS, SSS, SBS and/or SNS of the food amount or the eating-ware component are readily available to the user.

The Incrementally-Sized Standard-Sized Eating-ware System Standard Sizes formulas use inches as the basis for the origin of these sizes. These formulas can be expressed in units other than inches, inches squared, and/or inches cubed through unit conversions of corresponding measures of other Measurement Systems.

Incrementally-sized standard-sized eating-ware components are provided, as well as optional place settings and utensils, to induce behavior modification, causing desired weight loss (or gain) and establishing new, healthy eating habits.

The incrementally-sized standard-sized eating-ware can be grouped as a place setting made up of all the components that the user will use to consume directly from and/or transfer the substance directly into their body, such as: dinner plate, salad plate, desert plate, spoon, fork, knife, tea-spoon, glass, cup, mug, glassware and many other items that typically make-up a setting. The user can change the standard size of all items at once, or one or more items at the time, creating unlimited combinations available to the user. This will truly allow the user to adjust his/her consumption process as slowly or as quickly as the user chooses.

Changes in eating-ware component standard size occur in small increments, making it difficult to notice the changes from day to day, or week to week. Small daily or weekly changes in increments utilized by the incrementally-sized standard-sized eating-ware system and processes minimize dieting discomfort.

The user can make the standard size increment adjustments so small that they are virtually undetectable by the user. This is especially helpful for parents who are trying to instill healthy habits for their children. The incrementally-sized standard-sized eating-ware system currently provides the only method that can easily help a parent manage their child's weight. Others have tried to come up with a method that can be applied across all children, yet these methods come up short due to the high variability in growth and stature from child to child. The incrementally-sized standard-sized eating-ware makes these small adjustments possible without the chore of measuring and calculating portions.

The eating-ware components are proportioned between each standard size so that the calorie intake is slowly reduced (or increased) and a person is dieting (or gaining weight) without significant effort and/or the recognition that a change in caloric intake is occurring.

The human body does not possess a mechanism to evaluate the number of calories the person consumed. A person can consume a chocolate bar that is 600 calories and may still be hungry. With the abundance of varieties of foods that are available today a person has no mechanism that will indicate that what they consumed is sufficient. Because of that they depend largely on their visual interpretation and memory of what they've consumed. Consumers using the eating-ware components of the incrementally-sized standard-sized eating-ware system and processes will gradually become accustomed to smaller (or larger) standard sized eating-ware components and glassware, and portions of food and drink. Counting calories, measuring food portions, and dietary modifications involving departures from the user's normal foods are no longer required, owing to use of the present incrementally-sized standard-sized eating-ware system and processes.

Most diet-altering plans concern themselves with the calorie intake. The incrementally-sized standard-sized eating-ware system recognizes the importance of how fast the substances are consumed in addition to the amount per each meal, to help the user feel satiated.

The incrementally-sized standard-sized eating-ware system and processes have applications for use in managing an individual's weight, as well as the weight of family members, such as spouses, children and other family members. As children are beginning to have more and more weight issues, accountable in part due to eating larger portion sizes than their body build requires, weight management and healthier eating habits are needed. Children using the incrementally-sized standard-sized eating-ware system and processes will learn to recognize an appropriate meal standard size for their body size and weight. This learning experience enables children to establish healthy eating habits that carry on into their adult lives.

A portion of a child's life is spent in the school system. Currently school cafeteria eating-ware is one-size-fits-all. This size is too large for many children and teaches them to eat more than they need. As a solution the schools are trying to provide more healthy choices yet more variety will only compound the issue. With the incrementally-sized standard-sized eating-ware system, cafeterias and other eateries can easily adjust the portion size to that which is right for the individual child.

The discrete nature of the incrementally-sized standard-sized eating-ware components, optional bowls, cups, etc., of the system allow parents to gradually decrease a child's portion amount without the child being adversely affected, or even aware of the small, incremental decrease.

When a child transitions from a child plate to an adult plate the surface area increases almost four times. We are asking children to make the right choices without giving them the right tools to make these choices. The incrementally-sized standard-sized eating-ware does provide these tools. Children can learn to adjust their incrementally-sized standard sizes as they grow and the incrementally-sized standard-sized eating-ware system and process adjust with their age throughout their life-span. Labeling foods in a cafeteria or a restaurant with the Caloric Density Mark will also help children make right choices from the start.

A family can lose weight together. Moreover, progressive eating-ware component standard sizes can be used to track and accommodate growth of children. The eating-ware component standard sizes can be increased gradually and unnoticeably, instead of progressing from “kiddy-sized” eating-ware components directly to adult-sized eating-ware components, which encourages overeating and may contribute to childhood obesity. In addition, schools, currently feed all children the same size portions on a single size tray or eating-ware component. School cafeterias could use different standard size eating-ware components to match the appropriate food portions with caloric needs of different age children.

Additionally utensil-like eating-ware of various standard sizes (SBS and/or SNS) can be offered for children to help them learn to eat at a slower consumption rate. Snacks and other pre-portioned items can use the incrementally-sized standard-sized eating-ware number system to help the consumers make the right choices throughout their day.

The incrementally-sized standard-sized eating-ware and system could be used as part of the treatment for eating disorders such as anorexia and bulimia. For example, anorexics have a distorted view of themselves and the amount of food they consume. Starting with a small eating-ware component, they could gradually become accustomed to larger and larger eating-ware components and portion standard sizes until reaching a healthy amount of food.

Other inventions that are used for measurement of food require that food is contained inside the measuring container. This type of measurement cannot be used to measure a flat surface. The act of measuring adds a cumbersome step that prevents many users from controlling the size of their standard portion and results in weight gain. The act of measurement will also make the users realize that they are depriving themselves in some way. The current size of typical eating-ware makes the appropriate food serving appear meager and the user feels deprived if they serve the right food standard portion to maintain optimal weight.

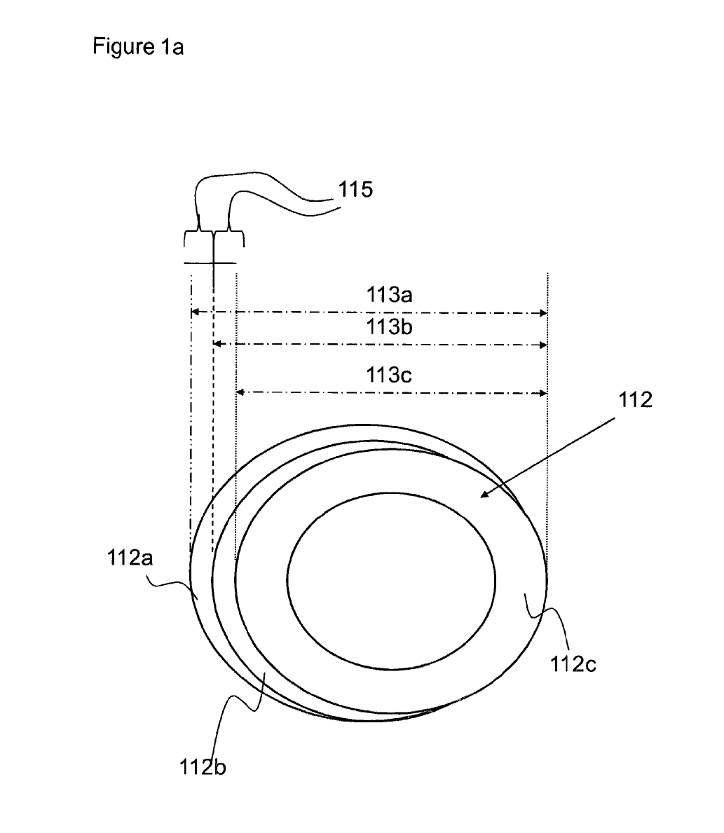

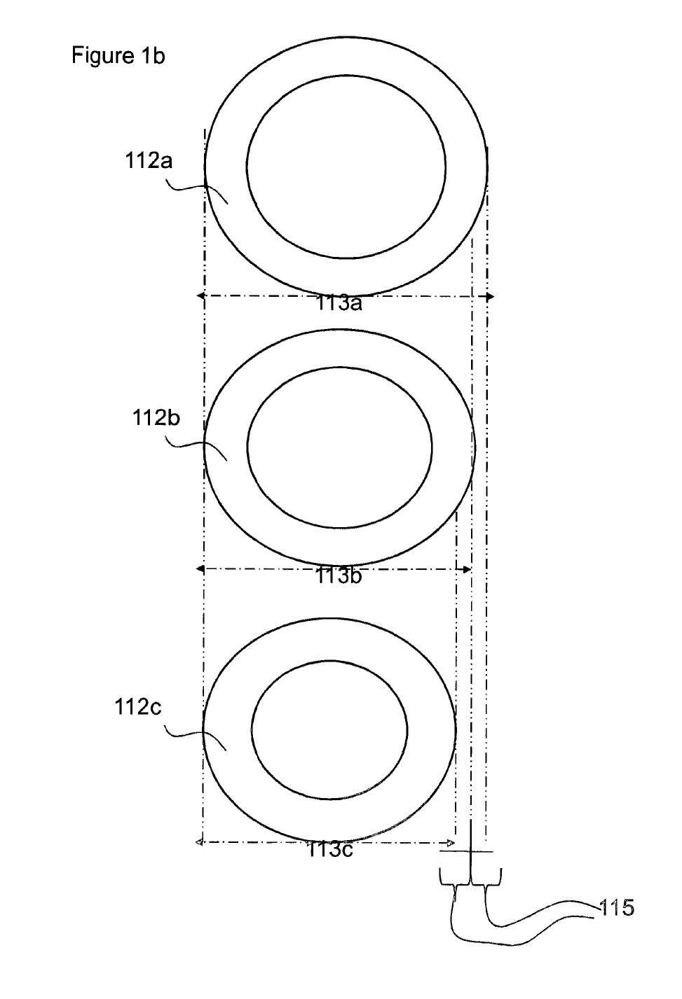

FIG. 1a illustrates a schematic view of a stack of flat round eating-ware components of the incrementally-sized standard-sized eating-ware system, while FIG. 1b illustrates a schematic view of some of the flat round incrementally-sized standard-sized eating-ware components separated from the set/stack of FIG. 1a. The incrementally-sized standard size eating-ware component is shown to look like a plate to demonstrate the—flat plate-like surface used for the formulas SPS and SSS and the incremental change 115 between standard sizes. The incrementally-sized standard-sized eating-ware system includes a plurality of incrementally-sized standard-sized eating-ware components 112a-112n having successively decreasing eating-ware component diameters da-dn. Herein eating-ware components 112a, 112b and 112c are shown with eating-ware component diameters da, db, and dc shown herein at 113a, 113b and 113c, respectively.

The round flat standard-sized plate-like surfaces increasing in small increment diameters are used to establish the basis for the Standard Portion Size and Standard Snack Size. The illustrations in FIG. 1 refer to a standard-sized plate-like device to illustrate how any standard-sized eating-ware component would have its dimensions and size adjusted in small and/or proportionate increments between each standard size.

Eating-ware component diameters da-dn, shown at 113a, 113b and 113c, of each of the incrementally-sized standard-sized eating-ware components 112a-112n are successively differentiated by an increment 115 to modify food portion intake delivered to a user. Increment 115 between successively decreasing eating-ware component diameters 112a, 112b and 112c ranges from 1/16 inch to a 1 inch increment. Preferably, increment 115 between successively decreasing eating-ware component diameters 112a, 112b and 112c ranges from ⅛ inch to a ½ inch increment. Most preferably, increment 115 between successively decreasing eating-ware component diameters 112a, 112b and 112c is ¼ inch.

The ¼ inch diameter increments of a round flat standard-sized plate-like surfaces form the basis for the whole number sizing of the Standard Portion Size of the incrementally-sized standard-sized eating-ware. The ⅛ inch diameter increments of a round flat standard-sized plate-like surfaces form the basis for the whole number sizing of the Standard Snack Size of the incrementally-sized standard-sized eating-ware. The integer value of a standard size represents a range of volumes that have the same number in the integer place. The decimal value of a standard size represents a single volume equivalent for each size SPS, SSS, SBS, and/or SNS. Fractional incrementally-sized standard-sized eating-ware increments can be implemented to further limit the detectability by a user. These increments can be smaller than the 1/16 inch above.

When increment 115 is small, the eating-ware component volume and vis-a-vie diameter changes or modifications are small so that shifting to the next or successive eating-ware component goes virtually unnoticed. The volume we are referring to is the total volumetric capacity directly above the flat round surface. The smaller diameter change results in a very gradual change in eating-ware component and vis-a-vie portion size.

Similarly, the Standard Bite Size and Standard Nibble Size, which are mostly applied to incrementally-sized standard-sized eating-ware components that you eat with (transfer food directly into the user), follow similar design of incremental adjustments. The basis for these standard sizes is an elliptical surface. The total volumetric capacity for food delivery is defined by an ellipsoid formed around this surface. The increment 115 equivalent is not the diameter change, but a change in the minor radius of the ellipsoid (where both minor radii are equal). When radii increment is small, the eating-ware component total volumetric capacity for delivery of food are small so that shifting to the next or successive eating-ware component goes virtually unnoticed. The smaller radii change results in a very gradual change in eating-ware component and vis-a-vie the amount of food delivered to the user per each mouthful, the rate of food delivery.

Another novel structural feature of the incrementally-sized standard-sized eating-ware system concerns the ability of the user to optimize his/her SBS and/or SNS. These two measures help the user establish how big a mouthful he/she needs to consume to feel satisfied. Also the process of optimizing the number of SBS and/or SNS per meal, per day, etc. gives the user a different way of managing his/her weight.

The incrementally-sized standard-sized eating-ware system and processes provide a weight loss program that focuses on incremental percent rate changes by automatically adjusting the portion served to a user. For example, for a flat round eating-ware component, change in area is equal to the following: change in area=pi/4 (d12−d22). Even though the change in eating-ware component diameter d1−d2 is constant, the rate at which the corresponding standard size' total volumetric capacity decreases is reduced in decreasing increments.

This is true for any round flat plate. As the user decreases each standard size (SPS and SSS) the “hurdle to the next standard size” (the amount of substance per one size reduction) decreases. This is motivating to the user and helps him/her attain and maintain his/her optimal weight.

This is also true for the utensil-like incrementally-sized standard-sized eating-ware components that are used to transfer food directly to the user. The incrementally-sized standard-sized eating-ware system and processes provide a weight loss program that not only focuses on incremental percent rate changes by automatically adjusting the portion served by a user, but also on incremental percent rate changes by automatically adjusting the rate the portion is transferred to a user. The amount of substance transferred per each transfer is dependent on the surface area of the utensil-like incrementally-sized standard-sized eating-ware. Standard Bite Size and Standard Nibble Size are based on a shape of a flat elliptically shaped spoon-like surface. As the minor radii decreases at a constant rate the volume decreases at a decreasing rate.

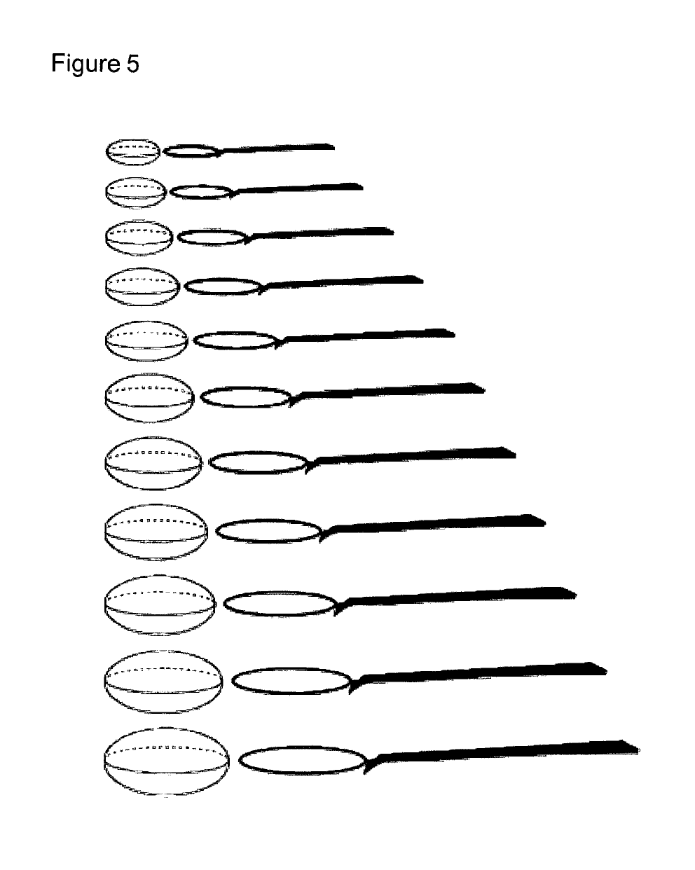

The user who makes the planar view assessment of the food quantity experiences a constant change in diameter/radii yet the amount of food reduced per SPS, SSS, SBS, and/or SNS is gradually decreasing. This creates a smaller and smaller hurdle to pass and therefore continually motivates the user to stick to his/her weight management regimen. Example of a “standard bite size” and “standard nibble size” are illustrated in FIG. 5.

The incremental adjustments in the area of the eating-ware component change the total volumetric capacity of the eating-ware component, and therefore alter the total calories consumed. As an individual reduces their eating-ware component standard size using constant diameter changes, the amount of calories per each change in diameter is decreased. This is true for a flat round plate as well as an elliptical flat spoon. The advantage of the incrementally-sized standard-sized eating-ware system is that it works on the consumption process in two ways. One is the two-dimensional component of a surface that is adjusted at small increments, and therefore the user who makes visual assessment during the serving and the consumption processes experiences little emotional impact. This aspect is adjusted at a constant rate. The other is the three dimensional aspect which affects the amount of substance contained within the incrementally-sized standard-sized eating-ware component, which affects the amount of substance consumed and the rate that it is consumed. Both aspects add to the positive motivational impact on the user.

To demonstrate this feature of the incrementally-sized standard-sized eating-ware system, a round flat plate-like surface is used. For example, when the eating-ware component is reduced from 10 to 9.75 inch diameter, the area of the eating-ware component is reduced by 3.88 square inches. Going from 5 inches to 4.75 inches, the area is reduced by 1.91 square inches, which corresponds to half the reduction of calories, assuming everything else is constant. Table I and Table II below set forth the diameter of the eating-ware component, the corresponding area and change in area with incremental change in diameter of ¼ inch for each sequential round eating-ware component, for Standard Portion Size and Standard Snack Size. The standard eating-ware component standard size dimensions assume a flat eating-ware component.

TABLE I
Standard Portion Size

| | | | | Volume of | |
|---|---|---|---|---|---|
| | | | | Incrementally | |
| Whole | | | | Sized | Change in |
| Number | Round Flat Surface and/or | | | Cylinder | volume per |
| Standard | Standard Portion Size | | | with height = | size change |
| Portion | Diameter | | Change in | 1 inch in | in inches |
| Size SPS | (inches) | Area (in²) | Area (in²) | cubic inches | cubed |
| 25 . . . | | | | | |
| 24 | 10 | 78.54 | | 78.54 | |
| 23 | 9.75 | 74.66 | 3.88 | 74.66 | 3.88 |
| 22 | 9.5 | 70.88 | 3.78 | 70.88 | 3.78 |
| 21 | 9.25 | 67.20 | 3.68 | 67.20 | 3.68 |
| 20 | 9 | 63.62 | 3.58 | 63.62 | 3.58 |
| 19 | 8.75 | 60.13 | 3.49 | 60.13 | 3.49 |
| 18 | 8.5 | 56.74 | 3.39 | 56.74 | 3.39 |
| 17 | 8.25 | 53.46 | 3.29 | 53.46 | 3.29 |
| 16 | 8 | 50.27 | 3.19 | 50.27 | 3.19 |
| 15 | 7.75 | 47.17 | 3.09 | 47.17 | 3.09 |
| 14 | 7.5 | 44.18 | 2.99 | 44.18 | 2.99 |
| 13 | 7.25 | 41.28 | 2.90 | 41.28 | 2.90 |
| 12 | 7 | 38.48 | 2.80 | 38.48 | 2.80 |
| 11 | 6.75 | 35.78 | 2.70 | 35.78 | 2.70 |
| 10 | 6.5 | 33.18 | 2.60 | 33.18 | 2.60 |
| 9 | 6.25 | 30.68 | 2.50 | 30.68 | 2.50 |
| 8 | 6 | 28.27 | 2.41 | 28.27 | 2.41 |
| 7 | 5.75 | 25.97 | 2.31 | 25.97 | 2.31 |
| 6 | 5.5 | 23.76 | 2.21 | 23.76 | 2.21 |
| 5 | 5.25 | 21.65 | 2.11 | 21.65 | 2.11 |
| 4 | 5 | 19.63 | 2.01 | 19.63 | 2.01 |
| 3 | 4.75 | 17.72 | 1.91 | 17.72 | 1.91 |
| 2 | 4.5 | 15.90 | 1.82 | 15.90 | 1.82 |
| 1 | 4.25 | 14.19 | 1.72 | 14.19 | 1.72 |
| 0 | 4 | 12.57 | 1.62 | 12.57 | 1.62 |

TABLE II
Standard Snack Size

| | | | | Volume of | |
|---|---|---|---|---|---|
| | | | | Incrementally | |
| Whole | | | | Sized | |
| Number | | | | Cylinder | Change in |
| Standard | Round Flat Surface and/or | | | with height = | volume per |
| Snack | Standard Snack Size | | | 1 inch | size change |
| Size | Diameter | | Change in | in cubic | in inches |
| SSS | (inches) | Area (in²) | Area (in²) | inches | cubed |
| 25 . . . | . . . | . . . | | . . . | |
| 24 | 3 | 7.069 | . . . | 7.069 | . . . |
| 23 | 2.875 | 6.492 | 0.577 | 6.492 | 0.577 |
| 22 | 2.75 | 5.940 | 0.552 | 5.940 | 0.552 |
| 21 | 2.625 | 5.412 | 0.528 | 5.412 | 0.528 |
| 20 | 2.5 | 4.909 | 0.503 | 4.909 | 0.503 |
| 19 | 2.375 | 4.430 | 0.479 | 4.430 | 0.479 |
| 18 | 2.25 | 3.976 | 0.454 | 3.976 | 0.454 |
| 17 | 2.125 | 3.547 | 0.430 | 3.547 | 0.430 |
| 16 | 2 | 3.142 | 0.405 | 3.142 | 0.405 |
| 15 | 1.875 | 2.761 | 0.380 | 2.761 | 0.380 |
| 14 | 1.75 | 2.405 | 0.356 | 2.405 | 0.356 |
| 13 | 1.625 | 2.074 | 0.331 | 2.074 | 0.331 |
| 12 | 1.5 | 1.767 | 0.307 | 1.767 | 0.307 |
| 11 | 1.375 | 1.485 | 0.282 | 1.485 | 0.282 |
| 10 | 1.25 | 1.227 | 0.258 | 1.227 | 0.258 |
| 9 | 1.125 | 0.994 | 0.233 | 0.994 | 0.233 |
| 8 | 1 | 0.785 | 0.209 | 0.785 | 0.209 |
| 7 | 0.875 | 0.601 | 0.184 | 0.601 | 0.184 |
| 6 | 0.75 | 0.442 | 0.159 | 0.442 | 0.159 |
| 5 | 0.625 | 0.307 | 0.135 | 0.307 | 0.135 |
| 4 | 0.5 | 0.196 | 0.110 | 0.196 | 0.110 |
| 3 | 0.375 | 0.110 | 0.086 | 0.110 | 0.086 |
| 2 | 0.25 | 0.049 | 0.061 | 0.049 | 0.061 |
| 1 | 0.125 | 0.012 | 0.037 | 0.012 | 0.037 |
| 0 | 0 | 0 | 0.12 | 0 | 0.12 |

To demonstrate this feature of the incrementally-sized standard-sized eating-ware system we use a round flat plate-like surface. For example: Family of four starting a weight loss initiative together using round flat plates: Father 300 lbs (plate's standard size is 24 for 10″ diameter flat round plate), mother 200 lbs (plate's standard size is 18 for 8.5″ diameter flat round plate), child 1 170 lbs (plate's standard size is 16 for 8″ diameter flat round plate), and child 2 150 lbs (plate's standard size is 14 for 7.5″ diameter flat round plate). They all start with eating-ware component standard sizes they feel comfortable with; when they go to the sequential incrementally smaller eating-ware component standard size, their flat round plates each reduce in area by different amounts. The father goes down by 3.88 sq. in., the mother by 3.29 sq. in., child 1 by 3.09 sq. in., and child 2 by 2.90 sq. in. They can motivate each other by reducing the eating-ware components by one standard size, but the calorie reduction will be different for each person. Obesity tends to run in families. The eating-ware component standard size variety can help parents realize that children need an eating-ware component standard size that corresponds to their size.

A plurality of eating-ware components is provided to form a set of incrementally-sized standard-sized eating-ware components. For example, if using round flat plates, wherein the smallest flat plate has a diameter of 4 inches (smaller round-flat plate sizes can be represented by negative numbers or typically would be represented by SSS rather than SPS) and a last flat plate has a largest plate diameter of 10 inches (bigger diameters and their respective incremental sizes follow the same formula for establishing their standard size for SPS), and the flat round plates are consecutively decreased by an increment of ¼ inch, twenty-five incrementally-sized standard-sized eating-ware components are provided, as in the example hereinabove (see Table I).

An incrementally-sized standard-sized setting may consist of multiple components of each type of eating-ware. As an example, a dinner plate may have five optional incrementally-sized standard-sized round flat plates. For example, the smallest round flat plate can have a diameter of 7 inches. This may represent the smallest round flat plate in the main or dinner plate set for most purposes. As discussed hereinafter, smaller round flat plates can, optionally, be used as dinner plates for people that require a greater calorie restriction. The round flat plates are used to demonstrate the concept, other shapes and configurations can be adjusted in a similar manner with the main focus on small incremental changes especially with the planar view of the eating-ware.

The system may further comprise a plurality of incrementally-sized standard-sized minor round flat plates designed to be used for lunch, dessert, salads, appetizers, or bread. When using round flat plates, the smallest is at least 4 inches and represents size 0 of the standard Portion Size, with successive round flat plate standard sizes increasing via ¼ inch diameter increments. These smaller incrementally-sized standard sized round flat plates also have significance for serving children, and/or adults who need a larger reduction in weight.

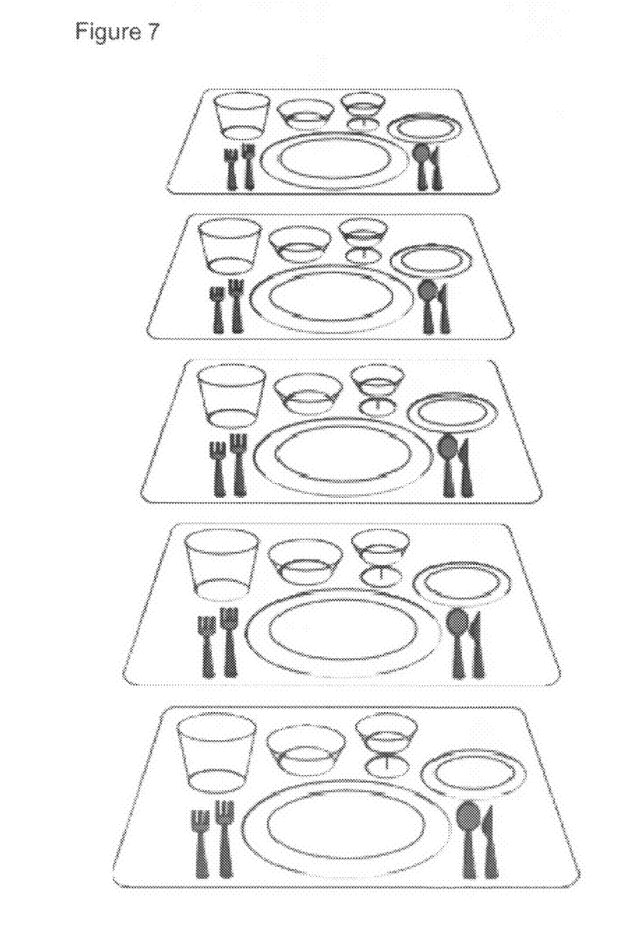

For this type of setting arrangement there would be five optional incrementally-sized standard-sized salad plates, desert plates, bowls, cups and saucers, glasses, mugs, butter plates, utensils, cutlery, etc. see FIG. 7.

For the purpose of demonstrating an example of one process that can be implemented using the incrementally-sized standard-sized eating-ware for weight management we are using a flat round plate as an example of an incrementally-sized standard-sized eating-ware component. The user shifts from using a starting eating-ware component selected from the incrementally-sized standard-sized eating-ware components (See FIG. 1b) 112a-112n to the next, successive eating-ware component standard size at a designated time interval to correspondingly modify the food portion intake. The user continues to successively shift from eating-ware components within the incrementally-sized standard-sized eating-ware components 112a-112n until the user reaches a goal food portion or weight. The person using the eating-ware components 112a-112n would start with a dinner eating-ware component standard size closest to their current eating-ware component standard size (i.e. the starting eating-ware component) and decrease one eating-ware component standard size at each designated time interval, such as every few days, or once per week, or longer if necessary. The time interval can be self guided by the user or guided by a professional like a doctor or nutritional consultant.

The time interval can range from daily, weekly, monthly or at any other interval that is selected by the user to lose or gain weight at their own pace. With each new time interval, the user shifts to the next successive eating-ware component.

Other processes that can be used to implement the incrementally-sized standard-sized eating-ware such as:
use the same standard sizes SPS, SSS, SBS, and/or SNS all day long (decreasing/increasing all 4 sizes after an interval of time);
use the same standard sizes for each type of meal (decreasing/increasing all 4 sizes after an interval of time);
use the same standard size for the type of food (decreasing/increasing all 4 sizes after an interval of time);
use a set number of standard-sized bites/nibbles per day, per meal, etc., and adjusting that number after an interval of time; use a set number of standard-sized bites/nibbles per day, per meal, etc., and adjusting the standard sizes of bites/nibbles after an interval of time.

The incrementally-sized standard-sized eating-ware can be used as a program designed for weight management. The program can incorporate charts and/or software for selection and/or determination of factors that determine the transition rate of each consecutive standard size combination. Preferably, a chart designating the eating-ware component appointed for selection from the incrementally-sized standard-sized eating-ware components 112a-112n is provided for determining a user's starting eating-ware component standard size as well as their end-use/goal eating-ware component standard size depending on their goal weight. The goal eating-ware component standard size is especially well suited for long term use in order to maintain a desired weight. Various weight management factors are utilized to determine the starting eating-ware component and goal eating-ware component, as well as the rate of shifting between successive eating-ware components. These factors preferably include, in combination, height, weight, gender, and activity level. A chart of goal eating-ware component vs. clothing sized (based on a typical height—weight range) can also be provided to help dieters meet their goal. The time interval for shifting between eating-ware components, and whether a user shifts consecutively or skips eating-ware components, is partially determined by the rate of weight loss the user is seeking. If the user is seeking rapid weight loss, the user may utilize a shorter time interval between eating-ware components, and/or may even skip eating-ware components to use smaller standard sizes at a more accelerated rate, thereby facilitating cut-back on food portion amounts at a more accelerated rate.

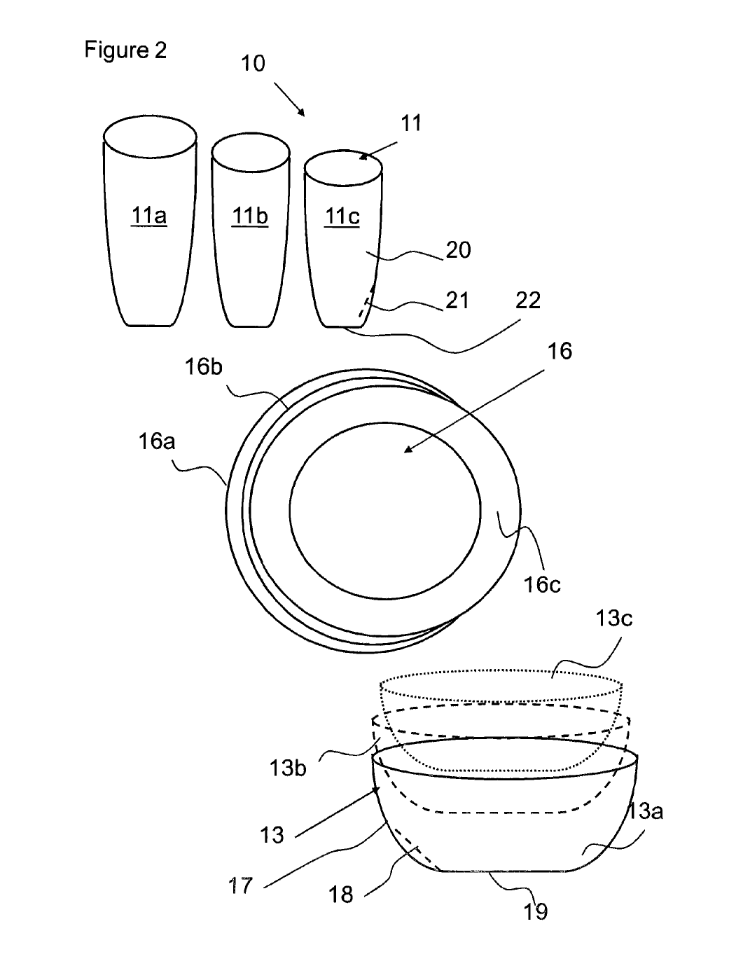

FIG. 2 shows how some of the incrementally-sized standard-sized eating-ware examples incrementally adjust in size. These adjustments in size, shape and/or configurations are made in such a way as to minimize the user's perception of change. FIG. 2 illustrates schematically an embodiment of the incrementally-sized standard-sized eating-ware system wherein a set of eating-ware components optionally includes incrementally-sized standard sized glasses and bowls, shown generally at 10. The incrementally-sized standard-sized eating-ware system may further comprise a plurality of incrementally-sized standard sized bowls 13a-13n, incrementally-sized standard sized salad round flat plates 16a-16n and/or incrementally-sized standard sized desert round flat plates corresponding to each of the plurality of incrementally-sized standard sized eating-ware components of FIG. 1, to form a plurality of incrementally-sized standard sized place settings a-n, as well as an optional plurality of incrementally-sized standard sized beverage containers 11a-11n. Incrementally-sized standard sized bowls 13a-13n comprise side walls 17 having a slope 18 and being oriented in relation to a bowl bottom 19 to form a bowl width. Each of bowls 13a-13n has an internal volume that incrementally differs by slightly adjusting slope 18, the height of side walls 17, and/or bowl bottom 19 to adjust the standard size. Bowls 13a-13n could start at standard size 0 and increase in small increments in various dimensions to help preserve undetectability between consecutive sizes. The bowls 13a-13n may include changing overall shape of the bowl and shapes and slopes of the sides in addition to the overall width in order to help reduce volume and decrease consumption while maintaining visually the perception that a larger quantity of food is contained within the bowl.

Incrementally-sized standard sized beverage containers 11a-11n are preferably selected from a group consisting of glasses, cups, or mugs. Beverage containers 11a-11n may successively decrease in height or/and in width and/or slope and/or shape to reduce the total volumetric capacity for each of the beverage containers 11a-11n to adjust the standard size.

Some users may find it easier to adjust their consumption intake by a constant reduction in total volumetric capacity. Therefore a fluid ounce or fractions of fluid ounce per each adjustment can create another process for a user to use. Although the standard sizes will not change at a constant increment, the amount of food and or rate of food transferred directly to the user can be adjusted at constant increments.

Each incrementally-sized standard-sized beverage container 11a-11n comprises a vessel having sides 20 arranged with a slope 21 in relation to a bottom 22, so that sides 20, slope 21, and/or bottom 22 may be incrementally reduced to create a total volumetric capacity reduction for each successive standard size change. These adjustments in size, shape and/or configurations are made in such a way as to minimize the user's perception of change. Beverage glassware (glasses, cups, mugs, etc.) 11a-11n could decrease in both height and width to reduce total volumetric capacity by standard size change. The shape and slope of the sides of the glassware 11a-11n can also be varied to control the volume of liquid, while minimizing the visual impact of the reduction.

Like incrementally-sized standard sized round flat plates 112a-112n of FIGS. 1a, 1b, the incrementally-sized standard sized place setting's bowls 13a-13n of FIG. 2, salad round flat plates 16a-16n and/desert round flat plates, and glasses 11a-11n are provided so that each member, bowl or glass, has different incremental standard sizes, 13a, 13b, 13c, 16a-16n and 11a, 11b, 11c, respectively, and delivers varying portion amounts. Through use of an incrementally-sized standard sized place setting, a user can set his or her table as usual, and when having dinner guests, the user will discretely continue on with his/her dieting goals.

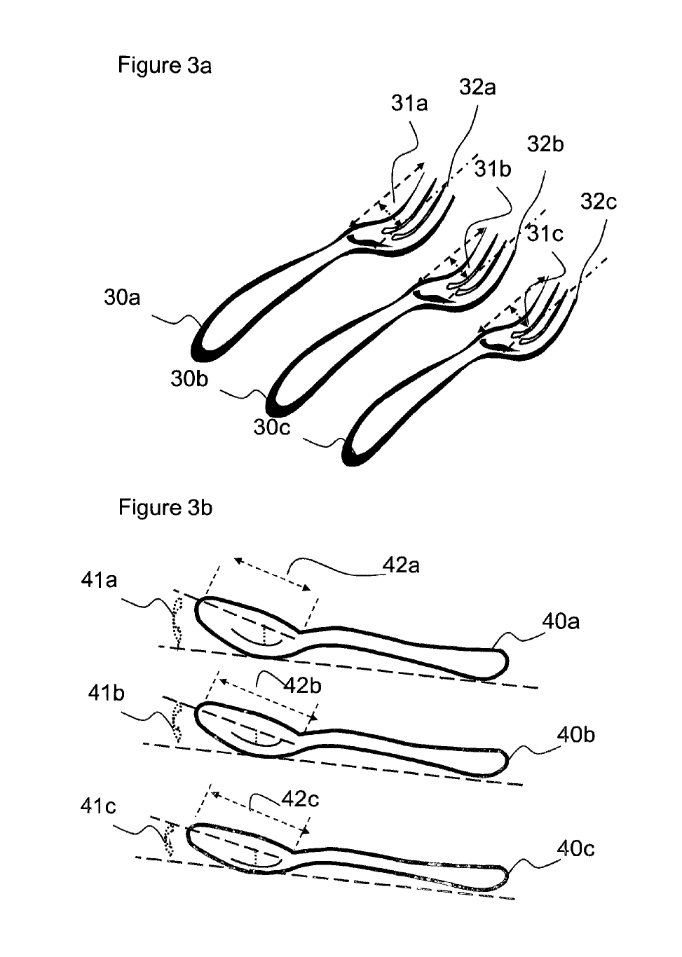

FIGS. 3a and 3b illustrate schematic views of optional incrementally-sized standard sized utensils, including incrementally-sized standard sized forks and incrementally-sized standard sized spoons. Other utensil-like eating-ware components will follow a similar pattern of size adjustment. A plurality of incrementally-sized standard sized forks 30a-30n and/spoons 40a-40n may be provided for delivering incrementally successively smaller bite standard sizes to the user. As a result, the user will be forced to eat more slowly as each bite is decreased in volume from the user's normal bite standard size. Forks 30a-30n may deliver smaller bites based on incrementally reducing each fork's depth 31a-31n or by shortening prongs 32a-32n. In turn, spoons 40a-40n may deliver smaller spoonfuls based on incrementally reducing each spoons depth 41a-41n or by shortening scoop length 42a-42n or the width. These dimensional adjustments are done to the surface or body extension that actually delivers food directly to the user. This is the portion that controls the Standard Bite Size and/or Standard Nibble Size of the eating-ware component. Another important aspect of these utensil-like eating-ware components and other eating-ware accessories used as part of the incrementally-sized standard sized eating-ware setting are overall dimensions, including features that do not directly contain the food, for example, handles, place-mats, etc. The relative overall size needs to proportionally adjust so that the eating-ware size reduction is not glaringly obvious due to relative size change.

The gradual reduction in Standard Bite/Nibble Size will gradually reduce the user's rate of food consumption and result in the user feeling more satisfied with the incrementally-smaller sized standard portion he or she consumes. Another process of implementing the incrementally-sized standard-sized eating-ware system is adjusting the SBS and/or SNS at a different rate then the SPS and/or SSS. This may make a transition easier for some of the users since the number of mouthfuls per SPS and/or SSS will change with each adjustment in SBS and/or SNS.

Each of the eating-ware components, such as plates, bowls, minor plates, salad/dessert plates, cups, mugs, and glasses may include encouraging reinforcement indicia to motivate the user to continue on with their weight management plan and to shift to the next successive eating-ware component. To account for differences in eating-ware component capacity due to different shapes and dimensions, eating-ware component standard sizes based on total volumetric capacity ranges can be established and imprinted on the back of each eating-ware component for easy user identification. Moreover, a restaurant eating-ware component system may be provided wherein a plurality of incrementally-sized standard sized restaurant eating-ware components are presented with portion amounts that can be readily compared to the incrementally-sized standard-sized eating-ware components used in a user's home.

When the incrementally-sized standard-sized eating-ware system is globally implemented for all eating-ware components the users will be able to continue on their weight management routine no matter where they are eating. Until then tools like charts and/or software, etc. can be provided to the users for cross-reference of the eating-ware components the standard sizes SPS, SSS, SBS, and/or SNS.

The Incrementally-Sized Standard-Sized Eating-ware System includes a single Standard Sized eating-ware component with demarcations that indicates one or more Standard Sizes, which allows a single eating-ware component to guide the user with multiple Standard Sizes.

The Incrementally-Sized Standard-Sized Eating-ware System can comprise of a plurality of Standard Sized templates and related devices to be used with Non-Standard Sized eating-ware, that provide guidance concerning the equivalency to the Standard Sizes.

These templates and related devices can have indicia to indicate the equivalency to one or more of the Standard Sizes.

With this arrangement, the user can maintain his or her portion modification in a restaurant environment. A system of standard or relative eating-ware component standard sizes could be utilized in restaurants and other eateries so that people can compare restaurant eating-ware components and portions with their own goals, or with normally-used eating-ware component standard sizes. The ratio of the diameters, the ratio of surface areas, or a ratio of the estimated volumes of the restaurant eating-ware component to the standard-sized eating-ware component can be provided to diners. In addition, that ratio, or other suitable indicia such as standard-sized eating-ware component standard size, eating-ware component diameter, surface area, total volumetric capacity, or the like, can be designated on the bottom of each eating-ware component, to facilitate distribution of eating-ware component settings among family members having divergent eating-ware component standard size requirements. These indicia can be located anywhere on the eating-ware component or on a guide that is available to the user. The indicia may be represented by design, demarcation, color, shape, or texture that represent a standard size and not necessarily the numerical value itself.

The Incrementally-Sized Standard-Sized Eating-ware System Standard Sizes can be marked on eating-ware using any of the following representations with Standard Size and/or Standard Size Range represented by:

encouraging reinforcement indicia,

standard size/s numerical value (representing total volumetric capacity(ties) and/or total volumetric capacity range(s)),

standard size represented by words like: small, medium, large . . . ,

standard size represented by words like: queen, king, pawn . . . ,

standard size represented by images: dots, animal shapes,

other indicia that would indicate incrementally increasing or decreasing Standard Size and/or Standard Size Range,

color and/or texture, and/or

imprinted design: pictorial or graphic.

In addition, the Incrementally-Sized Standard-Sized Eating-ware System can include a series of eating-ware in which Standard Sizes and/or Standard Size Ranges are indicated by variation between components in:

different colors,

different shapes,

different configurations, and/or

different texture
of each component within a series.

The Incrementally-Sized Standard-Sized Eating-ware System can also comprise of a single eating-ware component, in which multiple Standard Sizes and/or Standard Size Ranges are indicated within that component by:

encouraging reinforcement indicia,

standard size/s numerical value (representing total volumetric capacity and/or total volumetric capacity range),

standard size represented by words like: small, medium, large . . . ,

standard size represented by words like: queen, king, pawn . . . ,

standard size represented by images: dots, animal shapes,

other indicia that would indicate incrementally increasing or decreasing Standard Size and/or Standard Size Range,

color and/or texture, and/or

imprinted design: pictorial or graphic.

The Incrementally-Sized Standard-Sized Eating-ware System can have eating-ware components that are manufactured to the standard-sized specifications and/or the system can be applied to existing eating-ware components via measurement and/or calculation of equivalent total volumetric capacity.

The incrementally-sized standard-sized eating-ware can be produced as permanent eating-ware components, composed of glass, ceramic, plastic, metal or the like. Alternatively, the incrementally-sized standard-sized eating-ware can be produced as a disposable product, composed of paper, Styrofoam, plastic, or the like. Different colors of incrementally-sized standard-sized eating-ware could be available. Research has shown that color influences appetite and food intake. Different color eating-ware components can be used to increase appetite for those who want to gain weight, and decrease appetite for those who want to lose weight. Eating-ware components can be indistinguishable so that a parent can modify food intake without the awareness of the family members. Different colors can be used to represent different standard sizes of the eating-ware components.

Advantageously, the incrementally-sized standard-sized eating-ware system and processes provides eating-ware components and/or eating-ware component sets designed to decrease or increase consumption of food or drink over time with minimal impact on the consumer. Visual perceptions and habits greatly influence the quantity of food/liquid consumed. The eating-ware comprises of components that have an established standard size, such as SPS, SSS, SBS and/or SNS as defined by the formulas and are available with multiple components incrementally sized for the user to adjust sequentially and/or at his/her own rate for the purpose of weight management. Eating-ware components comprise part of a set; the standard size of the eating-ware components change from set to set. Eating-ware component standard size changes occur in small increments, making it difficult to notice the changes from day to day, or week to week. This results in small changes in food amounts consumed and/or the rate at which consumer transfers food to him/herself and therefore the user can achieve gradual and unnoticeable reduction in food consumption and succeed in a healthy weight management. Small daily or weekly changes in increments utilized by the incrementally-sized standard-sized eating-ware system and processes minimize the discomfort and feelings of deprivation that many people experience when dieting. The eating-ware components are proportioned between each standard size so that the calorie intake is slowly reduced (or increased) and a person diets (or gains weight) without significant effort and/or the recognition that a change in caloric intake is occurring. Consumers using the eating-ware components of the incrementally-sized standard-sized eating-ware system and processes will gradually become accustomed to smaller (or larger) standard sized eating-ware components and glassware, and portions of food and drink. They will gradually adjust all eating-ware components to the standard size that will assist them in maintaining their optimal weight.

Counting calories and measuring out food portions is no longer necessary, nor are dietary modifications involving departures from the user's normal foods. Advantageously, the user simply adjusts his/her portion standard size at an individualized pace by shifting to the next eating-ware component standard size.

Preferably, there are four standard formulas for assigning standard sizes to eating-ware components. The user of eating-ware uses visual, mostly planar view assessment of his/her portion relative to the eating-ware he/she is using to determine an adequate portion size. This is the reason why a planar surface of a flat plate-like round shape was used as the basis for two of the standard sizes, Standard Portion Size (SPS) and Standard Snack Size (SSS). For the same reason the planar surface of a spoon-like elliptical shape was used as the basis for the other two of the standard sizes, Standard Bite Size (SBS) and Standard Nibble Size (SNS).

FIG. 4 illustrates a schematic view of incrementally-sized Standard Portion Size (SPS) and incrementally-sized Standard Snack Size (SSS) and a sample of templates/physical objects and/or sample of visual representation printed and/or digital that represent these Standard Food Portion Sizes.

FIG. 5 illustrates a schematic view of incrementally-sized Standard Bite Size (SBS) and incrementally sized Standard Nibble Size (SNS) and a sample of templates/physical objects and/or sample of visual representation printed and/or digital that represent these Standard Food Portion Sizes

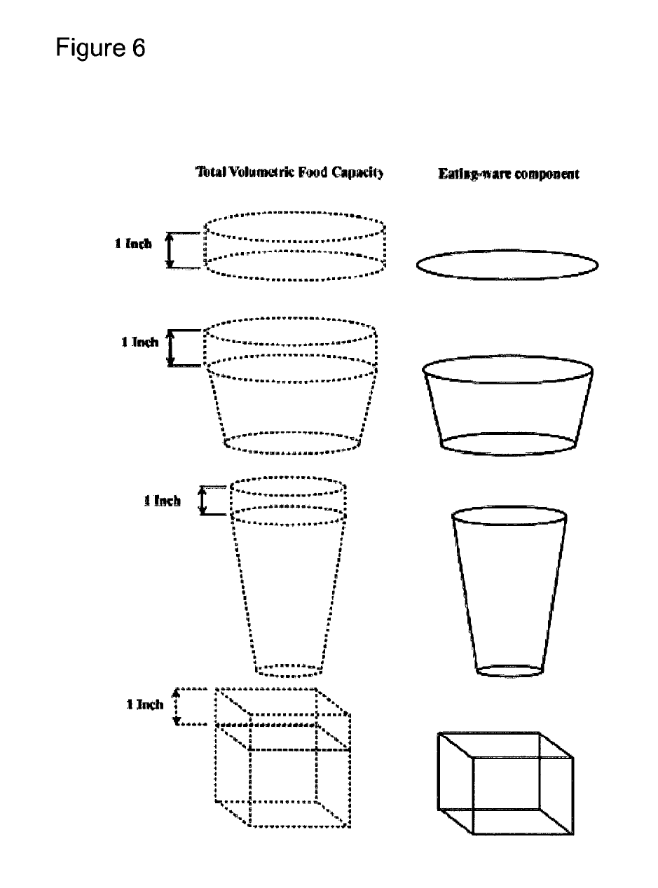

FIG. 6 illustrates the standard-sized eating-ware total volumetric food delivery capacity of variously shaped standard-sized eating-ware components.

FIG. 7 illustrates a schematic view of incrementally-sized Standard Size settings.

FIG. 8 illustrates a schematic planar view of the illusion created by a food portion placed on round flat surfaces that increase in diameter. This illusion leads to portion size distortion, whereby the portions appear smaller and smaller as the round flat surface increases even though the portion size remains constant.

Any of the Incrementally-Sized Standard-Sized Eating-ware System Standard Sizes can be expressed in terms of the other three Standard Sizes based on each other's equivalent total volumetric capacity.

Each of the Incrementally-Sized Standard-Sized Eating-ware System Standard Sizes may be expressed by a quantity of other Standard Size portions of food where:
a) the Standard Portion Size can be expressed as a quantity of Standard Snack Sizes based on the equivalent total volumetric capacity values and vice versa;
b) the Standard Bite Size can be expressed as a quantity of Standard Nibble Sizes based on the equivalent total volumetric capacity values and vice versa;
c) the Standard Portion Size and/or Standard Snack Size can be expressed in terms of a quantity of Standard Bite Sizes and/or Standard Nibble Sizes, based on equivalent total volumetric capacity values and vice versa.

Formulas

The formulas/calculations define relationships between various standard-sized eating-ware components and the standard sizes. The Incrementally-Sized Standard Sized eating-ware components can be used inter-changeably through selection of equivalent size eating-ware of corresponding Standard Size and/or Standard Size Range such as:

different sizes of a given type and style of component,

different sizes of the same type but different styles of components,

different types of the same style of components, and/or

different types and styles of component.

Standard Portion Size (SPS), is a standard sized eating-ware total volumetric food delivery capacity of a cylindrical space of 1 inch height directly above a flat round surface, where the diameter is equal to 4 inches or greater. The SPS=0 is equivalent to a 4″ diameter, 1 inch high standard portion. Each consecutive integer SPS is defined by an increment of ¼ inch increase in diameter of the cylinder base; for example standard portion that is 4.25 inches in diameter and 1 inch high is SPS=1, 4.5 inches in diameter and 1 inch high is SPS=2. and so on. Whole number SPS refers to a range of volumes that have the same integer portion of their value. A decimal Standard Portion Sizes can be interpolated in between the integer SPS values and refer to a single standard-sized volume.

The Standard Portion Size is a numeric representation of a 1 inch high cylinder space enveloped above a round flat surface. The Area (ASPS) of horizontal cross-section of a Standard Portion Size is a circle:

A_{SPS}=π×d²/4

where d is 4 inches at standard size 0 and increases by ¼ of inch per each increment in whole number standard size and π is a constant.

The volume VSPS of Standard Portion Size: the volume of a cylinder where height of the cylinder is constant at 1 inch times the area ASPS:

V_{SPS}=π×d²/4×1

The equivalent Standard Portion Size SSPS of any eating-ware component and/or for any volume can be determined as long as the surface area of the rim of the eating-ware component and the component's internal volume can be established. The volume of the surface of the rim area in inches squared is multiplied by 1 inch to obtain the volume directly above the eating-ware component. That volume is added to the internal volume of the eating-ware component (both in cubic inches). The total volume than is compared to an equivalent volume of the Standard Portion Size (SPS) and that corresponding size is assigned to the eating-ware component. The Standard Portion Size SSPS can be calculated as follows:

S_{SPS}=(the diameter of a cylinder in inches−4)×4

The Standard Snack Size (SSS) is a standard-sized eating-ware total volumetric food delivery capacity of a cylindrical space of 1 inch height directly above a flat round surface, where the diameter is equal to 0 inches or greater. The SSS of 0 is equivalent to 0″ diameter, linch high standard snack (food) portion. Each consecutive integer SSS is defined by an increment of ⅛ inch increase in diameter of the cylinder base; for example standard portion that is 0.125 inches in diameter and 1 inch high is SSS=1, 0.25 inches in diameter and 1 inch high is SSS=2. and so on. Whole number SSS refers to a range of volumes that have the same integer portion of their value. A decimal Standard Snack Sizes can be interpolated in between the integer SSS values and refer to a single standard-sized volume.

The Area ASSS of horizontal cross-section of Standard Snack Size is a circle:

A_{SSS}=π×d²/4

where d is 0 inches at standard size 0 and increases by ⅛ of inch per each increment in whole number standard size and π is a constant.

The volume VSSS of Standard Snack Size is a volume of a cylinder where height of the cylinder is constant at 1 inch times the area ASSS:

V_{SSS}=π×d²/4×1

The equivalent Standard Snack Size of any eating-ware component and/or for any volume can be determined as long as the surface area of the rim of the eating-ware component and the components internal volume can be established. The volume of the surface of the rim area in inches squared is multiplied by 1 inch to obtain the volume directly above the eating-ware component. That volume is added to the internal volume of the eating-ware component (both in cubic inches). The total volume then is compared to an equivalent volume of the Standard Snack Size (SSS) and that corresponding size is assigned to the eating-ware component.

Standard Snack Size S_{SSS} for a cylinder represented by a round flat surface can be calculated as follows:

S_{SSS}=the diameter of a cylinder in inches×8

Standard Bite Size is defined by the standard-sized eating-ware total volumetric food delivery capacity of an ellipsoid where both minor radii equal to 0.25 inches or greater and the major radius equals (1.5 times the minor radius) plus 0.125. The SBS=0 is equivalent to a standard-size food portion of a volume of an ellipsoid that has minor radii equal to 0.25″. The total volumetric food delivery capacity equivalent for each consecutive integer SBS is defined by an increment of 0.025 inch increase in minor radii. Whole number SBS refers to a range of volumes that have the same integer portion of their value. A decimal Standard Bite Sizes can be interpolated in between the integer SBS values and refer to a single standard-sized volume.

### Standard Bite Size Formulas:

Area A_{SBS} of horizontal cross-section of a Standard Bite Size is an ellipse:

A_{SBS}=π×rₘ×r_{M}

where

rₘ refers to the minor radius r_{M} refers to the major radius and π is a constant:

r_{M}=1.5×rₘ+0.125

A_{SBS}=1.5π×rₘ²+0.125×π×rₘ

Volume V_{SBS} of the ellipsoid where both minor radiuses are equal to each other is:

V_{SBS}=4/3×π×rₘ×rₘ×r_{M}

where

r_{M}=1.5×rₘ+0.125

V_{SBS}=2×π×rₘ³+⅙×π×rₘ²

Standard Bite Size (SBS) can be calculated as follows:

S_{SBS}=(rₘ+rₘ−0.75)/0.0625

where

r_{M}=1.5×rₘ+0.125

S_{SBS}=40×rₘ−10

rₘ=(S_{SBS}+10)/40

Table IIIa and Table IIIb below set forth the diameter to eating-ware component area and change in area and volume for each incremental changes for Standard Bite Size.

TABLE IIIa
Standard Bite Size Part a
Standard Bite Size

| | | | | Volume of | | |
|---|---|---|---|---|---|---|
| | | | | Incrementally- | | |
| | | | | sized | | |
| | | | | Standard- | | |
| | | | | Sized | Delta A- | Delta V- |
| Whole | | | | Eating- | change in | change in |
| Number | Minor | Major | Area of | ware | area per | volume |
| Standard | Radius | Radius | Ellipse | Ellipsoid | size | per size |
| Bite | rm | rM | in inches | in inches | in inches | in inches |
| Size | in inches | in inches | squared | cubed | squared | cubed |
| 25 . . . | | | | | | |
| 24 | 0.8500 | 1.40000 | 3.7384953 | 4.23696129 | 0.20715 | 0.35248 |
| 23 | 0.8250 | 1.36250 | 3.5313465 | 3.88448114 | 0.20126 | 0.33239 |
| 22 | 0.8000 | 1.32500 | 3.3300882 | 3.55209409 | 0.19537 | 0.31288 |
| 21 | 0.7750 | 1.28750 | 3.1347204 | 3.23921110 | 0.18948 | 0.29397 |
| 20 | 0.7500 | 1.25000 | 2.9452431 | 2.94524311 | 0.18359 | 0.27564 |
| 19 | 0.7250 | 1.21250 | 2.7616563 | 2.66960108 | 0.17770 | 0.25791 |
| 18 | 0.7000 | 1.17500 | 2.5839600 | 2.41169596 | 0.17181 | 0.24076 |
| 17 | 0.6750 | 1.13750 | 2.4121541 | 2.17093870 | 0.16592 | 0.22420 |
| 16 | 0.6500 | 1.10000 | 2.2462387 | 1.94674025 | 0.16002 | 0.20823 |
| 15 | 0.6250 | 1.06250 | 2.0862139 | 1.73851156 | 0.15413 | 0.19285 |
| 14 | 0.6000 | 1.02500 | 1.9320795 | 1.54566359 | 0.14824 | 0.17806 |
| 13 | 0.5750 | 0.98750 | 1.7838356 | 1.36760728 | 0.14235 | 0.16385 |
| 12 | 0.5500 | 0.95000 | 1.6414822 | 1.20375359 | 0.13646 | 0.15024 |
| 11 | 0.5250 | 0.91250 | 1.5050192 | 1.05351346 | 0.13057 | 0.13722 |
| 10 | 0.5000 | 0.87500 | 1.3744468 | 0.91629786 | 0.12468 | 0.12478 |
| 9 | 0.4750 | 0.83750 | 1.2497648 | 0.79151772 | 0.11879 | 0.11293 |
| 8 | 0.4500 | 0.80000 | 1.1309734 | 0.67858401 | 0.11290 | 0.10168 |
| 7 | 0.4250 | 0.76250 | 1.0180724 | 0.57690768 | 0.10701 | 0.09101 |
| 6 | 0.4000 | 0.72500 | 0.9110619 | 0.48589966 | 0.10112 | 0.08093 |
| 5 | 0.3750 | 0.68750 | 0.8099419 | 0.40497093 | 0.09523 | 0.07144 |
| 4 | 0.3500 | 0.65000 | 0.7147123 | 0.33353242 | 0.08934 | 0.06254 |
| 3 | 0.3250 | 0.61250 | 0.6253733 | 0.27099509 | 0.08345 | 0.05423 |
| 2 | 0.3000 | 0.57500 | 0.5419247 | 0.21676989 | 0.07756 | 0.04650 |
| 1 | 0.2750 | 0.53750 | 0.4643667 | 0.17026778 | 0.07167 | 0.03937 |
| 0 | 0.2500 | 0.50000 | 0.3926991 | 0.13089969 | | |

TABLE IIIb
Standard Bite Size Part b
Standard Bite Size

| | | Volume | | | | |
|---|---|---|---|---|---|---|
| | | of | | | | |
| | | Incrementally- | | | | |
| | | sized | | | | |
| | | Standard- | | | Rate of | Rate of |
| | | Sized | Delta A- | Delta V- | change | change |
| Whole | | Eating- | change in | change in | of Delta | of Delta |
| Number | Area of | ware | area per | volume | A- | V- |
| Standard | Ellipse in | Ellipsoid | size | per size | change in | change in |
| Bite | inches | in inches | in inches | in inches | area per | volume |
| Size | squared | cubed | squared | cubed | size | per size |
| 25 . . . | | | | | | |
| 24 | 3.7384953 | 4.23696129 | 0.20715 | 0.35248 | 0.00589 | 0.02009 |
| 23 | 3.5313465 | 3.88448114 | 0.20126 | 0.33239 | 0.00589 | 0.01950 |
| 22 | 3.3300882 | 3.55209409 | 0.19537 | 0.31288 | 0.00589 | 0.01892 |
| 21 | 3.1347204 | 3.23921110 | 0.18948 | 0.29397 | 0.00589 | 0.01833 |
| 20 | 2.9452431 | 2.94524311 | 0.18359 | 0.27564 | 0.00589 | 0.01774 |
| 19 | 2.7616563 | 2.66960108 | 0.17770 | 0.25791 | 0.00589 | 0.01715 |
| 18 | 2.5839600 | 2.41169596 | 0.17181 | 0.24076 | 0.00589 | 0.01656 |
| 17 | 2.4121541 | 2.17093870 | 0.16592 | 0.22420 | 0.00589 | 0.01597 |
| 16 | 2.2462387 | 1.94674025 | 0.16002 | 0.20823 | 0.00589 | 0.01538 |
| 15 | 2.0862139 | 1.73851156 | 0.15413 | 0.19285 | 0.00589 | 0.01479 |
| 14 | 1.9320795 | 1.54566359 | 0.14824 | 0.17806 | 0.00589 | 0.01420 |
| 13 | 1.7838356 | 1.36760728 | 0.14235 | 0.16385 | 0.00589 | 0.01361 |
| 12 | 1.6414822 | 1.20375359 | 0.13646 | 0.15024 | 0.00589 | 0.01302 |
| 11 | 1.5050192 | 1.05351346 | 0.13057 | 0.13722 | 0.00589 | 0.01244 |
| 10 | 1.3744468 | 0.91629786 | 0.12468 | 0.12478 | 0.00589 | 0.01185 |
| 9 | 1.2497648 | 0.79151772 | 0.11879 | 0.11293 | 0.00589 | 0.01126 |
| 8 | 1.1309734 | 0.67858401 | 0.11290 | 0.10168 | 0.00589 | 0.01067 |
| 7 | 1.0180724 | 0.57690768 | 0.10701 | 0.09101 | 0.00589 | 0.01008 |
| 6 | 0.9110619 | 0.48589966 | 0.10112 | 0.08093 | 0.00589 | 0.00949 |
| 5 | 0.8099419 | 0.40497093 | 0.09523 | 0.07144 | 0.00589 | 0.00890 |
| 4 | 0.7147123 | 0.33353242 | 0.08934 | 0.06254 | 0.00589 | 0.00831 |
| 3 | 0.6253733 | 0.27099509 | 0.08345 | 0.05423 | 0.00589 | 0.00772 |
| 2 | 0.5419247 | 0.21676989 | 0.07756 | 0.04650 | 0.00589 | |
| 1 | 0.4643667 | 0.17026778 | 0.07167 | 0.03937 | | |
| 0 | 0.3926991 | 0.13089969 | | | | |

Standard Bite Size can be determined for a non-standard eating-ware components and/or for any volume: 1) The non-standard eating-ware component internal volume V_{I} is measured; 2) The cross-sectional area of top of the non-standard eating-ware component is measured and the area A_{N-Bite} is calculated; and 3) The corresponding rₘ is calculated for the non-standard area A_{N-Bite} and is r_{mN}

A_{N-Bite}=1.5π×r_{mN}²+0.125××π×r_{mN}

1.5π×r_{mN}²+0.125×π×r_{mN}−A_{N-Bite}=0

For a Quadratic equation:

ax²+bx+c=0

x=(−b+SQRT(b²−4×a×c))/2×a

a=1.5π

b=0.125×π

c=−A_{N-Bite}

r_{mN}=(−(0.125×π)+SQRT((0.125×π)²−4×(1.5π)×(−A_{N-Bite})))/(2×1.5π)

The corresponding volume of non-standard eating-ware V_{NE} (external volume directly above the non-standard area is equal to the volume of ½ the ellipsoid formed by an equivalent standard area) is calculated for the r_{mN} and it represents a volume the half of a standard equivalent ellipsoid volume that would be directly above the standard size area equivalent to A_{N-Bite}.

Standard Bite Size volume:

V_{SBS}=2×π×rₘ³+⅙×π×rₘ²

½ of the ellipsoid of the equivalent Standard Bite Size:

V_{NE}=π×r_{mN}³+ 1/12×π×r_{mN}²

The corresponding V_{NE} is added to the internal volume of the non-standard eating-ware component for a total volume V_{NT}:

V_{NT}=V_{I}+V_{NE}

The corresponding r_{mT} is calculated using the cubic equation for V_{NT} and/or any known volume:

For a Cubic equation:

ax³+bx²+cx+d=0

x=−(b/3a)−(C/3a)−((b²−3ac)/3aC)

V_{NT}=2×π×r_{mT}³+⅙×π×r_{mT}²

2×π×r_{mT}³+⅙×π×r_{mT}²−V_{NT}=0

Q=√(2b³−9abc+27a²d)²−4(b²−3ac)³

C=[½×(Q+2b³−9abc+27a²d)]

a=2×π

b=⅙×π

c=0

d=−V_{NT}

Q=√(2(⅙×π)³+27(2×π)²×(−V_{NT})))²−4((⅙×π)²)³

C=½×([√(2(⅙×π)³+27(2×π)²×(−V_{NT})))²−4((⅙×π)²)³]+2(⅙×π)³+27(2×π)²×(−V_{NT})))

x=−(b/3a)−(C/3a)−((b²−3ac)/3aC)

r_{mT}=−[(⅙×π)/3(2×π)]−[C/3(2×π)]−((⅙×π)²/3(2×π)C)

The corresponding S_{NT} is calculated for the V_{NT} and/or any known volume based on:

S_{NT}=40×r_{mT}−10

The Standard Nibble Size is generally defined by the standard-sized eating-ware total volumetric food delivery capacity of an ellipsoid where both minor radii equal to 0 inches or greater and the major radius equals 1.5 times the minor radius. The SNS=0 is equivalent to a standard-size food portion of a volume of an ellipsoid that has a minor radius equal to 0″. The total volumetric food delivery capacity equivalent for each consecutive integer SNS is defined by an increment of 0.0125 inch increase in minor radii. Whole number SNS refers to a range of volumes that have the same integer portion of their value. A decimal Standard Nibble Size can be interpolated in between the integer SNS values and refer to a single standard-sized volume.

Standard Nibble Size Formulas:

A_{SNS} is the area of horizontal cross-section of Standard Nibble Size (SNS) which is an ellipse, where rₘ is the minor radius and r_{M} is the major radius with the formula for area:

A_{SNS}=π×rₘ×r_{M}

where:

r_{M}=1.5×rₘ

A_{SNS}=1.5×rₘ²

Volume of Standard Nibble Size (SNS) is an ellipsoid where both minor radiuses are equal to each other:

V_{SNS}= 4/3×π×rₘ×rₘ×r_{M}

where

r_{M}=1.5×rₘ

V_{SNS}=2×π×rₘ³

Standard Nibble Size (SNS):

where

r_{M}=1.5×rₘ

S_{SNS}=80×rₘ

Table IVa and Table IVb below set forth the diameter to eating-ware component area and change in area and volume for each incremental changes for Standard Nibble Size.

TABLE IVa
Standard Nibble Size Part a
Standard Nibble Size

| | | | | Volume | | |
|---|---|---|---|---|---|---|
| | | | | of | | |
| | | | | Incrementally- | | |
| | | | | sized | | |
| | | | | Standard- | | |
| | | | | Sized | Delta A- | Delta V- |
| Whole | | | | Eating- | change in | change in |
| Number | Minor | Major | Area of | ware | area per | volume |
| Standard | Radius | Radius | Ellipse | Ellipsoid | size | per size |
| Nibble | rm | rM | in inches | in inches | in inches | in inches |
| Size | in inches | in inches | squared | cubed | squared | cubed |
| 25 . . . | | | | | | |
| 24 | 0.3000 | 0.45000 | 0.4241150 | 0.16964600 | 0.03461 | 0.02033 |
| 23 | 0.2875 | 0.43125 | 0.3895084 | 0.14931155 | 0.03313 | 0.01864 |
| 22 | 0.2750 | 0.41250 | 0.3563744 | 0.13067062 | 0.03166 | 0.01702 |
| 21 | 0.2625 | 0.39375 | 0.3247131 | 0.11364957 | 0.03019 | 0.01547 |
| 20 | 0.2500 | 0.37500 | 0.2945243 | 0.09817477 | 0.02872 | 0.01400 |
| 19 | 0.2375 | 0.35625 | 0.2658082 | 0.08417259 | 0.02724 | 0.01260 |
| 18 | 0.2250 | 0.33750 | 0.2385647 | 0.07156941 | 0.02577 | 0.01128 |
| 17 | 0.2125 | 0.31875 | 0.2127938 | 0.06029158 | 0.02430 | 0.01003 |
| 16 | 0.2000 | 0.30000 | 0.1884956 | 0.05026548 | 0.02283 | 0.00885 |
| 15 | 0.1875 | 0.28125 | 0.1656699 | 0.04141748 | 0.02135 | 0.00774 |
| 14 | 0.1750 | 0.26250 | 0.1443169 | 0.03367395 | 0.01988 | 0.00671 |
| 13 | 0.1625 | 0.24375 | 0.1244365 | 0.02696125 | 0.01841 | 0.00576 |
| 12 | 0.1500 | 0.22500 | 0.1060288 | 0.02120575 | 0.01694 | 0.00487 |
| 11 | 0.1375 | 0.20625 | 0.0890936 | 0.01633383 | 0.01546 | 0.00406 |
| 10 | 0.1250 | 0.18750 | 0.0736311 | 0.01227185 | 0.01399 | 0.00333 |
| 9 | 0.1125 | 0.16875 | 0.0596412 | 0.00894618 | 0.01252 | 0.00266 |
| 8 | 0.1000 | 0.15000 | 0.0471239 | 0.00628319 | 0.01104 | 0.00207 |
| 7 | 0.0875 | 0.13125 | 0.0360792 | 0.00420924 | 0.00957 | 0.00156 |
| 6 | 0.0750 | 0.11250 | 0.0265072 | 0.00265072 | 0.00810 | 0.00112 |
| 5 | 0.0625 | 0.09375 | 0.0184078 | 0.00153398 | 0.00663 | 0.00075 |
| 4 | 0.0500 | 0.07500 | 0.0117810 | 0.00078540 | 0.00515 | 0.00045 |
| 3 | 0.0375 | 0.05625 | 0.0066268 | 0.00033134 | 0.00368 | 0.00023 |
| 2 | 0.0250 | 0.03750 | 0.0029452 | 0.00009817 | 0.00221 | 0.00009 |
| 1 | 0.0125 | 0.01875 | 0.0007363 | 0.00001227 | 0.00074 | 0.00001 |
| 0 | 0.0000 | 0.00000 | 0.0000000 | 0.00000000 | | |

TABLE IVb
Standard Nibble Size Part b
Standard Nibble Size

| | | Volume | | | | |
|---|---|---|---|---|---|---|
| | | of | | | | |
| | | Incrementally- | | | | |
| | | sized | | | | |
| | | Standard- | | | | |
| | | Sized | Delta A- | Delta V- | Rate of | Rate of |
| Whole | | Eating- | change in | change in | change of | change of |
| Number | Area of | ware | area per | volume | Delta A- | Delta V- |
| Standard | Ellipse | Ellipsoid | size | per size | change in | change in |
| Nibble | in inches | in inches | in inches | in inches | area per | volume |
| Size | squared | cubed | squared | cubed | size | per size |
| 25 . . . | | | | | | |
| 24 | 0.4241150 | 0.16964600 | 0.03461 | 0.02033 | 0.00147 | 0.00169 |
| 23 | 0.3895084 | 0.14931155 | 0.03313 | 0.01864 | 0.00147 | 0.00162 |
| 22 | 0.3563744 | 0.13067062 | 0.03166 | 0.01702 | 0.00147 | 0.00155 |
| 21 | 0.3247131 | 0.11364957 | 0.03019 | 0.01547 | 0.00147 | 0.00147 |
| 20 | 0.2945243 | 0.09817477 | 0.02872 | 0.01400 | 0.00147 | 0.00140 |
| 19 | 0.2658082 | 0.08417259 | 0.02724 | 0.01260 | 0.00147 | 0.00133 |
| 18 | 0.2385647 | 0.07156941 | 0.02577 | 0.01128 | 0.00147 | 0.00125 |
| 17 | 0.2127938 | 0.06029158 | 0.02430 | 0.01003 | 0.00147 | 0.00118 |
| 16 | 0.1884956 | 0.05026548 | 0.02283 | 0.00885 | 0.00147 | 0.00110 |
| 15 | 0.1656699 | 0.04141748 | 0.02135 | 0.00774 | 0.00147 | 0.00103 |
| 14 | 0.1443169 | 0.03367395 | 0.01988 | 0.00671 | 0.00147 | 0.00096 |
| 13 | 0.1244365 | 0.02696125 | 0.01841 | 0.00576 | 0.00147 | 0.00088 |
| 12 | 0.1060288 | 0.02120575 | 0.01694 | 0.00487 | 0.00147 | 0.00081 |
| 11 | 0.0890936 | 0.01633383 | 0.01546 | 0.00406 | 0.00147 | 0.00074 |
| 10 | 0.0736311 | 0.01227185 | 0.01399 | 0.00333 | 0.00147 | 0.00066 |
| 9 | 0.0596412 | 0.00894618 | 0.01252 | 0.00266 | 0.00147 | 0.00059 |
| 8 | 0.0471239 | 0.00628319 | 0.01104 | 0.00207 | 0.00147 | 0.00052 |
| 7 | 0.0360792 | 0.00420924 | 0.00957 | 0.00156 | 0.00147 | 0.00044 |
| 6 | 0.0265072 | 0.00265072 | 0.00810 | 0.00112 | 0.00147 | 0.00037 |
| 5 | 0.0184078 | 0.00153398 | 0.00663 | 0.00075 | 0.00147 | 0.00029 |
| 4 | 0.0117810 | 0.00078540 | 0.00515 | 0.00045 | 0.00147 | 0.00022 |
| 3 | 0.0066268 | 0.00033134 | 0.00368 | 0.00023 | 0.00147 | 0.00015 |
| 2 | 0.0029452 | 0.00009817 | 0.00221 | 0.00009 | 0.00147 | |
| 1 | 0.0007363 | 0.00001227 | 0.00074 | 0.00001 | | |
| 0 | 0.0000000 | 0.00000000 | | | | |

Standard Nibble Size can be determined for a non-standard Nibble size eating-ware component and/or for any volume: 1) The non-standard eating-ware component internal volume V_{I} is measured; 2) The cross-sectional area of top of the eating-ware component is measured and/or calculated the area A_{N-Nibble} is calculated; and 3) The corresponding rₘ is calculated for the non-standard area A_{N-Nibble} and is r_{mN}.

A_{N-Nibble}=1.5π×r_{mN}²

r_{mN}=√(A_{N-Nibble}/(1.5×π))

The corresponding V_{NE} (external volume directly above the non-standard area is equal to the volume of ½ the ellipsoid formed by an equivalent standard area) is calculated for the r_{mN} and it represents a volume the half of an ellipsoid volume that would be directly above the standard size area equivalent to A_{N-Nibble}.

Standard Nibble Size volume:

V_{Nibble}=2×π×r_{mN}³

½ of an ellipsoid of the equivalent:

V_{NE}=π×r_{mN}³

The corresponding V_{NE} is added to the internal volume of the non-standard eating-ware component for a total volume V_{NT}:

V_{NT}=V_{I}+V_{NE}

The corresponding r_{mT} is calculated using the cubic equation for V_{NT} and/or any known volume:

V_{NT}=2×π×r_{mNT}³

r_{mNT}=(V_{NT}/(2×π)

The corresponding S_{NT} is calculated for the V_{NT} and/or any known volume based on:

S_{Nibble}=80×rₘ

S_{Nibble}=80×(V_{NT}/(2×π)

A significant aspect of this invention is that the user can use the eating-ware components interchangeably. The Incrementally-Sized Standard-Sized Eating-ware System eating-ware components with the same Standard Size can be used interchangeably, and this interchangeability is independent of the type, style and/or configuration of eating-ware. The user can continue to stick to his/her weight management regimen regardless of how he/she eats as long as he/she uses the Incrementally-Sized Standard-Sized Eating-ware System eating-ware components with the same Standard Size.

In the Incrementally-Sized Standard-Sized Eating-ware System, any eating-ware and its Standard Size and/or Range and/or related total volumetric capacity equivalents can be listed or identified in books, guides, software, charts, menus, signs, labels, or external packaging indicia.

The Incrementally-Sized Standard-Sized Eating-ware System can include serving-ware where the internal volume contains the exact total volumetric capacity of a specific Standard Size, or it contains indicia indicating multiple Standard Sizes contained within. For example a soup ladle can be of a specific Standardized size or be able to dispense a standardized size volumetric equivalent of soup or contain markings of multiple standard sizes. A brownie tray can indicate marking of a standard size squares for example.

Although the volumetric shapes of a cylinder and an ellipsoid surrounding a flat elliptical surface have been used to establish standard sizes for food amounts, standard sizes can be established using other volumetric shapes, for example a hemisphere, a cone or a frustrum of a cone, and will be considered to be included within the scope of this invention.

The four Standard Sizes defined within will work well for most users. Some users may need a more customized transition between each incremental change. The Incrementally-Sized Standard-Sized Eating-ware System includes a series of Standard Sized eating-ware presented in a way that the rate of change in the total volumetric capacity decreases or increases between each increment:

a) at an increasing rate,

b) at a decreasing rate,

c) at a constant rate, or

d) at a variable rate.

The Incrementally-Sized Standard-Sized Eating-ware System includes a series of Standard Sized eating-ware, where the eating-ware's internal and/or external dimensions and/or configurations, including depth, height, slope of the walls, wall thickness, internal texture, shape of the inside, shape of the bottom, and/or a combination of some or all of the above, are varied in small increments to control the rate at which the incremental difference in total volumetric capacity between successive eating-ware in the series increases/decreases/remains constant/ or is varied/customized to the user needs.

Having thus described the invention in rather full detail, it will be understood that such detail need not be strictly adhered to. For example, the eating-ware component geometry can be circular, oval, polygonal or the like. Substantially any incrementally-sized standard-sized eating-ware geometry that permits incremental changes to be made in the surface area and total volumetric capacity of the incrementally-sized standard-sized eating-ware, is intended to fall within the scope of the invention. Additional changes and modifications may suggest themselves to one skilled in the art, for example, the invention is suitable for use with eating-ware components, such as plates, bowls, drink-ware, utensils, any item that can be used to serve and eat food directly from and/or any item that can be used to transfer food directly to user's mouth, etc. having a round, oval, square, cylindrical, cubic, or polygonal configuration. Incrementally-Sized Standard-Sized Eating-ware System eating-ware components can have any regular or irregular configuration, since an equivalent Standard Size can be determined established and/or assigned for any eating-ware component.

Embodiments of the present invention include a series of standardized portion templates that are incrementally-sized. According to one embodiment, the portion templates are objects or visual representations (for example, printed, digital, projected, and/or emitted images) that represent, identify, and/or deliver standardized food portion sizes as defined within the inventive system.

As previously described, in embodiments of the present eating-ware system, volumetric portions of food are defined by formulas that establish the standard sizes, which are based on a series of incrementally-sized flat surfaces. The flat surfaces establish the basis for total volumetric capacity equivalents, which include the volume inside the eating-ware and directly above the eating-ware. The standard sizes are used as a guide to control amount and rate of food consumed for weight management.

Users make visually based decisions when it comes to serving food and other substances. Currently there is no standardized way of presenting users food portions sized for the individual users. The currently available guides employ one-size-fits-all portion sizing by comparisons to typical objects like a deck of cards or a ball, for example. These objects, however, are generally not volumetrically standardized. In other methods, users are told to follow the size of their palm to judge their portion size. For an overweight person, however, their enlarged palm will guide them to consume more food. Subsequent to maturity, generally, palm size does not significantly change as a user ages, unless they gain weight.

By nature, when young, a user's ideal portion size increases as they grow to an adult. As they continue to age, their ideal portion size needs to decrease, for example, due to a loss of muscle mass. Every user is impacted by many factors, such as the amount of exercise and activity, the time of the day food is consumed, lifestyle changes due to career changes, moving to different location, getting married, getting pregnant, having children, and the like. And change is a seemingly constant factor. Therefore each user will have a unique ideal food portion that is individually sized for the adjustments needed to maintain, increase, or decrease weight to sustain a healthy lifestyle.

Childhood obesity, with its implications of lower self-esteem, depression, increased risk of diabetes and heart disease, is a cultural symptom of the one-size-fits-all and one-size-fits-big portion sizes. School cafeterias and restaurant “kid's meals” are currently training children to consume more than they need. Incrementally-sized standardized eating-ware and templates can be used to train a child to consume a portion size that is just right for that child's unique situation, so that obesity and related complications may be prevented.

Embodiments of the present invention establish a numeric value to a volumetric food portion in a way that the user can modify portion size at an increasing, decreasing, and/or constant rate. In other words, the user can decide and implement how fast to modify food portioning. Templates (for example, objects, or visual representations thereof) that physically and/or visually represent each incrementally-sized portion can be used for comparison when serving and/or for training users to learn and/or establish an ideal portion size that is right for their weight goal achievement, whether that is weight increase, decrease, or maintenance at a particular level.

According to one embodiment, the standardized templates are be made out of solid products and have different shapes, for example, a hockey puck, a rectangular solid, an egg, a ball, a heart, or the like). For example, as shown in FIGS. 9 and 10, a standardized volume can have different shapes. More specifically, the cylindrical solid 200 of FIG. 9 has a four inch diameter and a one inch height, and the rectangular solid 202 of FIG. 10 has a length of two inches, a width of two inches, and a height of 3.14 inches. Accordingly, the volumes of the two shapes 200 and 202 are substantially equivalent, and both equate to a standard size of zero in the inventive system.

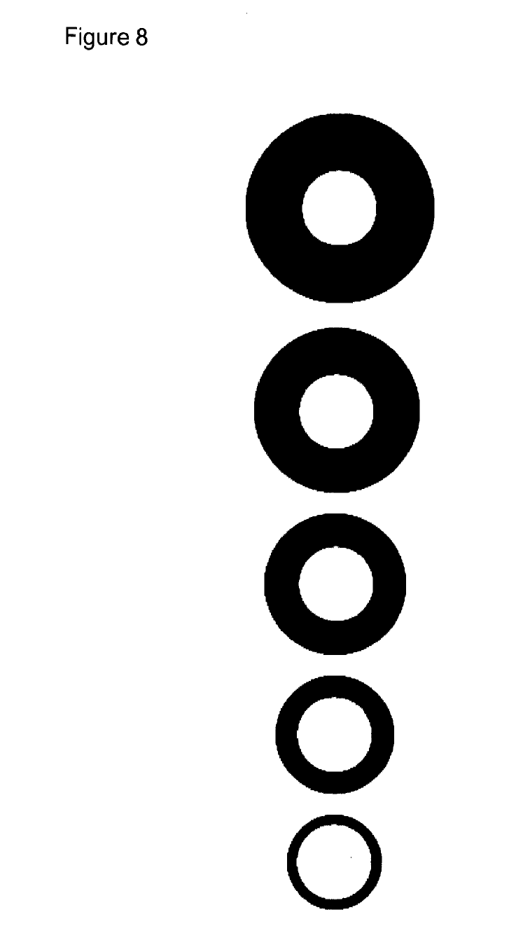

Similarly, as shown in FIG. 11, all of the different-shaped templates 203-207 have the same standardized size. For example, all of the templates 203-207 have a standardized size of 25 in accordance with the inventive standardized eating system. Additionally, all of the templates 208-212 of FIG. 12 have a standardized size of 24, and all the templates 213-217 of FIG. 13 have a standardized size of 23, despite their different shapes.

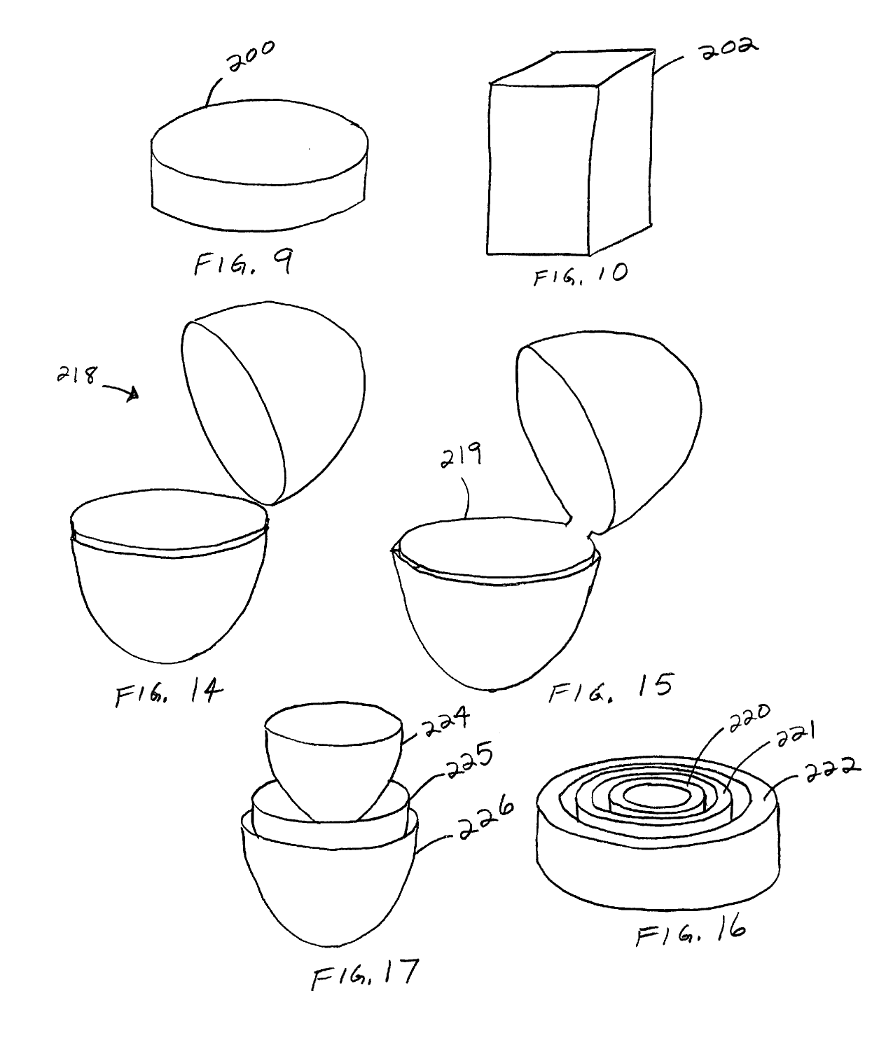

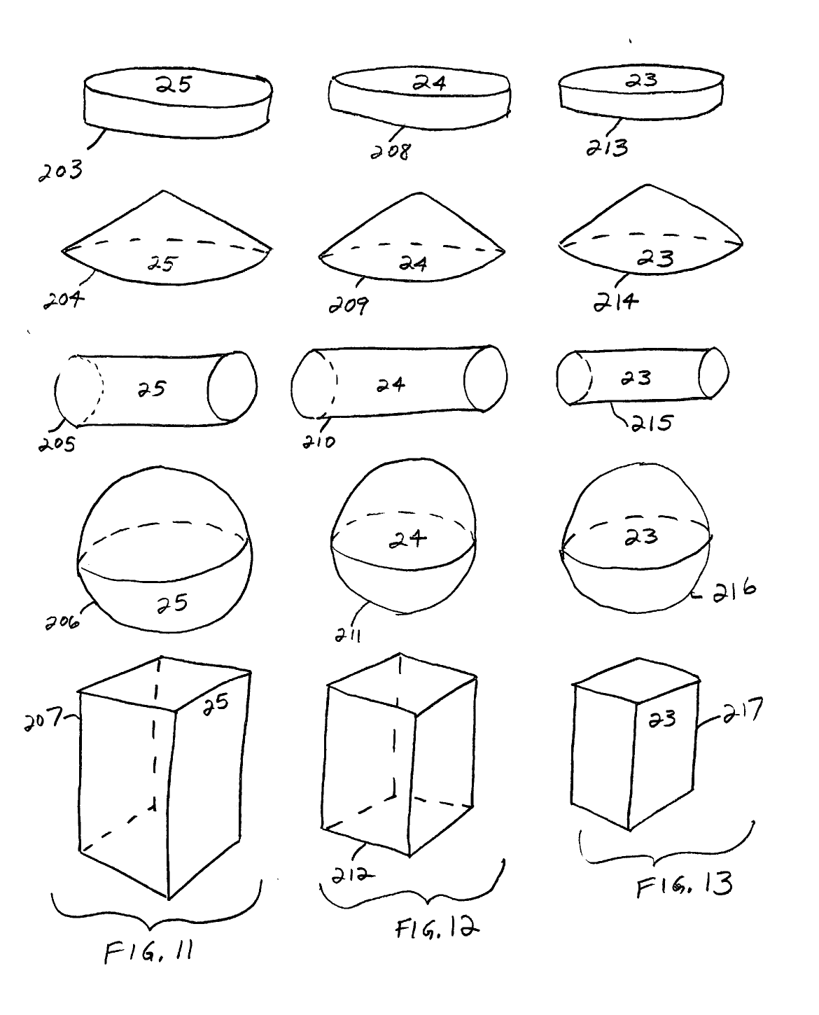

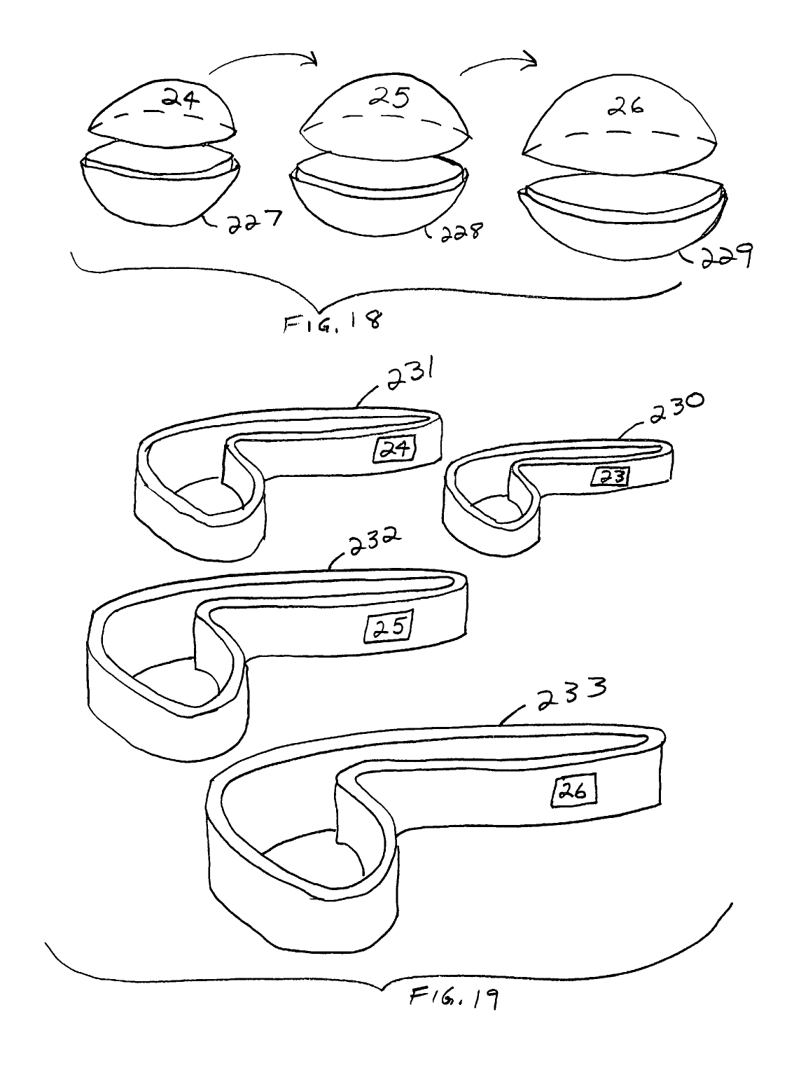

According to one embodiment, the templates are hollow and/or can collapse for ease of carrying. Templates can be single-piece or multiple-piece constructions, for example, like plastic Easter eggs, as shown in FIG. 14 (multiple piece construction template 218) and FIG. 15 (hingedly-connected single-piece construction template 219). According to one embodiment, the templates are stackable so that the outer, larger template contains “nested” smaller incremental templates 220-222, as shown in FIG. 16, for example. Additionally, templates can be nested like Russian nested dolls. In other words, according to one embodiment, each template encloses a volume, and that volume accommodates the sequentially-next smaller sized template. Such templates 224, 225, and 226 (which are like the egg-shaped embodiments of FIGS. 14 and 15) are illustrated in FIG. 17, although the tops of the templates 224, 225, and 226 are omitted for clarity. Similarly, FIG. 18 illustrates templates 227-229 with indicia denoting standardized food portion sizes 26, 25, and 24. The size 24 template 227 is nestable inside the enclosed volume of the size 25 template 228, and the size 25 template 228 is similarly nestable inside the size 26 template 229.

According to one embodiment, the templates are inflatable, like a beach ball. According to another embodiment, the templates are expandable and collapsible, like a dry sponge. According to another embodiment, the templates are fillable, like a paper or plastic bag.

According to another embodiment, the templates are malleable or re-shapeable, like play-doh or silly putty, or the like. According to yet another embodiment, the templates are another oppugnant substance comprising a viscous liquid, non-Newtonian fluid, viscoelastic fluid, or polymeric material. According to still another embodiment, the templates are made of plastic, wood, rubber metal, paper, or other materials.

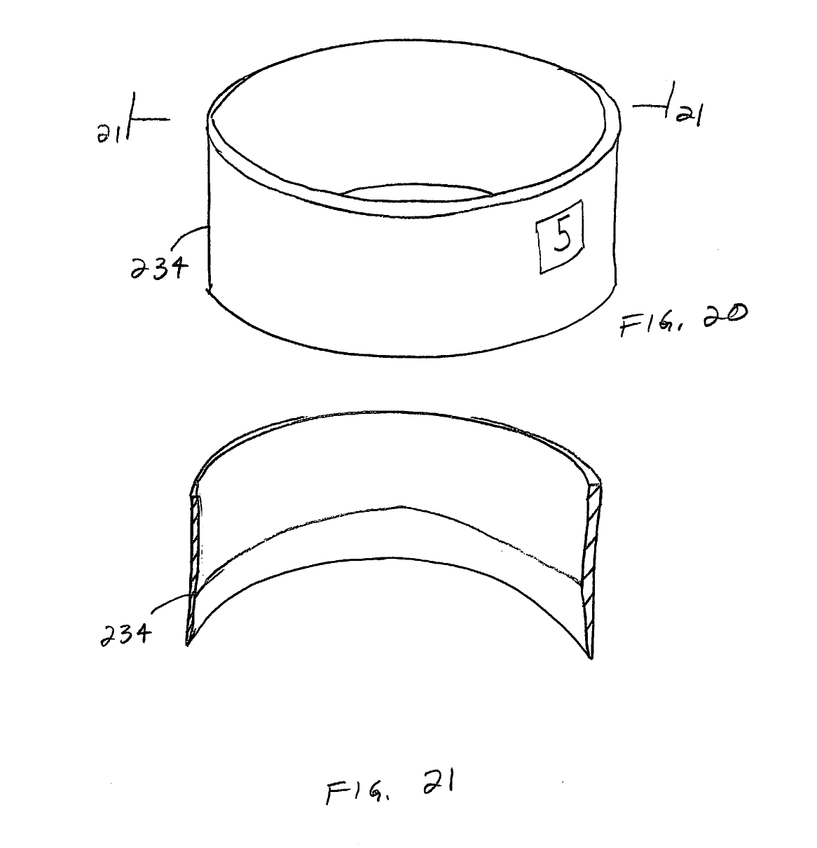

Templates in accordance with embodiments of the present invention can be solid, flexible and/or collapsible, and can be used for comparison, demonstration, delineation, and/or designation of surface and/or space. For example, as shown in FIG. 19, the templates 230-233 are a series of flexible templates that can be folded or collapsed for storage or transportation. The templates 230-233 each have indicia thereon denoting the correspondence of the template with the standardized portion size in accordance with the standardized eating system. For example, the templates 230-233 have indicia denoting portion sizes 23-26, respectively. According to one embodiment, the templates 230-233 are not subdivided. In addition to being collapsible, the templates 230-233 are nestable within each other, and a nested plurality of the templates 230-233 can be collapsed for storage and/or transportation.

Users can employ the templates to guide and/or control the meal and/or meal component's portion size that is served, or at least the size that is consumed, by comparing the meal and/or meal component to the template. More specifically, a user can employ the templates to visually compare the portion that is being served to the user's current standardized portion size. Having the visual representation of the portion will make it easy to estimate and/or measure the portion to serve and/or consume when embodiments of the incrementally-sized standardized eating-ware components are not available. In other words, the user can employ the standardized templates to serve the proper portion on non-standardized eating-ware.

After a while of using the system for example, pre-packaged food that identifies the portion size (for example, a frozen meal that is identified as a “Size 15” meal), the previously-described incremental standardized dish-ware, or templates (which include visual representations in printed, digital, and/or similar formats), the user will gain a better visual estimation of his/her portion and be better able to control the amount of food consumed. When a user finds a need to lose weight, the user can select an incrementally-smaller standardized size (for example, for the portion template or the dish-ware) and use it for a period of time. If the user does not succeed in the desired weight reduction, the user can shift to the following smaller standardized size. These templates can be used while serving to select an eating component that will just fit the selected standardized food portion, and can be available for use at home and outside of home. For example, the templates can be employed by servers in restaurants and other public eateries to deliver the desired standardized food portion. In addition, the standardized templates can be used for training to help a user learn the portion size needed to maintain, lose, and/or gain weight.

According to one embodiment, the templates are ring-like or can have different shapes with a top end and/or bottom end that is not enclosed (for example, as shown in FIG. 16), so that the templates fit within each other for ease of packaging and/or storage. Such templates with an open top and/or bottom end can be used to cut a specific Standardized Food Portion Size or to measure it out. For example, concentric rings (either fixed or flexible) can be used to demonstrate or measure out specific SPS, SSS, SBS, and/or SNS standard sizes, and be stacked within each other for ease of storage and shipping.

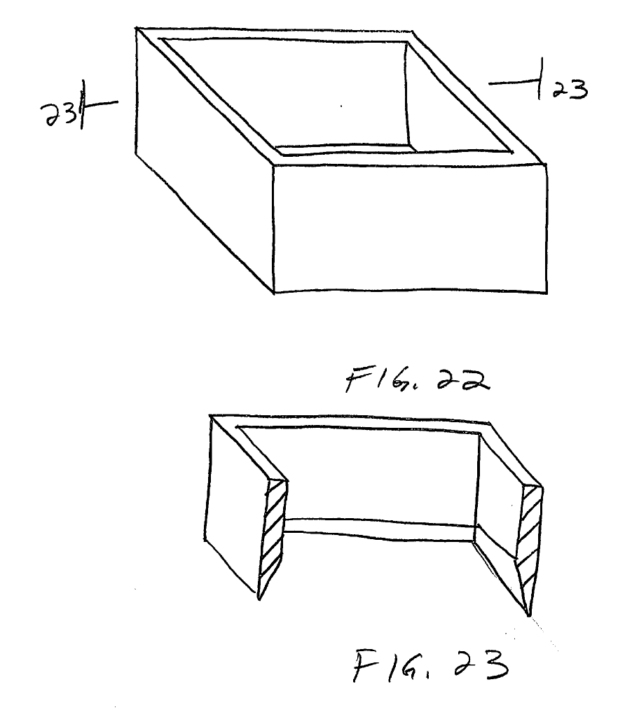

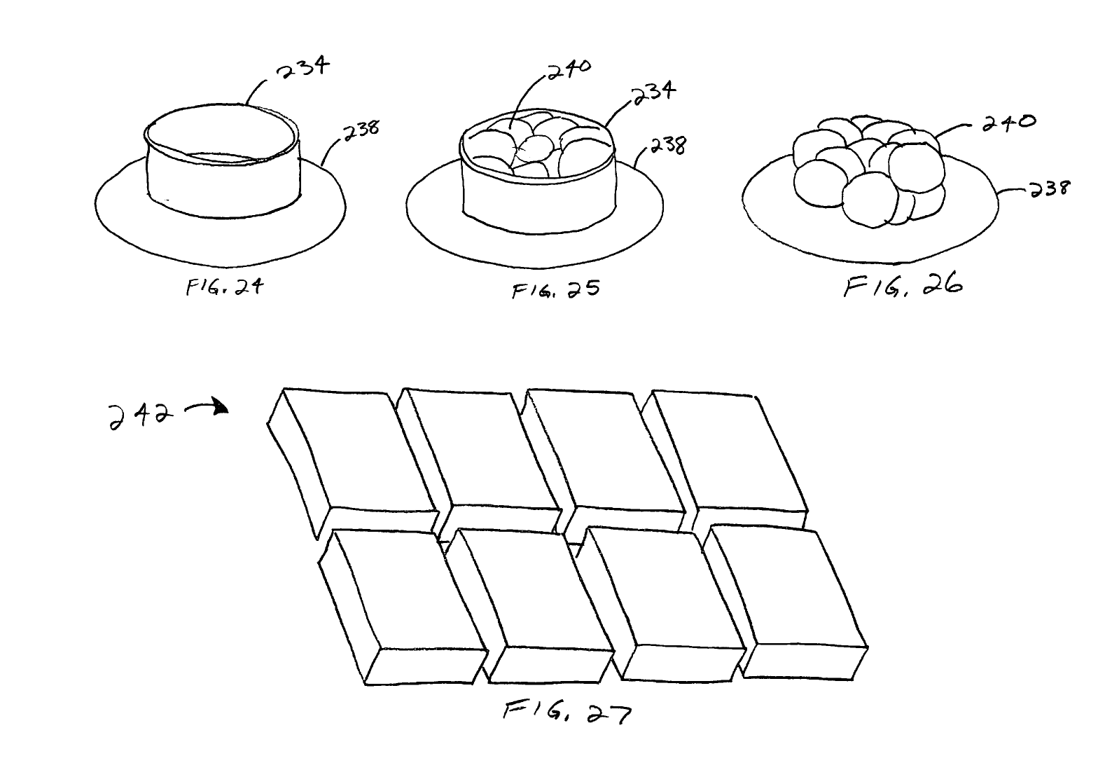

FIGS. 20 and 21 illustrate a hollow, cylindrical standardized size 5 template 234 with a cutting edge 235. Similarly, FIGS. 22 and 23 illustrate a hollow, rectangular standardized size 5 template 236 with a cutting edge 237. Each of the templates 234 and 235 can be used to cut a standardized size 5 portion, for example, out of a cake.

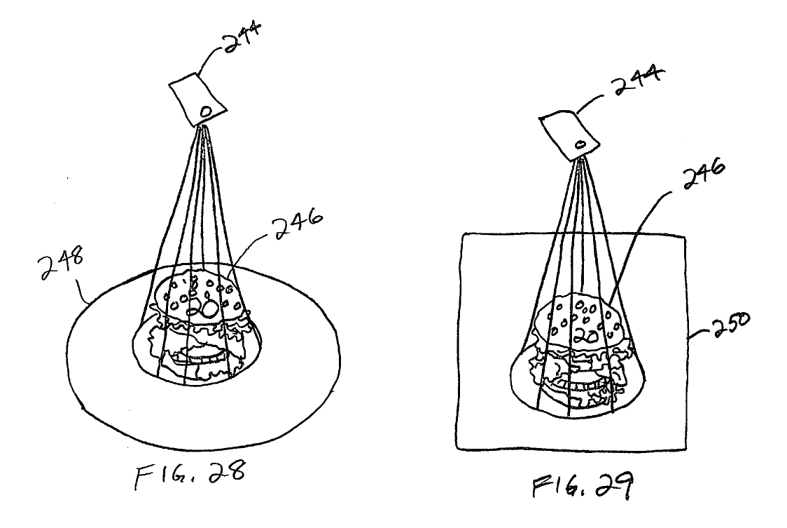

Additionally, as shown in FIGS. 24-26, the template 234 can be used with a plate 24 of any size (whether or not the plate is standardized size in accordance with the inventive eating system) to define a size 5 food portion of, for example, melon balls 240. In FIG. 24, the user places the template 234 on the plate 238. In FIG. 25, the user fills the template 234 with the melon balls 240, and in FIG. 26, the user removes the template 234.

FIG. 27 illustrates food partitioned by a rectangular template (such as template 236) into eight standardized size 5 portions.

According to one embodiment, the standardized food portion templates can be graphically and/or visually represented in printed, digital, or other format, for example, a holographic image. The templates can be in full scale or can be in a proportionally reduced scale for the purpose of demonstration. For example, as shown in FIGS. 28 and 29, a smartphone or other projector 244 projects a template image 246 of a standardized size 20 food portion as a hamburger onto the surface of a round plate 248 (FIG. 28) and a rectangular plate 250 (FIG. 29). According to one embodiment, the template image 246 is a hologram. According to one embodiment, the image 246 includes different food types to encourage a user to eat a more nutritious diet.

By employing the inventive system, for example, the templates, system-labeled pre-packaged food, or standardized dish-ware, the user will be able to establish and regulate the standardized food portion size(s) to lose/gain or maintain weight.

A user may want to increase consumption of desired substances like water, vegetable, high nutritional value substances, or another specific substance. The user can easily use the system to incrementally increase the standardized portion size of the desired substance. by using the next sequential standardized size up (or more than the next sequential standardized size if greater increase is desired). On the other hand the user may want to decrease consumption of undesired substances, such as caffeine, alcohol, high-salt content substances (to reduce the risk of high blood pressure), high-fat content substances (to reduce the risk of heart disease), high-sugar substances (to reduce the risk of diabetes), or a specific substance. The user can easily use the system to incrementally decrease the standardized portion size of this substance by using the next sequential standardized size down (or more than the next sequential standardized size if greater reduction is desired).

Due to poor eating habits, a diet filled with high-sugar and/or high-fat content foods, a dieter may find the portion size reduced to the levels that the user finds making the adjustments to be stressful. The user can be guided to make better food choices by using the inventive Caloric Density Mark (CDM) to select the foods. For example, the user may be using SPS 12 for all meals, but the food may have a CDM of G (>60 to 70 calories per cubic inch). By shifting to foods with CDM of F (>50 to 60 calories per cubic inch) and keeping standardized portion size the same, thereby reducing the user's daily caloric intake, the user can realize a weight loss. The user can be encouraged to dilute the substance of a given CDM with substances that will lower the overall CDM in incremental levels. For example, the user can dilute soda with SBS size 3 of water. The user can further dilute the soda with a, standardized size 4 of water, and thereby realize a greater CDM reduction.

The above-described system and processes can be used alone or in combination, depending on user preferences. One user may be able to use a single SPS, SSS, SBS, and/or SNS and make periodic adjustments based on life changes and be successful in maintaining a healthy weight. Other users may have a more difficult time adjusting to even smaller incremental changes. A medically supervised approach with monitoring of health vitals may be required. As dieters are individual in their needs and abilities to transition to gradually smaller standardized food portion sizes, the incrementally standardized system provides the user with the tools needed to develop and maintain healthy portion eating habits.

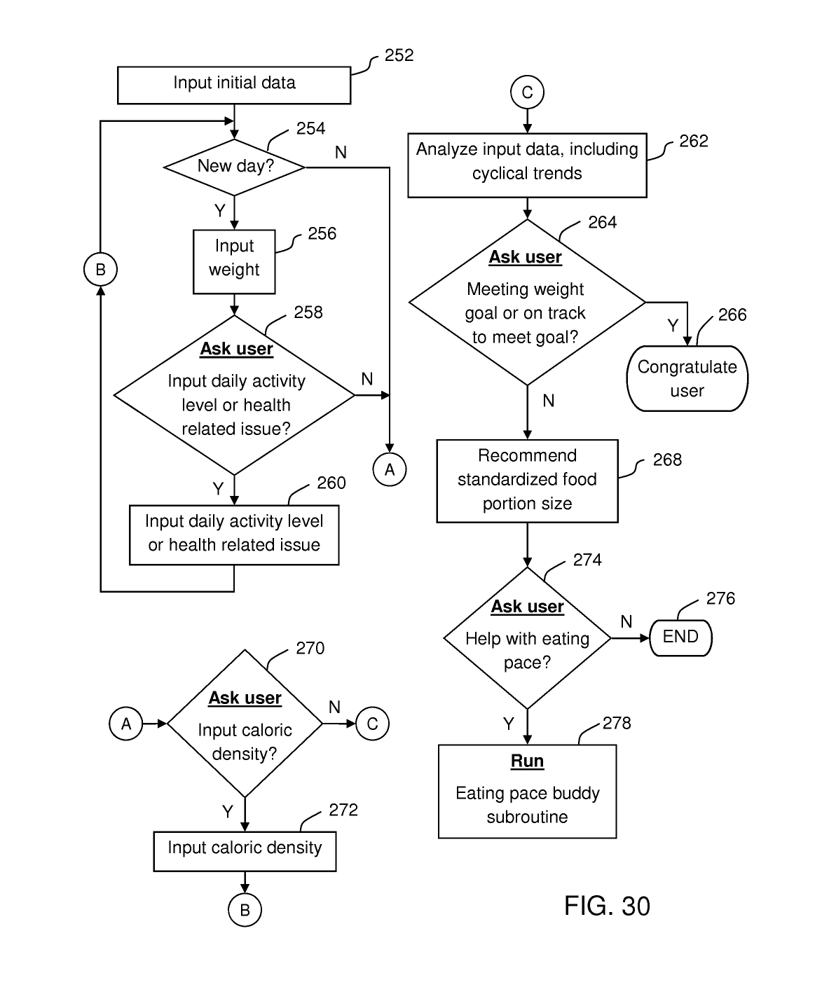

The flexibility of the system creates an opportunity for creating a customized and individualized eating process throughout a user's lifespan. Once the user establishes the current level of consumption, the user will easily be able to follow the standardized numeric sizing system and the alphabetical CDM system in their daily routine. Although the daily consumption will vary for every user, on average, there will be a trend that will indicate if there has been a lifestyle change. According to one inventive embodiment, a software application can be used for tracking weight and can detect a statistically significant change and guide the user to maintain or adjust the user's standardized food portions. According to one embodiment, as shown in FIG. 30, the user can indicate level of activity (amount of exercise), and/or indicate health related issues (258), and the software will recommend a standardized portion size (268) to maintain the user's weight at a desired level. According to one embodiment, in a preventative mode, the software detects cyclical trends (262), such as work week vs. weekend, or summer vs. winter, and recommends a size adjustment due to the cyclical changes (268). According to one embodiment, when a user has days of high levels of activity and low levels of activity, the software recommends reducing the standardized portion on the days when exercise does not occur.

According to one embodiment, the inventive software can help the user track standardized portion sizes and the caloric density (particularly if using the inventive CDM) of the planned or ingested food. This information can be used to help estimate the caloric content of a meal and daily consumption.

According to one embodiment, the software (278) can be used to help a user slow down their eating process and gradually extend the interval between each bite using a visual display of chewing duration. This would be especially useful when teaching children how to eat more slowly. For example a character-like friend or “buddy” can eat along with the child to teach them when to take the next bite, as well as entertain the child until the next bite. The child will learn to eat more slowly, and as a result can feel satiated prior to over-eating.

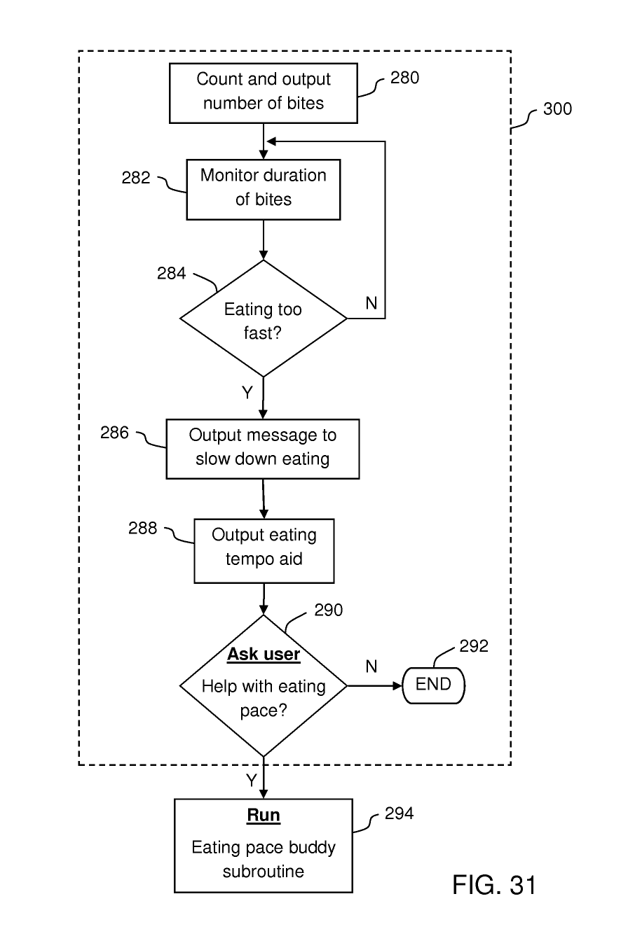

For example, as shown in FIG. 31, an eating “buddy” subroutine 300 can include the operations of counting and outputting a number of bites (280), monitoring the duration of bites (282), and using that data to determine (284) whether the user is eating too fast. If so, the subroutine outputs a message (286) to an input/output device, such as a display and/or speaker, to slow down the eating. The subroutine also can output a visual aid to the screen to illustrate the proper eating tempo (288). Subsequently, the subroutine asks the user (290) if they want additional help with their eating pace (290). If so, the device on which the subroutine is running (for example, a computer, a tablet, or a smartphone) runs the subroutine 300 again.

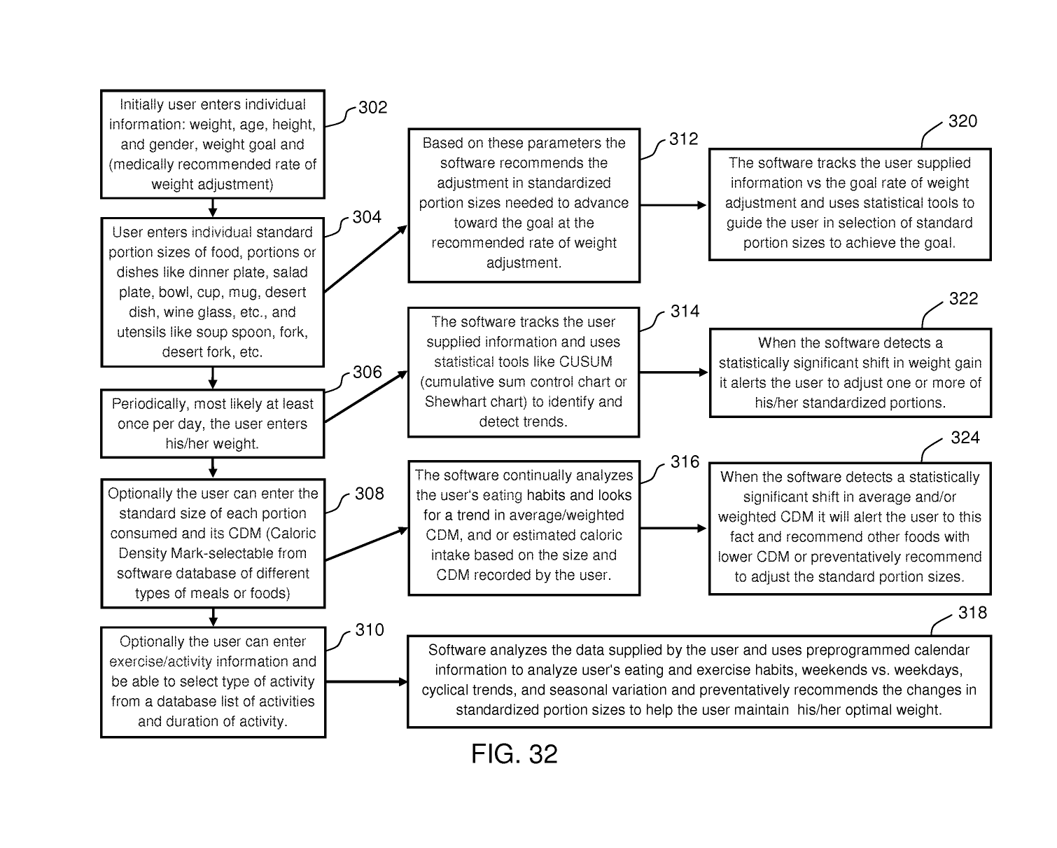

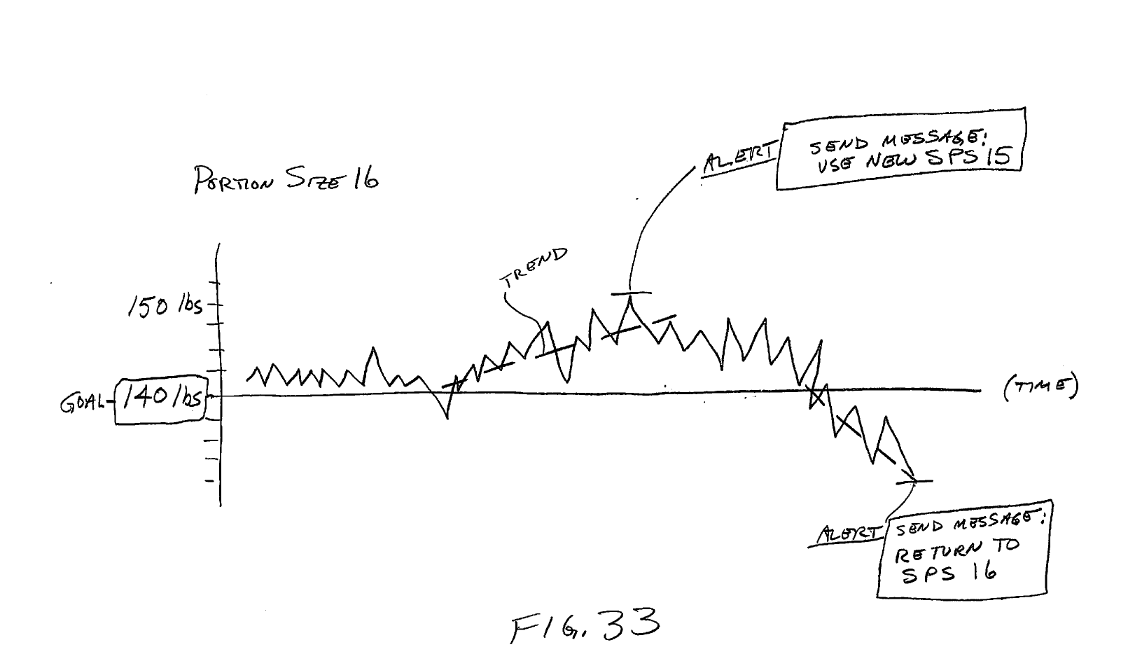

FIG. 32 is a block diagram of a software program in accordance with an embodiment of the present invention. In block 324, when the software detects a statistically significant shift in average and/or weighted CDM, as illustrated in the graph in FIG. 33, which can be output to a display, the software alarms the user to this fact.

When employing the system, for example if all eating components have an indicated standardized food portion size, achieving desired goals is relatively simple. For example, the user selects the components with the proper standardized portion size for them, serves, and eats.

Embodiments of the inventive system provide incrementally-sized eating-ware components that are deployed during intervals to provide gradual and effectively unnoticeable food portion reduction, thereby enabling a user to modify eating habits for effective weight management without feelings of deprivation. Embodiments of eating-ware include any item that is used to eat from and/or with. For example, surfaces, plates, bowls, cups, mugs, forks, and spoons. Embodiments of the system provide a plurality of standardized components that are incrementally sized and can be utilized in a graduated manner over a period of time. Embodiments of the present invention are designed to maintain, decrease, or increase serving sizes and vis-á-vie consumption of food over a period of time, depending on a user's weight management needs.

Embodiments of the inventive system allow the user to use implement the components in a process that delivers desired standardized portions that help the user succeed in losing, gaining, and/or maintaining weight. For example, if the user does not have the eating-ware components that have established Standard Food Portion Sizes, the user can employ the formulas to determine the size of his/her current eating-ware components, or can employ the templates. Here are some examples of how a user can use the inventive system's standardized portion sizes to lose weight:

### Example 1

User adjusts all standardized eating-ware components (see note below) sizes to lose weight. The noted sizes indicate the standardized sizes of eating-ware, and/or template used to guide the user in selection of the portion size and/or predetermined portion in case of prepared/pre-measured or prepackaged food. The period is a duration of time of using the selected sizes between size adjustments. For example, the period can be one week, but will vary with individuals.

| | Current SPS | 1st Period SPS | 2nd Period SPS |
|---|---|---|---|
| Dinner Plate | 20 | 19 | 18 |
| Soup Bowl | 15 | 14 | 13 |
| Dessert Plate | 10 | 9 | 8 |
| Glass | 8 | 7 | 6 |
| Cup | 6 | 5 | 4 |

| | Current SSS | 1st Period SSS | 2nd Period SSS |
|---|---|---|---|
| Snack-ware | 10 | 9 | 8 |

| | Current SBS | 1st Period SBS | 2nd Period SBS |
|---|---|---|---|
| Soup Spoon | 18 | 17 | 16 |
| Fork | 16 | 15 | 14 |

### Example 2

User adjusts some standardized eating-ware component sizes to lose weight. Again, the noted sizes indicate the standardized sizes of eating-ware, and/or template used to guide the user in selection of the portion size and/or predetermined portion in case of prepared/pre-measured or prepackaged food. The period is a duration of time of using the selected sizes between size adjustments. For example, the period can be one week, but will vary with individuals.

| | Current SPS | 1st Period SPS | 2nd Period SPS |
|---|---|---|---|
| Dinner Plate | 20 | 19 | 18 |
| Soup Bowl | 15 | 15 | 15 |
| Dessert Plate | 10 | 10 | 10 |
| Glass | 8 | 8 | 8 |
| Cup | 6 | 6 | 6 |

| | Current SSS | 1st Period SSS | 2nd Period SSS |
|---|---|---|---|
| Snack-ware | 10 | 9 | 8 |

| | Current SBS | 1st Period SBS | 2nd Period SBS |
|---|---|---|---|
| Soup Spoon | 18 | 17 | 16 |
| Fork | 16 | 15 | 14 |

There are infinite combinations that can be used, but the individual will be able to determine the right combination for them and easily follow the inventive standardized system to lose, gain, and/or maintain weight.

According to one embodiment, to begin the process, the user first establishes the correlation of current eating-ware components to the inventive system's standardized eating-ware components. For example, the user can employ the previously-described formulas, use the previously-described information or chart, and/or can utilize the standardized templates. Preferably, the user measures weight daily to establish a current weight and identify “typical” daily fluctuations. To reduce weight, the user decreases the standardized portion size, for example, by utilizing the next sequentially-reduced size of eating-ware and/or template. The user can adjust one component and/or size at a time, or can make multiple adjustments for quicker results. At the end of each period (for example, weekly, but noting that the period may vary based on medical advice or recommendations) the user will determine the amount of weight lost.

If no weight was lost, the user can go to the next sequentially-reduced size of eating-ware components and/or templates. If the user loses 1-2 lbs, the user's doctor may recommend continuing at this level for another period (for example, another week) or may recommend reduction by one size interval. This iteration of adjustment and assessment will continue until the user is able to sustain the desired weight. The inventive system can help determine the optimal standardized portion size for the user that will help the user maintain a desired/optimal weight. When the user is eating out the user can either bring a template for comparison or go to a location that serves food using the inventive system's eating-ware components, or uses devices that cut, measure and/or indicate the portion size in terms of the inventive system. Ideally, food packaging companies would adopt the inventive system and indicate the systemic portion size directly on the packaging. This would permit the user to consume the food knowing with confidence that the portion size is the right “sized” portion for him or her.

Another way to implement the inventive system is to use utensils that the user knows the size of with respect to the standardized system. For example, the user may typically consume 35 mouthfuls of food for dinner, 18 for breakfast, and 25 for lunch. Initially the user uses a utensil with, for example, standardized bite size (SBS) of 17. Utensils labeled in accordance with the inventive system can be utilized, or the previously-described formulas or templates can be used to determine the size of utensils not labeled in accordance with the inventive system. Again, the user would establish baseline weight and day to day fluctuation first. Then, the user would select utensils with an SBS of 16. Even though the user would consume same number of mouthfuls, the user would consume less food. The user would weigh themselves and follow the above-described size reduction, preferably with medical supervision, until the user achieves a desired weight.

Counting mouthfuls while eating may be cumbersome to some users. Accordingly, a standardized utensil that is able to track the mouthfuls and indicate them to the user would make this easier. Preferably, the utensil includes an electronic or mechanical device that is also capable of monitoring duration between mouthfuls, to help the user adjust the speed of consumption. According to one embodiment, interactive software counts the number of bites and the chewing duration using, for example, a camera linked to a computer, phone, or tablet device. According to one embodiment, the device and/or software application has distracting or entertaining capabilities to help user fill the time, and thereby slow down between mouthfuls. Such an embodiment would be especially useful for children that are learning a correct way of eating.

According to one embodiment, as shown in FIG. 34, the handle 326 includes an electronic portion with a memory to store a program or programs, and a display 328 and/or speaker for input and/or output. The handle 326 can be attached and detached to different utensils, for example, standardized spoons 330, 332, 334, and -336, via a locking mechanism 329, to implement system utensil size modifications. According to one embodiment, the locking mechanism 329 also includes a load sensor for determining a weight of food disposed on the utensil. Additionally, according to one embodiment, the handle can be detached for cleaning of the utensils, for example, in a dishwasher.

In one embodiment, the handle 326 includes a plurality of signal lights 331, 333, and 335. As subsequently described in greater detail, when using the handle 326 with a connected utensil, the program or programs can interactively signal the user via the signal lights. According to one embodiment, the signal lights are green (331), yellow (333), and red (335).

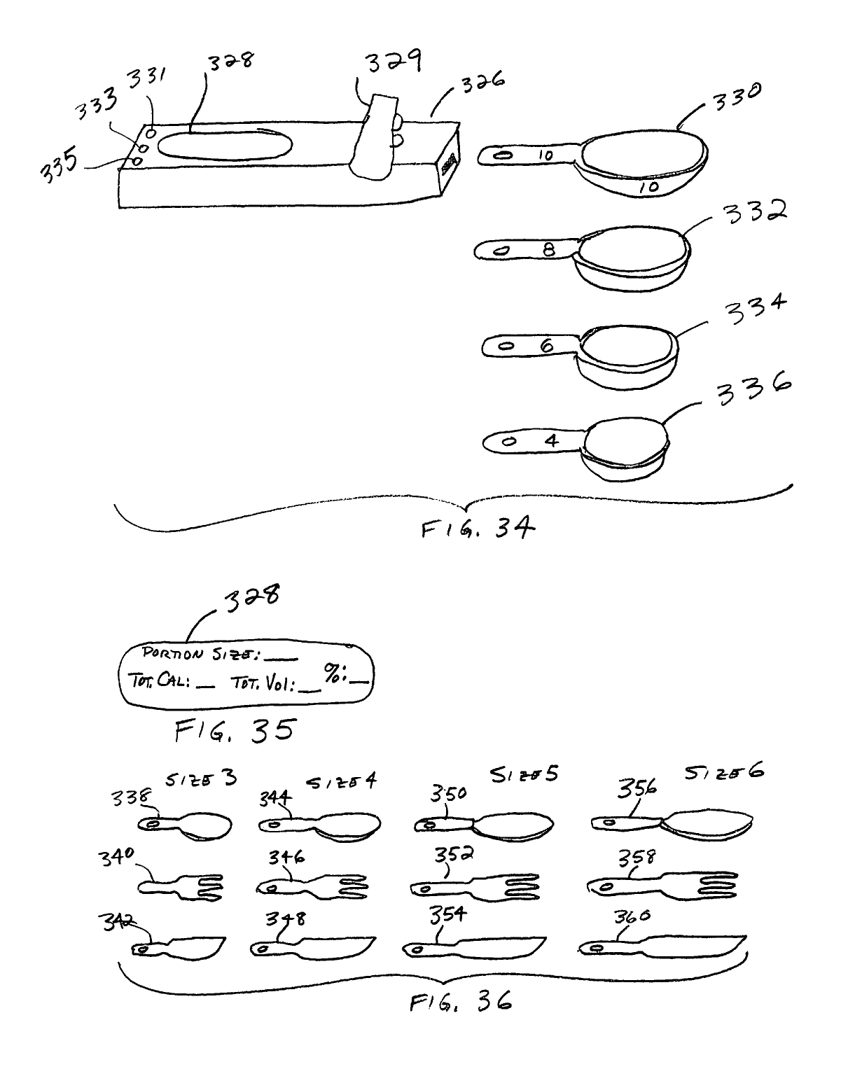

FIG. 35 illustrates an embodiment of the display 328, which can include the portion size of the utensil, which can be recognized by the handle and/or the program or programs. The display can also include the estimated total calories consumed during a given meal, an estimated total volume consumed during a given meal, and an estimated percentage of the consumed food relative to a goal in accordance with the inventive standardized eating system. The accuracy of the estimates can be improved by inputting the Caloric Density Mark (CDM) of the food being consumed. FIG. 36 illustrates a plurality of different utensils (338-360) for use with the handle 326.

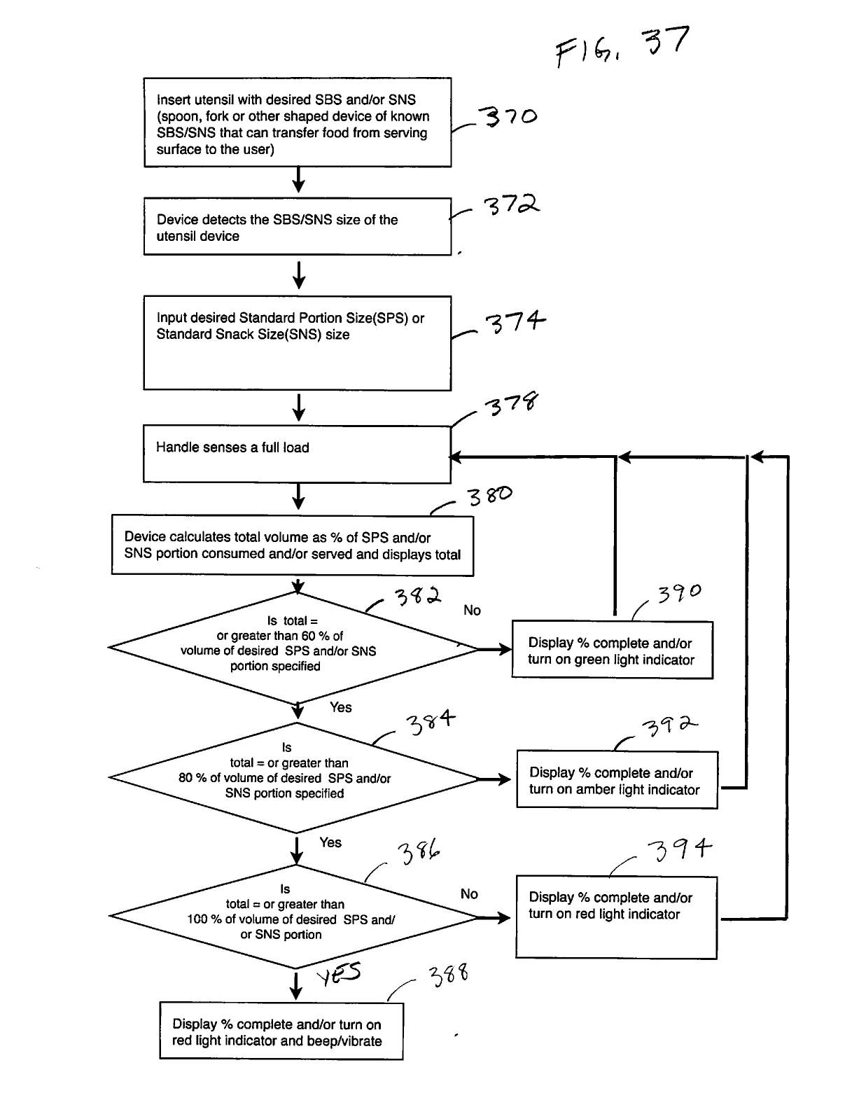

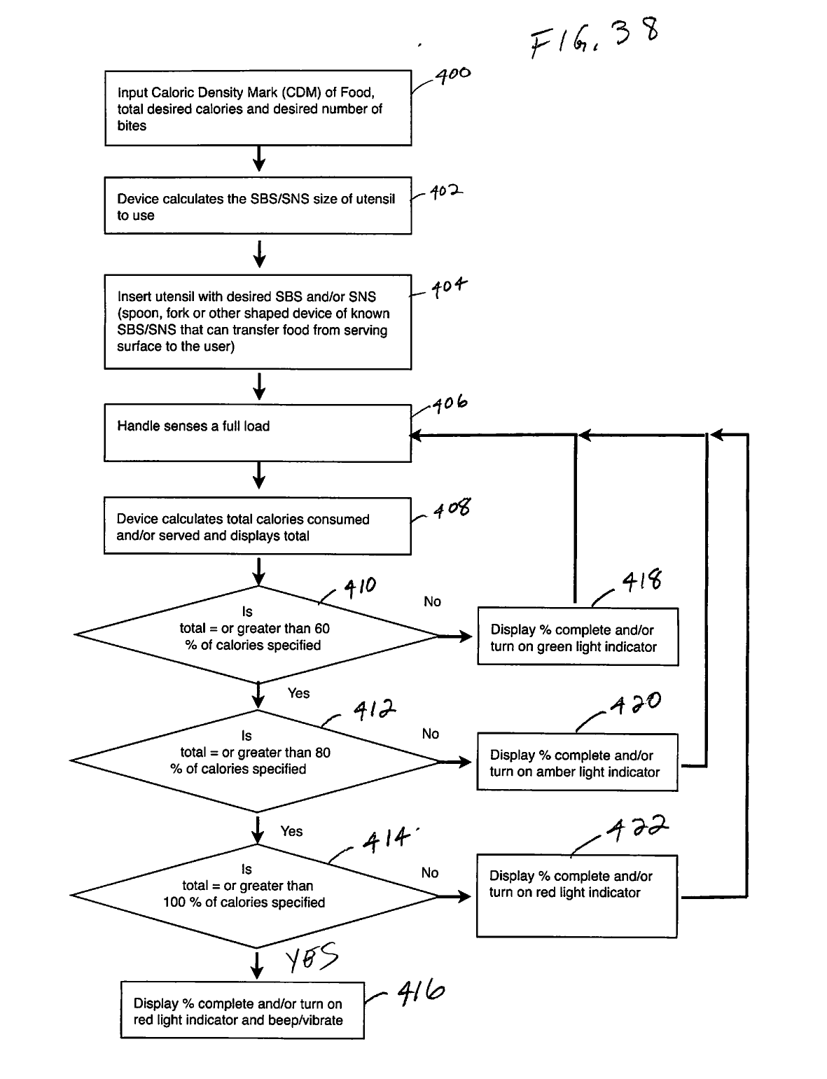

FIGS. 37 and 38 are block diagrams representing methods of using the handle 326. In the method illustrated in FIG. 37, the user initially inserts a desired SBS or SNS utensil into the handle 326 (370) and the handle 326 and/or program or programs detect the SBS/SNS size of the utensil (372) in accordance with the inventive system. Next, the user inputs a desired Standard Portion Size (SPS) or Standard Snack Size (SSS) (374). When using the connected utensil and handle, the handle 326 determines the weight of the food loaded onto the utensil (378) and the program and memory calculate a total volume of food consumed as a percentage of SPS and/or SNS, and displays a running total (380).

If the total percentage is less than 60% of the desired portion size, the program controls the signal lights to light the green signal light 331 (382 and 390). If the total percentage is greater than 60% of the desired portion size but less than 80%, the program controls the signal lights to light the yellow signal light 333 (384 and 390). If the total percentage is greater than 80% of the desired portion size but less than 100%, the program controls the signal lights to light the red signal light 335 (386 and 394). And if the total percentage is greater than 100% of the desired portion size, the program controls the signal lights to light the red signal light 335 and/or controls the handle 326 to emit an auditory and/or tactile signal (388).

In the method illustrated in FIG. 38, the user initially inputs a the Caloric Density Mark (CDM) of the food to be consumed (400), and the handle 326 and/or program or programs determines the optimal SBS/SNS size of the utensil to use (402) in accordance with the inventive system. Next, the user inserts the determined SBS or SNS utensil into the handle 326 (404). When using the connected utensil and handle, the handle 326 determines the weight of the food loaded onto the utensil (406) and the program and memory calculate a total calories of food consumed and/or served, and displays a running total (408).

If the total percentage is less than 60% of the calories specified, the program controls the signal lights to light the green signal light 331 (410 and 418). If the total percentage is greater than 60% of the specified calories but less than 80%, the program controls the signal lights to light the yellow signal light 333 (412 and 420). If the total percentage is greater than 80% of the specified calories but less than 100%, the program controls the signal lights to light the red signal light 335 (414 and 422). And if the total percentage is greater than 100% of the specified calories, the program controls the signal lights to light the red signal light 335 and/or controls the handle 326 to emit an auditory and/or tactile signal (416).

According to one embodiment, the handle is combined with a plurality of standardized standard bite size (SBS) and standard nibble size (SNS) utensils. Each of the utensils includes indicia demarking its correspondence with the inventive standardized eating system. The handle has a user interface and a memory for operating an interactive program, and the handle is connectible to each of the utensils. The interactive program and handle recognize the correspondence of a connected utensil with the standardized eating system. Additionally, the interactive program and handle can estimate a total volume and/or total calories per meal.

According to one embodiment, the handle also includes a communication unit for communicating with a dietary monitoring device, such as a personal computer, a tablet, or a smart phone. The communication unit communicates the estimate the total volume and/or calories per meal to the dietary monitoring device as input for a dietary monitoring system.

Some eating-ware components of the inventive system can be used for both liquids and for solids, for example, a coffee mug or a bowl. As such, the component may deliver different volumetric portion equivalents depending on the type of substance used. For example, while a coffee cup can only contain a given volume of milk or other liquid without overflowing, ice cream can extend above the rim. Accordingly, in one embodiment, the component indicates different sizes for the same component depending which type of substance is used. For example, the size can be followed by a letter (for example, S or L) to indicate that the portion size corresponds to using the component with solid or liquid, respectively. As another example, a bowl or a glass can also be used for solid or a liquid food. According to one embodiment, the component indicates SPS-S-16 (denoting its system size is 16 when used for solid) as well as SPS-L-15 (denoting its system size is 15 when used for liquid food). One skilled in the art will understand that other marking systems for denoting a system-size difference for a given component depending on the substance, such as “SPS 16(S) 15(L)” can be employed without departing from the scope of the present invention.

Although only a few embodiments of the present invention have been shown and described, the present invention is not limited to the described embodiments. Instead, it will be appreciated by those skilled in the art that changes may be made to these embodiments without departing from the principles and spirit of the invention. It is particularly noted that those skilled in the art can readily combine the various technical aspects of the various elements of the various exemplary embodiments that have been described above in numerous other ways, all of which are considered to be within the scope of the invention, which is defined by the appended claims and their equivalents.

What is claimed is:

1. A diet management system, comprising:
a plurality of different-sized templates, each template having the same shape and defining a size of a food portion in accordance with a standardized eating system;
wherein each template is collapsible for storage and/or transportation; and
wherein each template includes indicia demarking the correspondence of the template with the standardized eating system.

2. The system according to claim 1, wherein each of the templates is malleable.

3. The system according to claim 1, wherein each of the templates is re-shapeable.

4. The system according to claim 1, wherein each of the templates is inflatable.

5. The system according to claim 1, wherein for each template but the largest template, the template is nestable within the successively larger template.

6. The system according to claim 5, wherein each of the templates has an end that is not enclosed.

7. The system according to claim 1, wherein each of the templates includes a cutting edge to partition the defined size of the meal from a larger serving.

8. A diet management system, comprising:
a plurality of different-sized templates, each template having the same shape and defining a size of a food portion in accordance with a standardized eating system;
wherein each template encloses a volume; and
wherein each template includes indicia demarking the correspondence of the template with the standardized eating system.

9. The system according to claim 8, wherein each template is hollow.

10. The system according to claim 8, wherein for each template but the largest template, the template is nestable within the successively larger template.

11. The system according to claim 8, wherein each template comprises a hingedly-connected multi-piece construction.

12. The system according to claim 8, wherein each of the templates is inflatable.

13. The system according to claim 8, wherein each of the templates is openable and closable.

14. A method of employing a plurality of different-sized templates, the method comprising:
selecting one of a plurality of different-sized templates, each template of the plurality of templates having the same shape and defining a size of a food portion in accordance with a standardized eating system, each template including an indicia demarking the correspondence of the template with the standardized eating system;
collapsing the selected template;
transporting the collapsed template;
bringing template to its expanded, full size;
employing the expanded template to define a size of a food portion on dishware that does not include indicia demarking a correspondence to a standardized eating system.

15. A method of employing a plurality of different-sized templates, the method comprising:
projecting a selected single one and/or plural templates of the plurality of template as an image on a surface area of dishware to define a size of a food portion, each template of the plurality of templates defining a size of a food portion in accordance with a standardized eating system;
wherein each template includes indicia demarking the correspondence of the template with the standardized eating system.

16. The method according to claim 15, wherein the image comprises a hologram.

17. The method according to claim 15, wherein the image corresponds to a standard size surface area of the standardized eating system.

18. The method according to claim 15, wherein the image comprises standard sizes for different food types.

19. The method according to claim 15, wherein projecting the template comprises projecting an image of selected dishware and/or utensils from the standardized eating system onto dishware and/or utensils that do not include indicia demarking a correspondence to a standardized eating system.

20. A computer readable medium encoded with processing instructions for implementing a method performed by a computer of adjusting dietary intake, the method comprising:
a first set of instructions for receiving input of current user data, wherein the current user data includes weight, height, and/or activity level;
a second set of instructions for receiving user's desired weight goal;
a third set of instructions for statistically analyzing input user data over time, and recommending and/or adjusting standard portion size (SPS), standard snack size (SSS), standard nibble size (SNS), and standard bite size (SBS) of dishware and utensils to achieve the desired weight goal.
